(19) United States
(12) Patent Application Publication
(10) Pub. No.: US 2009/0020027 A1
(43) Pub. Date: Jan. 22, 2009

(54) Synchronous control method and apparatus for web rotary printing press

(75) Inventor: Hiromitsu Numauchi, Tsukuba-shi (JP)

Correspondence Address: BIRCH STEWART KOLASCH & BIRCH, PO BOX 747, FALLS CHURCH, VA, 22040-0747, US

(73) Assignee: KOMORI CORPORATION, Tokyo (JP)

(21) Appl. No.: 12/219,062

(22) Filed: Jul. 15, 2008

(30) Foreign Application Priority Data
Jul. 17, 2007 (JP) 2007-185326

(51) Int. Cl. B41F 5/04

(52) U.S. Cl. 101/219

(57) ABSTRACT

A synchronous control method and apparatus are disclosed for a web rotary printing press which comprises a first printing press, a second printing press, a drive motor for driving the second printing press, and a folder provided in the first printing press, and enables a web printed by the first printing press and a web printed by the second printing press to be superposed and folded by the folder. The synchronous control apparatus comprises a pattern phase deviation detecting sensor provided halfway through a transport path, on which the web printed by the second printing press is transferred so that the web is superposed on a web printed by the first printing press, and adapted to measure the position of a pattern printed by the second printing press, and a pattern phase deviation computing device and a central control device for controlling the rotation phase of the drive motor based on the position of the pattern printed by the second printing press, the position having been measured by the sensor.

### BACKGROUND OF THE INVENTION

1. Field of the Invention

This invention relates to a synchronous control method and apparatus for a web rotary printing press.

2. Description of the Related Art

JP-A-6-328672 and JP-A-2005-304109 disclose DUPLEX or TRIPLEX systems in which a plurality of offset rotary printing presses are operated in synchronization, and webs printed by the respective offset rotary printing presses are cut and folded in a superposed state by a folding machine.

If long-run printing is carried out in such a system, positional displacement occurs between printing products produced by a master machine and a slave machine because of a difference in length between the web transport paths of the master machine and the slave machine operated in synchronization, as well as the elongation of the web. Thus, it has been customary practice for an operator to make a constant visual check of the printing product and, in the event of position displacement, to forcibly adjust the position of a compensator roller on the master machine side, thereby correcting the positional displacement.

According to the customary practice, as described above, the operator is obliged to constantly conduct a visual check of the printing product and, in case of positional displacement, has to forcibly adjust the position of the compensator roller on the master machine side. Thus, the problems put a burden on the operator, and further an adjustment error cannot be avoided completely because the operator visually makes adjustment, causing excess defective printing products.

The present invention has been accomplished in light of the above-described problems. It is an object of the invention to provide a synchronous control method and apparatus for a web rotary printing press, which can lessen burden on an operator and cut down on the amount of occurrence of defective printing products by automating an adjustment for correcting positional displacement occurring between printing products produced by a first web rotary printing press and a second web rotary printing press.

### SUMMARY OF THE INVENTION

A first aspect of the present invention is a synchronous control method for a web rotary printing press which includes

a first web rotary printing press,

a second web rotary printing press,

a drive motor for driving the second web rotary printing press, and

a folder provided in the first web rotary printing press, and enables a printing product printed by the first web rotary printing press and a printing product printed by the second web rotary printing press to be superposed and folded by the folder,

the synchronous control method, which has the steps of:

providing pattern position measuring means halfway through a transport path, on which a web printed by the second web rotary printing press is transferred so that the web is superposed on a web printed by the first web rotary printing press, the pattern position measuring means being adapted to measure a position of a pattern printed by the second web rotary printing press;

measuring the position of the pattern, which has been printed by the second web rotary printing press, by the pattern position measuring means; and

controlling a rotation phase of the drive motor based on the measured position of the pattern printed by the second web rotary printing press.

The synchronous control method for a web rotary printing press according to the first aspect may further comprise: providing a means for adjusting a position of a compensator roller based on the measured position of the pattern printed by the second web rotary printing press, the means for adjusting the position of the compensator roller being provided halfway through the transport path, on which the web printed by the second web rotary printing press is transferred so that the web is superposed on the web printed by the first web rotary printing press, the compensator roller being adapted to adjust a length of the transport path of the web printed by the second web rotary printing press; and controlling the rotation phase of the drive motor based on the position of the compensator roller.

A second aspect of the present invention is a synchronous control method for a web rotary printing press which includes

a first web rotary printing press,

a second web rotary printing press having a drive motor provided in a printing unit, and

a folder provided in the first web rotary printing press, and enables a printing product printed by the first web rotary printing press and a printing product printed by the second web rotary printing press to be superposed and folded by the folder,

the synchronous control method, which has the steps of:

providing pattern position measuring means halfway through a transport path, on which a web printed by the second web rotary printing press is transferred so that the web is superposed on a web printed by the first web rotary printing press, the pattern position measuring means being adapted to measure a position of a pattern printed by the second web rotary printing press;

measuring the position of the pattern, which has been printed by the second web rotary printing press, by the pattern position measuring means; and

controlling a rotation phase of the drive motor, which drives the printing unit of the second web rotary printing press, based on the measured position of the pattern printed by the second web rotary printing press.

The synchronous control method for a web rotary printing press according to the second aspect may further has the steps of: providing a means for adjusting a position of a compensator roller based on the measured position of the pattern printed by the second web rotary printing press, the means for adjusting the position of the compensator roller being provided halfway through the transport path, on which the web printed by the second web rotary printing press is transferred so that the web is superposed on the web printed by the first web rotary printing press, the compensator roller being adapted to adjust a length of the transport path of the web printed by the second web rotary printing press; and controlling the rotation phase of the drive motor, which drives the printing unit of the second web rotary printing press, based on the position of the compensator roller.

A third aspect of the present invention is a synchronous control apparatus for a web rotary printing press which includes

a first web rotary printing press;

a second web rotary printing press;

a drive motor for driving the second web rotary printing press;

a folder provided in the first web rotary printing press, and enables a printing product printed by the first web rotary printing press and a printing product printed by the second web rotary printing press to be superposed and folded by the folder;

a pattern position measuring means provided halfway through a transport path, which a web printed by the second web rotary printing press takes until the web is superposed on a web printed by the first web rotary printing press, the pattern position measuring means being adapted to measure a position of a pattern printed by the second web rotary printing press; and

a control means for controlling a rotation phase of the drive motor based on the position of the pattern printed by the second web rotary printing press, the position having been measured by the pattern position measuring means.

The synchronous control apparatus for a web rotary printing press according to the third aspect may further comprise a means for adjusting a position of a compensator roller based on the measured position of the pattern printed by the second web rotary printing press, the means for adjusting the position of the compensator roller being provided halfway through the transport path, on which the web printed by the second web rotary printing press is transferred so that the web is superposed on the web printed by the first web rotary printing press, the compensator roller being adapted to adjust a length of the transport path of the web printed by the second web rotary printing press, and the control means may control the rotation phase of the drive motor based on the position of the compensator roller.

A fourth aspect of the present invention is a synchronous control apparatus for a web rotary printing press which includes

a first web rotary printing press;

a second web rotary printing press having a drive motor provided in a printing unit;

a folder provided in the first web rotary printing press;

and enables a printing product printed by the first web rotary printing press and a printing product printed by the second web rotary printing press to be superposed and folded by the folder;

a pattern position measuring means provided halfway through a transport path, which a web printed by the second web rotary printing press takes until the web is superposed on a web printed by the first web rotary printing press, the pattern position measuring means being adapted to measure a position of a pattern printed by the second web rotary printing press; and

a control means for controlling a rotation phase of the drive motor, which drives the printing unit of the second web rotary printing press, based on the position of the pattern printed by the second web rotary printing press, the position having been measured by the pattern position measuring means.

The synchronous control apparatus for a web rotary printing press according to the fourth aspect may further comprise a means for adjusting a position of a compensator roller based on the measured position of the pattern printed by the second web rotary printing press, the means for adjusting the position of the compensator roller being provided halfway through the transport path, on which the web printed by the second web rotary printing press is transferred so that the web is superposed on the web printed by the first web rotary printing press, the compensator roller being adapted to adjust a length of the transport path of the web printed by the second web rotary printing press, and the control means may control the rotation phase of the drive motor, which drives the printing unit of the second web rotary printing press, based on the position of the compensator roller.

According to the present invention having the above-described features, the rotation phase of the drive motor on the second web rotary printing press side is adjusted directly, or indirectly based on the position of the compensator roller, in accordance with the position of the pattern detected by the pattern position measuring means provided halfway through the transport path in which the web printed by the second web rotary printing press is individually transported. Thus, the position of the pattern printed by the first web rotary printing press and the position of the pattern printed by the second web rotary printing press can be automatically brought into predetermined position. Accordingly, burden on the operator can be lessened, and the amount of occurrence of defective printing products can be cut down.

In an offset rotary printing press of the sectional drive type in which the respective printing units are synchronously operated, if the rotation phase of the drive motor for driving each printing unit is adjusted, the position of the pattern printed by the first web rotary printing press and the position of the pattern printed by the second web rotary printing press can be likewise automatically brought into the predetermined position.

### BRIEF DESCRIPTION OF THE DRAWINGS

The present invention will become more fully understood from the detailed description given hereinbelow and the accompanying drawings which are given by way of illustration only, and thus are not limitative of the present invention:

FIG. 1 is a schematic configurational drawing of a synchronous control apparatus for a web rotary printing press showing Embodiment 1 of the present invention;

FIG. 2 is a block diagram of a pattern phase deviation computing device;

FIG. 3 is a block diagram of a central control device;

FIG. 4 is a block diagram of a virtual master generator;

FIG. 5 is a block diagram of a drive control device for each of a master machine and a slave machine;

FIG. 6 is a motion flow chart of the pattern phase deviation computing device;

FIG. 7(a) is a motion flow chart of the central control device;

FIG. 7(b) is a motion flow chart of the central control device;

FIG. 8(a) is a motion flowchart of the virtual master generator;

FIG. 8(b) is a motion flowchart of the virtual master generator;

FIG. 9(a) is a motion flowchart of the virtual master generator;

FIG. 9(b) is a motion flowchart of the virtual master generator;

FIG. 10 is a motion flow chart of the drive control device for each of the master machine and the slave machine;

FIG. 11 is a motion flow chart of the drive control device for each of the master machine and the slave machine;

FIG. 12 is a schematic configurational drawing of a synchronous control apparatus for a web rotary printing press showing Embodiment 2 of the present invention;

FIG. 13 is a block diagram of a pattern phase deviation computing device;

FIG. 14 is a block diagram of a central control device;

FIG. 15 is a block diagram of a virtual master generator;

FIG. 16 is a block diagram of a drive control device for each unit of a master machine and a slave machine;

FIG. 17 is a motion flow chart of the pattern phase deviation computing device;

FIG. 18(a) is a motion flowchart of the central control device;

FIG. 18(b) is a motion flowchart of the central control device;

FIG. 19(a) is a motion flow chart of the virtual master generator;

FIG. 19(b) is a motion flow chart of the virtual master generator;

FIG. 20(a) is a motion flow chart of the virtual master generator;

FIG. 20(b) is a motion flow chart of the virtual master generator;

FIG. 21 is a motion flow chart of the drive control device for each unit of the master machine and the slave machine;

FIG. 22 is a motion flow chart of the drive control device for each unit of the master machine and the slave machine;

FIG. 23 is a schematic configurational drawing of asynchronous control apparatus for a web rotary printing press showing Embodiment 3 of the present invention;

FIG. 24 is a block diagram of a pattern phase deviation computing device;

FIG. 25 is a block diagram of a drive control device for a main printing press;

FIG. 26 is a block diagram of a drive control device for a subordinate printing press;

FIG. 27 is a motion flow chart of the pattern phase deviation computing device;

FIG. 28(a) is a motion flow chart of the drive control device for the main printing press;

FIG. 28(b) is a motion flow chart of the drive control device for the main printing press;

FIG. 29(a) is a motion flow chart of the drive control device for the main printing press;

FIG. 29(b) is a motion flow chart of the drive control device for the main printing press;

FIG. 30 is a motion flow chart of the drive control device for the subordinate printing press;

FIG. 31 is a motion flow chart of the drive control device for the subordinate printing press;

FIG. 32 is a schematic configurational drawing of asynchronous control apparatus for a web rotary printing press showing Embodiment 4 of the present invention;

FIG. 33 is a block diagram of a pattern phase deviation computing device;

FIG. 34 is a block diagram of a drive control device for a folder unit of a main printing press;

FIG. 35 is a block diagram of a drive control device for other unit;

FIG. 36 is a motion flow chart of the pattern phase deviation computing device;

FIG. 37(a) is a motion flow chart of the drive control device for the folder unit of the main printing press;

FIG. 37(b) is a motion flow chart of the drive control device for the folder unit of the main printing press;

FIG. 37(c) is a motion flow chart of the drive control device for the folder unit of the main printing press;

FIG. 38(a) is a motion flow chart of the drive control device for the folder unit of the main printing press;

FIG. 38(b) is a motion flow chart of the drive control device for the folder unit of the main printing press;

FIG. 39 is a motion flow chart of the drive control device for other unit;

FIG. 40 is a motion flow chart of the drive control device for other unit;

FIG. 41 is a schematic configurational drawing of a synchronous control apparatus for a web rotary printing press showing Embodiment 5 of the present invention;

FIG. 42 is a block diagram of a pattern phase deviation modifying compensator roller control device;

FIG. 43 is a block diagram of a drive control device for a folder unit of a main printing press;

FIG. 44 is a block diagram of a drive control device for other unit of the main printing press;

FIG. 45 is a block diagram of a drive control device for each unit of a subordinate printing press;

FIG. 46(a) is a motion flowchart of the pattern phase deviation modifying compensator roller control device;

FIG. 46(b) is a motion flowchart of the pattern phase deviation modifying compensator roller control device;

FIG. 47(a) is a motion flow chart of the drive control device for the folder unit of the main printing press;

FIG. 47(b) is a motion flow chart of the drive control device for the folder unit of the main printing press;

FIG. 47(c) is a motion flow chart of the drive control device for the folder unit of the main printing press;

FIG. 48 is a motion flow chart of the drive control device for other unit of the main printing press;

FIG. 49 is a motion flow chart of the drive control device for each unit of the subordinate printing press;

FIG. 50(a) is a motion flow chart of the drive control device for each unit of the subordinate printing press; and

FIG. 50(b) is a motion flow chart of the drive control device for each unit of the subordinate printing press.

### DETAILED DESCRIPTION OF THE INVENTION

The synchronous control method and apparatus for a web rotary printing press according to the present invention will be described in detail by preferred embodiments of the invention by reference to the accompanying drawings.

### Embodiment 1

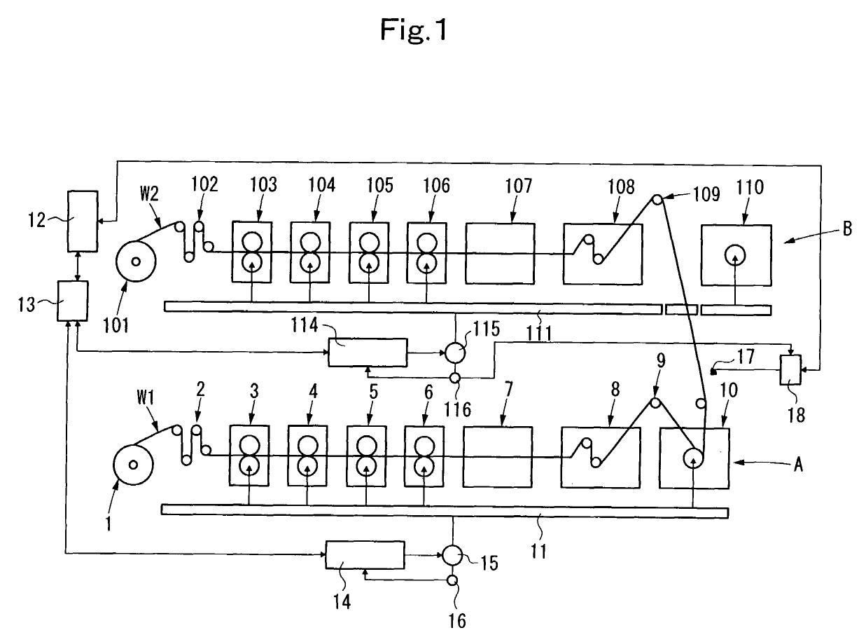

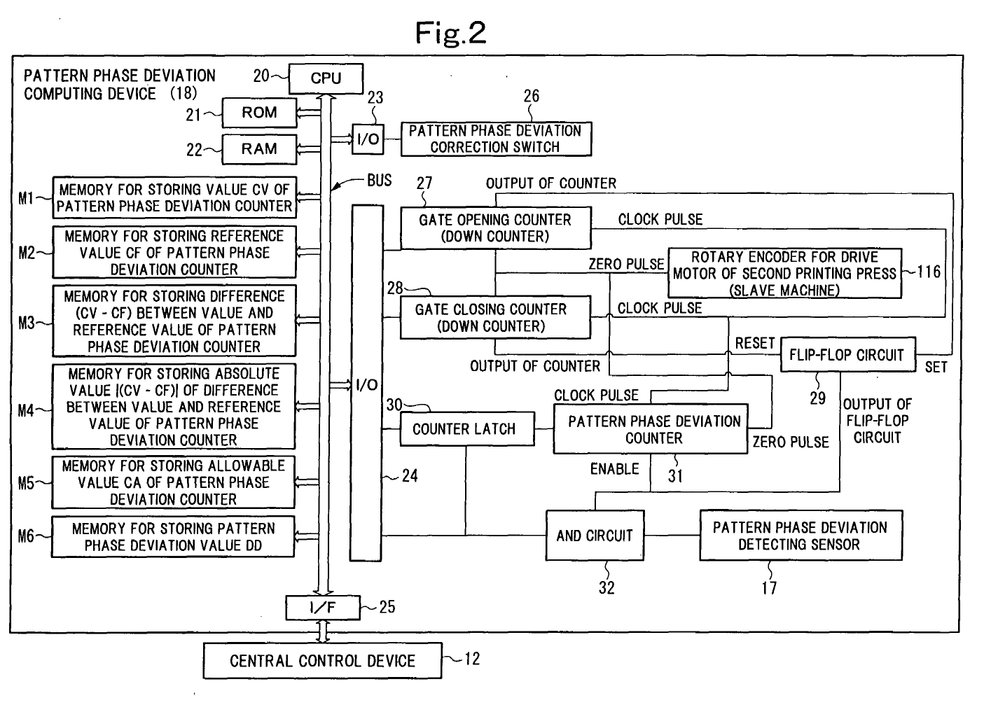

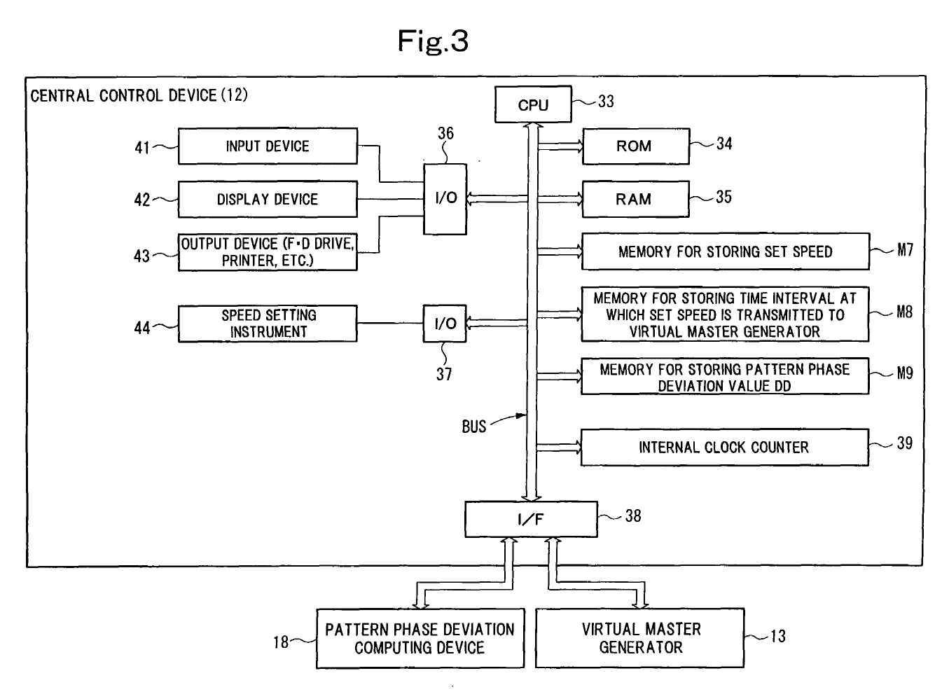

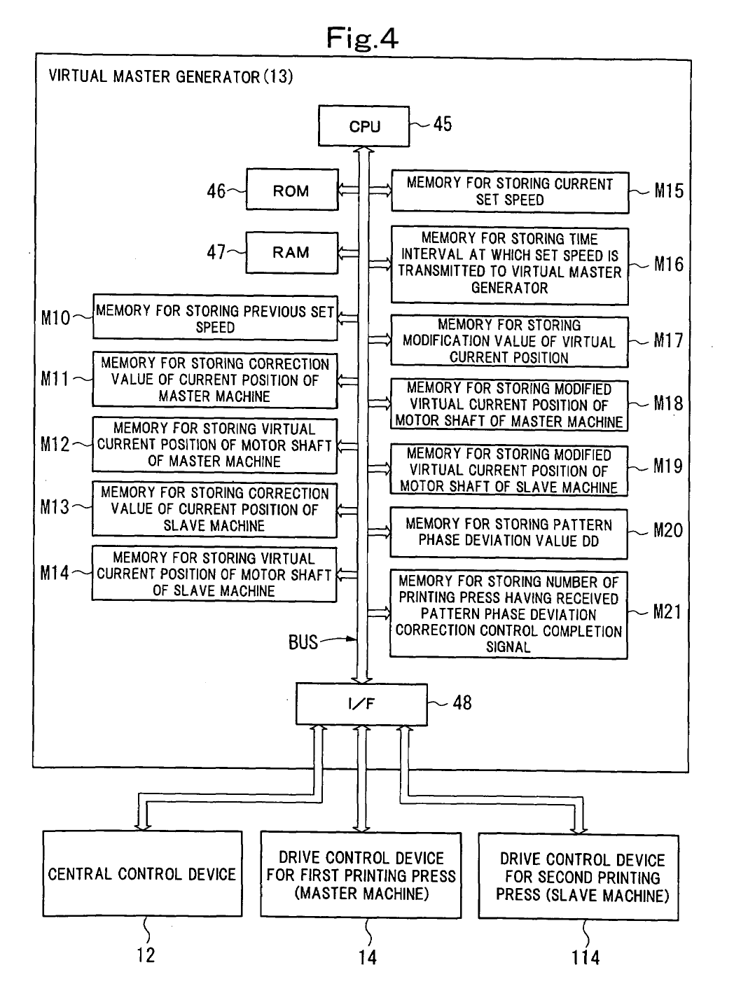

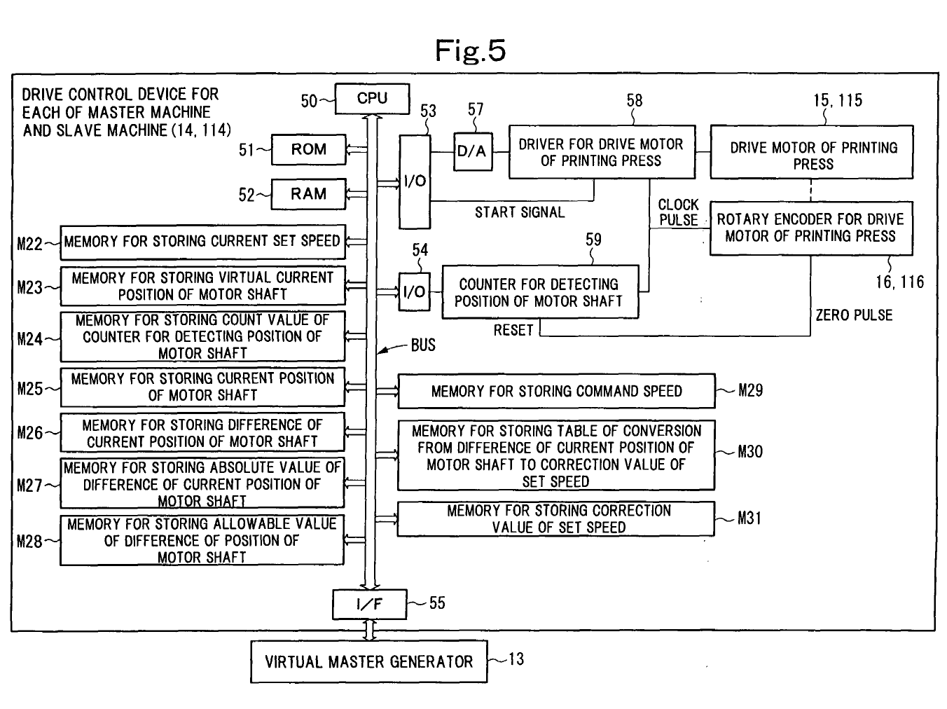

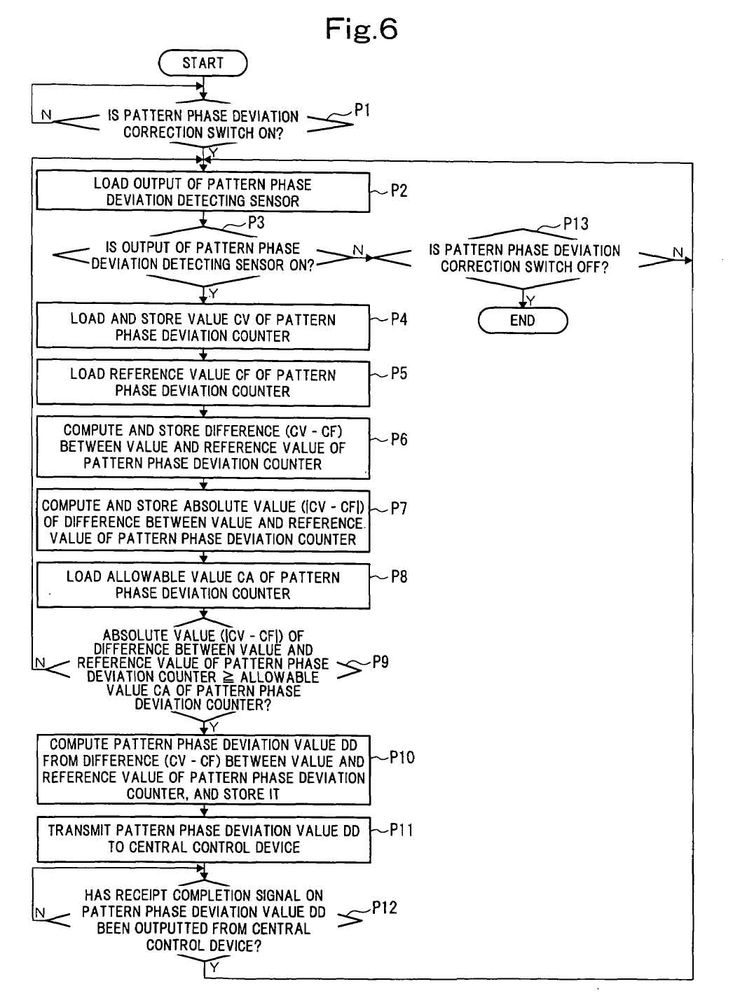

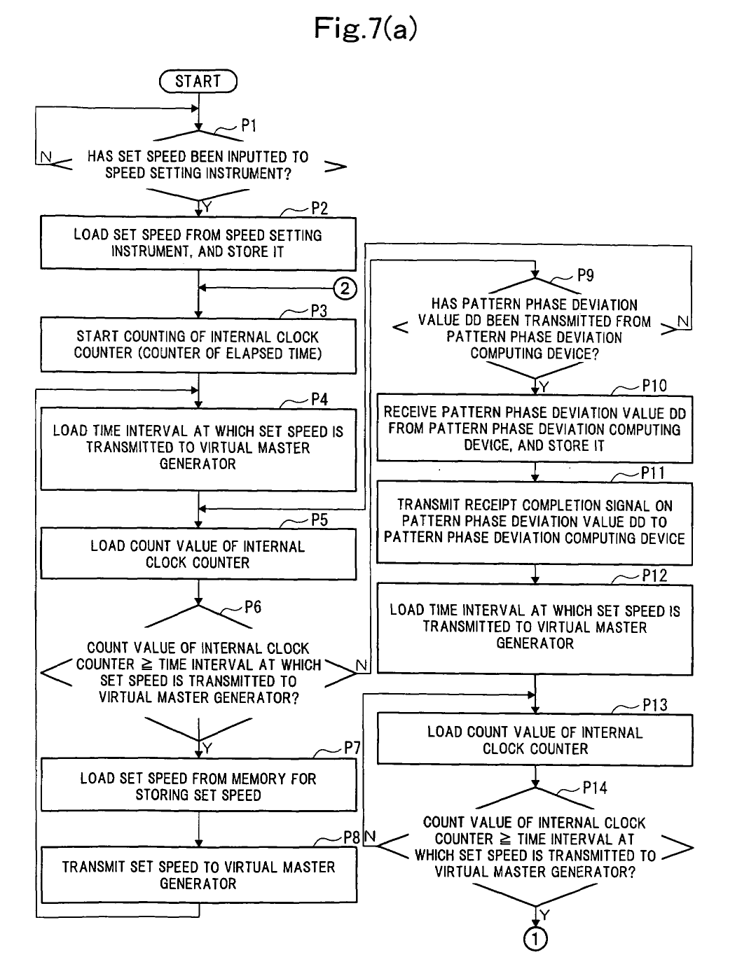

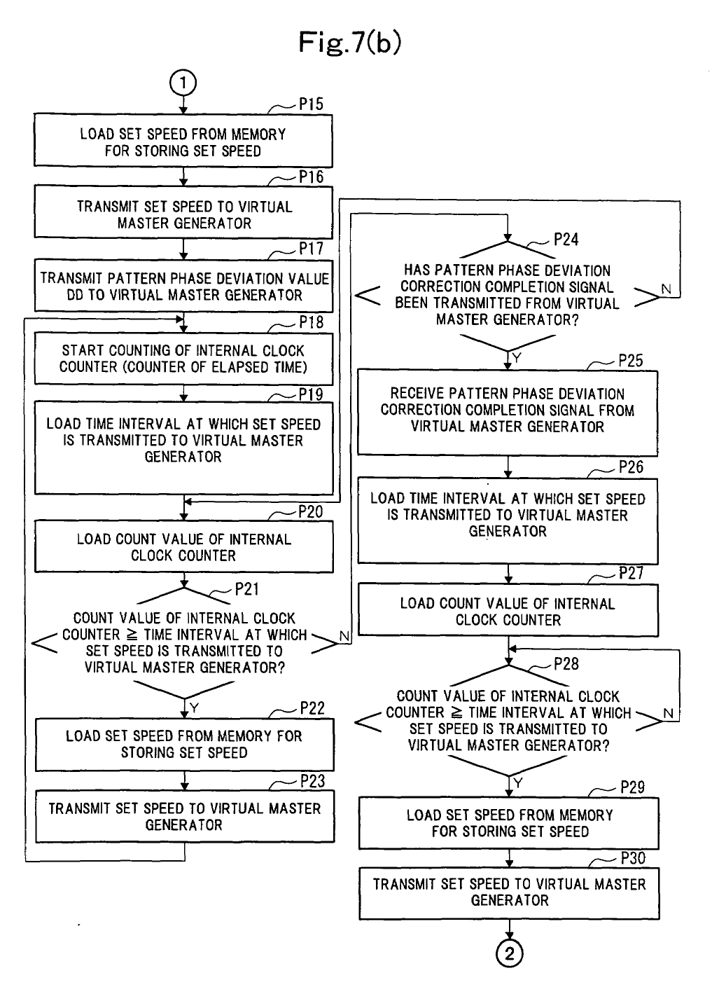

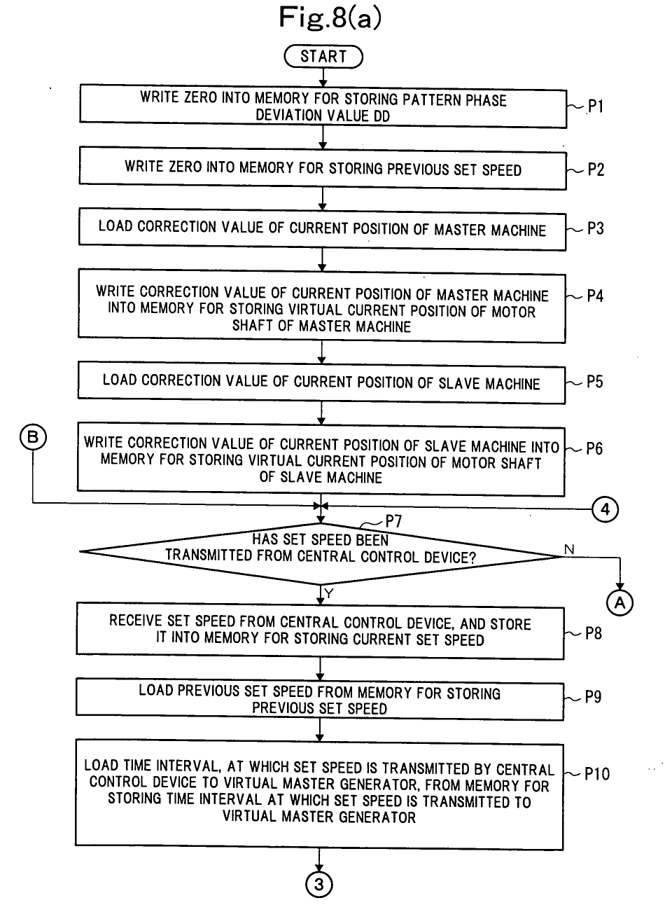

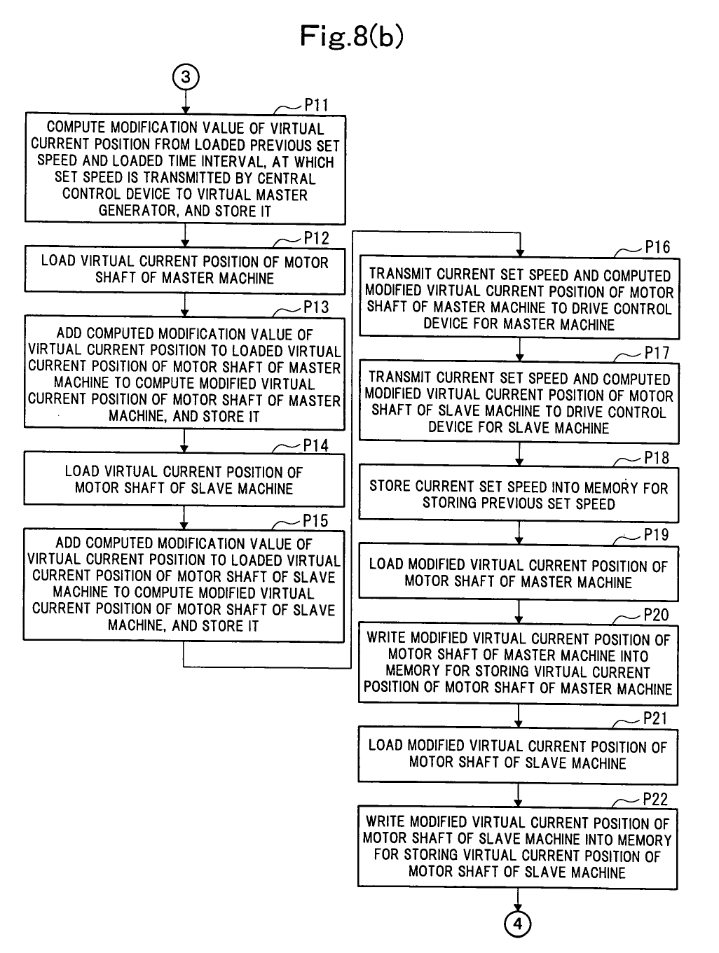

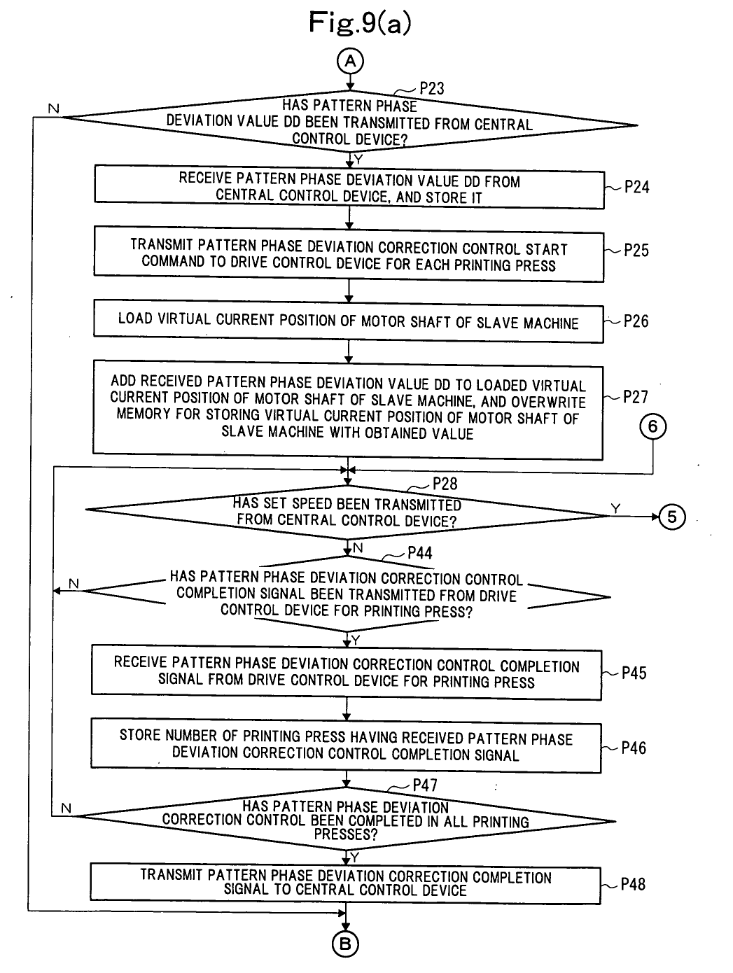

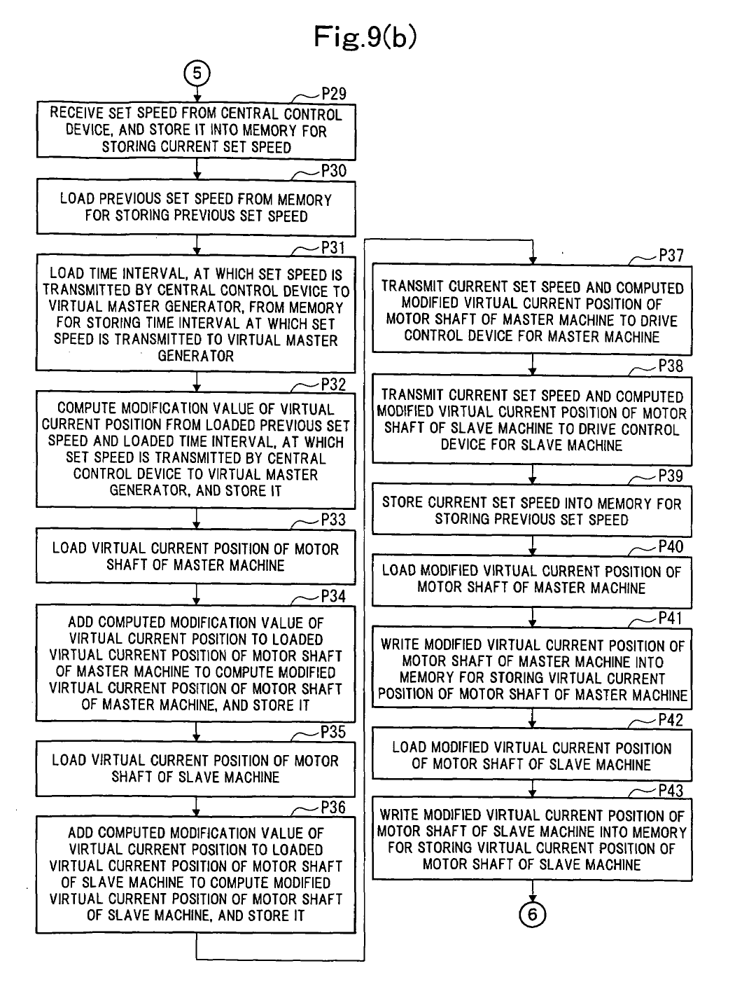

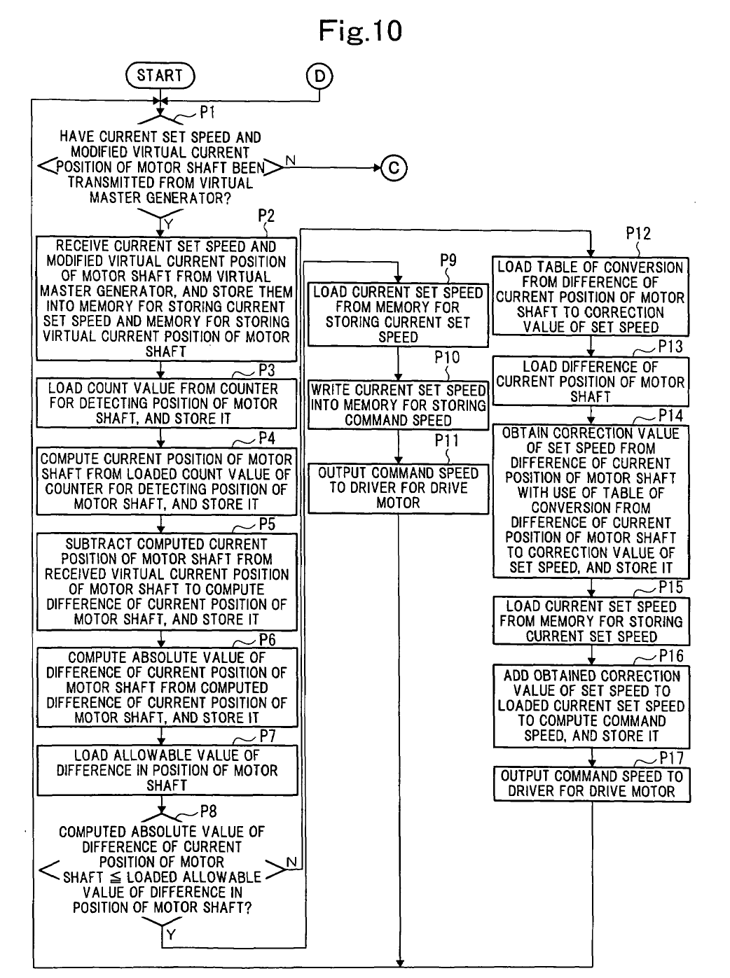

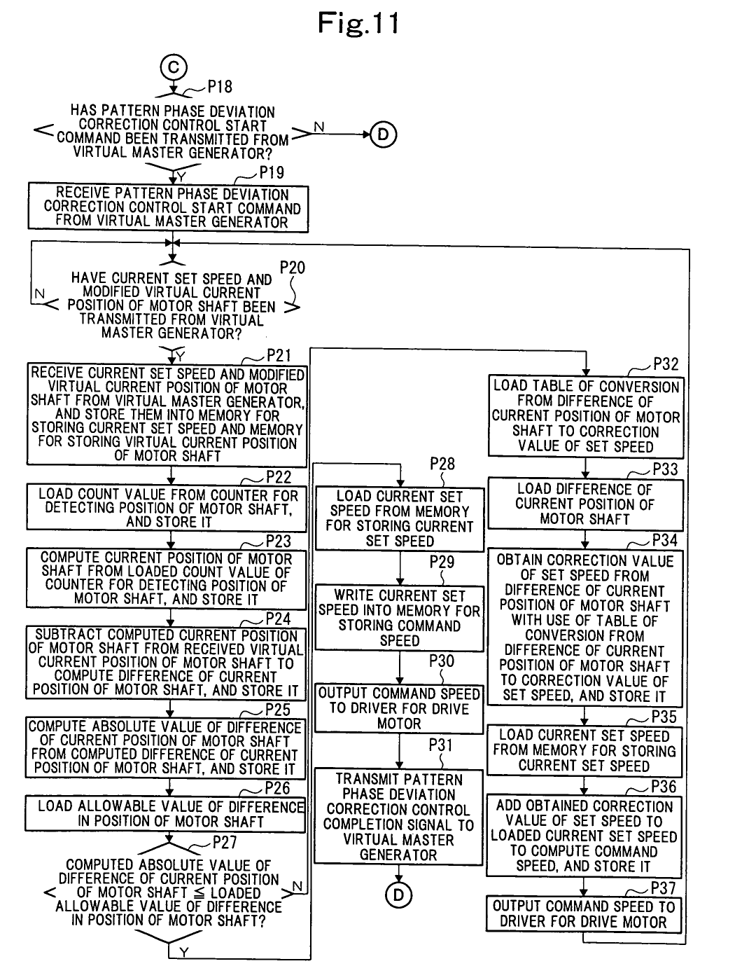

FIG. 1 is a schematic configurational drawing of a synchronous control apparatus for a web rotary printing press showing Embodiment 1 of the present invention. FIG. 2 is a block diagram of a pattern phase deviation computing device. FIG. 3 is a block diagram of a central control device. FIG. 4 is a block diagram of a virtual master generator. FIG. 5 is a block diagram of a drive control device for each of a master machine and a slave machine. FIG. 6 is a motion flow chart of the pattern phase deviation computing device. FIG. 7(a) is a motion flow chart of the central control device. FIG. 7(b) is a motion flow chart of the central control device. FIG. 8(a) is a motion flow chart of the virtual master generator. FIG. 8(b) is a motion flow chart of the virtual master generator. FIG. 9(a) is a motion flow chart of the virtual master generator. FIG. 9(b) is a motion flow chart of the virtual master generator. FIG. 10 is a motion flow chart of the drive control device for each of the master machine and the slave machine. FIG. 11 is a motion flow chart of the drive control device for each of the master machine and the slave machine.

In a first printing press (master machine) A having a web rotary printing press as a first rolled paper rotary printing press, as shown in FIG. 1, a roll of paper (web) W1, which is continuously fed from a feeder 1 and an infeed unit 2 is subjected to various printings as it passes through first to fourth printing units 3 to 6. Then, the web is heated to dry when it passes through a dryer 7, and is then cooled when it passes through a cooling unit 8. Then, when the web passes over a drag unit 9, its tension is controlled or its direction is changed. Then, the web is cut into a predetermined shape and then folded by a folder 10.

The first to fourth printing units 3 to 6 and the folder 10 are driven by a drive motor 15 of the printing press via a machine shaft (line shaft) 11. A rotary encoder 16 for detecting the rotational speed of the drive motor 15 is connected to the drive motor 15. The drive motor 15 is drivingly controlled by a drive control device 14 for the master machine, and a detection signal from the rotary encoder 16 is inputted to the drive control device 14 for the master machine.

On the other hand, in a second printing press (slave machine) B, which has a web rotary printing press as a second rolled paper rotary printing press, rolled paper (web) W2 continuously, which is fed from a feeder 101 and an infeed unit 102, is subjected to various printings as it passes through first to fourth printing units 103 to 106. Then, the web is heated to dry when it passes through a dryer 107, and is then cooled when it passes through a cooling unit 108. Then, when the web passes over a drag unit 109, its tension is controlled or its direction is changed. Then, the web is cut to a predetermined shape and then folded by a folder 110.

The first to fourth printing units 103 to 106 and the folder 110 are driven by a drive motor 115 of the printing press via a machine shaft (line shaft) 111. A rotary encoder 116 for detecting the rotational speed of the drive motor 115 is annexed to the drive motor 115. The drive motor 115 is drivingly controlled by a drive control device 114 for the slave machine, and a detection signal from the rotary encoder 116 is transferred to the drive control device 114 for the slave machine.

The drive control devices 14 and 114 for the master machine and the slave machine are connected to a central control device (control means) 12 via a virtual master generator 13, and the master machine A and the slave machine B are synchronously controlled (operated) by the central control device 12. That is, in the present embodiment, the webs W1 and W2 printed by the master machine A and the slave machine B are both guided to the folder 10 of the master machine A, where they are folded.

A pattern phase deviation detecting sensor (pattern position measuring means) 17, such as a scanning sensor, for measuring the position of a pattern (strictly, a register mark), which is printed by the slave machine B, is provided halfway through a transport path on which the web W2 printed by the slave machine B is transferred so that it is superposed on the web W1 printed by the master machine A.

A detection signal from the pattern phase deviation detecting sensor 17 is inputted to a pattern phase deviation computing device (control means) 18, together with the detection signal from the rotary encoder 116 in the slave machine B. The amount of an error in the pattern position (pattern phase deviation value DD) computed by the pattern phase deviation computing device 18 is inputted to the central control device 12. The central control device 12 controls the rotation phase of the drive motor 115 of the slave machine B in accordance with this error amount (pattern phase deviation value DD), thereby bringing the position of the pattern printed by the master machine A and the position of the pattern printed by the slave machine B into registration or alignment.

As shown in FIG. 2, the pattern phase deviation computing device 18 comprises CPU 20, ROM 21, RAM 22, input/output devices 23 and 24, and an interface 25 connected together by BUS (bus line). To the BUS, the following memories are connected: A memory M1 for storing the value CV of a pattern phase deviation counter, a memory M2 for storing the reference value CF of the pattern phase deviation counter, a memory M3 for storing the difference (CV−CF) between the value and the reference value of the pattern phase deviation counter, a memory M4 for storing the absolute value |(CV−CF)| of the difference between the value and the reference value of the pattern phase deviation counter, a memory M5 for storing the allowable value CA of the pattern phase deviation counter, and a memory M6 for storing the pattern phase deviation value DD.

To the input/output device 23, a pattern phase deviation correction switch 26 is connected.

To the input/output device 24, a gate opening counter (down counter) 27 and a gate closing counter (down counter) 28 are connected, a pattern phase deviation counter 31 is connected via a counter latch 30, and the pattern phase deviation detecting sensor 17 is connected to the input/output device 24 via an AND circuit 32. A rotary encoder 116 for the drive motor of the second printing press (slave machine) is connected to the gate opening counter (down counter) 27 and the gate closing counter (down counter) 28, and the rotary encoder 116 for the drive motor of the second printing press (slave machine) is also connected to the pattern phase deviation counter 31. A flip-flop circuit 29 is connected to the gate opening counter (down counter) 27 and the gate closing counter (down counter) 28, and the flip-flop circuit 29 is also connected to the pattern phase deviation counter 31 and the AND circuit 32. The AND circuit 32 is also connected to the counter latch 30.

In the input/output device 24, therefore, the gate opening counter 27, the gate closing counter 28, and the pattern phase deviation counter 31 are reset by a zero pulse generated by the rotary encoder 116 for the drive motor of the second printing press in accordance with the rotation of the drive motor 115 of the second printing press. Then, the gate opening counter 27 counts up in accordance with a clock pulse generated by the rotary encoder 116, whereupon the flip-flop circuit 29 is set by the output of the counter 27. As a result, the pattern phase deviation counter 31 starts counting, and the AND circuit 32 is opened, in accordance with the output from the flip-flop circuit 29. When the signal from the pattern phase deviation detecting sensor 17 is inputted, the count value of the counter 31 at this time is held by the counter latch 30.

Then, the gate closing counter 28 counts up in accordance with the clock pulse generated by the rotary encoder 116, whereupon the flip-flop circuit 29 is reset by the output of the counter 28. Consequently, the output from the flip-flop circuit 29 is stopped, whereby the pattern phase deviation counter 31 stops counting, and the AND circuit 32 is closed, so that the input signal from the pattern phase deviation detecting sensor 17 is shut off. In this manner, the pattern phase deviation is detected only with a predetermined timing preset by the gate opening counter 27 and the gate closing counter 28.

The central control device 12 to be described later is connected to the interface 25.

As shown in FIG. 3, the central control device 12 comprises CPU 33, ROM 34, RAM 35, input/output devices 36, 37, and an interface 38 connected together by BUS (bus line). To the BUS, the following are connected: A memory M7 for storing a set speed, a memory M8 for storing a time interval at which the set speed is transmitted to the virtual master generator, a memory M9 for storing the pattern phase deviation value DD, and an internal clock counter 39.

To the input/output device 36, the following are connected: an input device 41 such as a keyboard, various switches, and buttons, a display device 42 such as CRT and lamps, and an output device 43 such as a printer and a floppy disk (registered trademark) drive. A speed setting instrument 44 is connected to the input/output device 37. The aforementioned pattern phase deviation computing device 18 and the virtual master generator 13 (to be described later) are connected to the interface 38.

As shown in FIG. 4, the virtual master generator 13 has CPU 45, ROM 46, RAM 47, and an interface 48 connected together by BUS (bus line). To the BUS, the following memories are connected: a memory M10 for storing the previous set speed, a memory M11 for storing the correction value of the current position of the master machine, a memory M12 for storing the virtual current position of the motor shaft of the master machine, a memory M13 for storing the correction value of the current position of the slave machine, a memory M14 for storing the virtual current position of the motor shaft of the slave machine, a memory M15 for storing the current set speed, a memory M16 for storing a time interval at which the set speed is transmitted to the virtual master generator, a memory M17 for storing a modification value of the virtual current position, a memory M18 for storing the modified virtual current position of the motor shaft of the master machine, a memory M19 for storing the modified virtual current position of the motor shaft of the slave machine, a memory M20 for storing the pattern phase deviation value DD, and a memory M21 for storing the number of the printing press having received a pattern phase deviation correction control completion signal.

To the interface 48, the following are connected: the aforementioned central control device 12, drive control device 14 (to be described later) for the first printing press (master machine), and drive control device 114 (to be described later) for the second printing press (slave machine).

As shown in FIG. 5, the drive control devices 14, 114 for the master machine and the slave machine each comprise CPU 50, ROM 51, RAM 52, input/output devices 53, 54, and an interface 55 connected together by BUS (bus line). To the BUS, the following memories are connected: a memory M22 for storing the current set speed, a memory M23 for storing the virtual current position of the motor shaft, a memory M24 for storing the count value of a counter for detecting the position of the motor shaft, a memory M25 for storing the current position of the motor shaft, a memory M26 for storing the difference of the current position of the motor shaft, a memory M27 for storing the absolute value of the difference of the current position of the motor shaft, a memory M28 for storing the allowable value of the difference in the position of the motor shaft, a memory M29 for storing a command speed, a memory M30 for storing a table of conversion from the difference of the current position of the motor shaft to the correction value of the set speed, and a memory M31 for storing the correction value of the set speed.

The drive motor (15, 115) of the printing press is connected to the input/output device 53 via a D/A converter 57 and a driver 58 for the drive motor of the printing press. A counter 59 for detecting the position of the motor shaft is connected to the input/output device 54. The rotary encoder (16, 116) for the drive motor of the printing press, which is drivingly coupled to the drive motor (15, 115) of the printing press, is connected to the driver 58 for the drive motor of the printing press and the counter 59 for detecting the position of the motor shaft. The aforementioned virtual master generator 13 is connected to the interface 55.

Because of the above configurations, when the master machine A and the slave machine B are to be synchronously controlled, the pattern phase deviation computing device 18 acts in accordance with a motion flow shown in FIG. 6.

If the pattern phase deviation correction switch 26 is ON in Step P1, the output of the pattern phase deviation detecting sensor 17 is loaded in Step P2. Then, in Step P3, it is determined whether the output of the pattern phase deviation detecting sensor 17 is ON.

If the answer is Y (yes) in the above Step P3, the value CV of the pattern phase deviation counter 31 is loaded and stored into the memory M1 in Step P4. If the answer is N (no) in Step P3, it is determined in Step P13 whether the pattern phase deviation correction switch 26 is OFF. If the answer is Y in Step P13, the action is completed. If the answer is N, the program returns to Step P2.

Then, in Step P5, the reference value CF of the pattern phase deviation counter 31 is loaded from the memory M2. Then, in Step P6, the difference (CV−CF) between the value and the reference value of the pattern phase deviation counter is computed, and stored into the memory M3. The reference value CF of the pattern phase deviation counter corresponds to the rotation phase of the slave machine B, in which the pattern printed by the slave machine B is detected by the pattern phase deviation detecting sensor 17, with the position of the pattern printed by the master machine A (first printing press) and the position of the pattern printed by the slave machine B (second printing press) being aligned in the folder 10, in consideration of the amount of elongation of the web W1 printed by the master machine A.

Then, in Step P7, the absolute value (|CV−CF|) of the difference between the value and the reference value of the pattern phase deviation counter is computed, and stored into the memory M4. Then, in Step P8, the allowable value CA of the pattern phase deviation counter is loaded from the memory M5.

Then, in Step P9, it is determined whether the absolute value (|CV−CF|) of the difference between the value and the reference value of the pattern phase deviation counter is equal to or greater than the allowable value CA of the pattern phase deviation counter. If the answer is Y, in Step P10, the pattern phase deviation value DD is computed from the difference (CV−CF) between the value and the reference value of the pattern phase deviation counter, and stored into the memory M6. If the answer is N, the program returns to Step P2.

Then, in Step P11, the pattern phase deviation value DD is transmitted to the central control device 12. Then, if, in Step P12, a receipt completion signal on the pattern phase deviation value DD is outputted from the central control device 12, the program returns to Step P2. Then, this procedure is repeated.

In accordance with the above motion flow, the pattern phase deviation value DD (the amount of an error in the pattern position) is computed, and the result of the computation is transmitted to the central control device 12.

Then, the central control device 12 acts in accordance with the motion flow shown in FIGS. 7(a) and 7(b).

If the set speed is inputted to the speed setting instrument 44 in Step P1, the set speed is loaded from the speed setting instrument 44, and stored in the memory M7, in Step P2. Then, in Step P3, counting of the internal clock counter (counter of elapsed time) 39 is started.

Then, in Step P4, the time interval at which the set speed is transmitted to the virtual master generator 13 is loaded from the memory M8, whereafter the count value of the internal clock counter 39 is loaded in Step P5.

Then, in Step P6, it is determined whether the count value of the internal clock counter is equal to or greater than the time interval at which the set speed is transmitted to the virtual master generator. If the answer is Y, in Step P7, the set speed is loaded from the memory M7 for storing the set speed. Then, in Step P8, the set speed is transmitted to the virtual master generator 13, whereafter the program returns to Step P4. If the answer is N, the program shifts to Step P9.

Then, in Step P9, it is determined whether the pattern phase deviation value DD has been transmitted from the pattern phase deviation computing device 18. If the answer is Y, in Step P10, the pattern phase deviation value DD is received from the pattern phase deviation computing device 18, and stored in the memory M9. If the answer is N, the program returns to Step P5.

Then, in Step P11, a receipt completion signal on the pattern phase deviation value DD is transmitted to the pattern phase deviation computing device 18. Then, in Step P12, the time interval at which the set speed is transmitted to the virtual master generator 13 is loaded from the memory M8. Then, in Step P13, the count value of the internal clock counter 39 is loaded.

Then, in Step P14, it is determined whether the count value of the internal clock counter is equal to or greater than the time interval at which the set speed is transmitted to the virtual master generator. If the answer is Y, in Step P15, the set speed is loaded from the memory M7 for storing the set speed. If the answer is N, the program returns to Step P13.

Then, in Step P16, the set speed is transmitted to the virtual master generator 13. Then, in Step P17, the pattern phase deviation value DD is transmitted to the virtual master generator 13. Then, in Step P18, counting of the internal clock counter (counter of elapsed time) 39 is started.

Then, in Step P19, the time interval at which the set speed is transmitted to the virtual master generator 13 is loaded from the memory M8. Then, in Step P20, the count value of the internal clock counter 39 is loaded.

Then, in Step P21, it is determined whether the count value of the internal clock counter is equal to or greater than the time interval at which the set speed is transmitted to the virtual master generator. If the answer is Y, in Step P22, the set speed is loaded from the memory M7 for storing the set speed. Then, in Step P23, the set speed is transmitted to the virtual master generator 13, and the program returns to Step P18. If the answer is N, the program shifts to Step P24.

Then, in Step P24, it is determined whether a pattern phase deviation correction completion signal has been transmitted from the virtual master generator 13. If the answer is Y, in Step P25, the pattern phase deviation correction completion signal is received from the virtual master generator 13. If the answer is N, the program returns to Step P20.

Then, in Step P26, the time interval at which the set speed is transmitted to the virtual master generator 13 is loaded from the memory M8. Then, in Step P27, the count value of the internal clock counter 39 is loaded.

Then, if, in Step P28, the count value of the internal clock counter is equal to or greater than the time interval at which the set speed is transmitted to the virtual master generator, in Step P29, the set speed is loaded from the memory M7 for storing the set speed. Then, in Step P30, the set speed is transmitted to the virtual master generator 13, and the program returns to Step P3. Then, this procedure is repeated.

In accordance with the above-mentioned motion flow, the set speed and the pattern phase deviation value DD (the amount of an error in the pattern position) are transmitted to the virtual master generator 13 at predetermined time intervals.

Then, the virtual master generator 13 acts in accordance with the motion flow shown in FIGS. 8(a), 8(b) and 9(a) and 9(b).

In Step P1, zero is written into the memory M20 for storing the pattern phase deviation value DD, and then in Step P2, zero is written into the memory M10 for storing the previous set speed.

Then, in Step P3, the correction value of the current position of the master machine is loaded from the memory M11. Then, in Step P4, the correction value of the current position of the master machine is written into the memory M12 for storing the virtual current position of the motor shaft of the master machine.

Then, in Step P5, the correction value of the current position of the slave machine is loaded from the memory M13. Then, in Step P6, the correction value of the current position of the slave machine is written into the memory M14 for storing the virtual current position of the motor shaft of the slave machine.

Then, in Step P7, it is determined whether the set speed has been transmitted from the central control device 12. If the answer is Y, in Step P8, the set speed is received from the central control device 12, and stored in the memory M15 for storing the current set speed. If the answer is N, the program shifts to Step P23, as described later.

Then, in Step P9, the previous set speed is loaded from the memory M10 for storing the previous set speed. Then, in Step P10, the time interval at which the set speed is transmitted by the central control device 12 to the virtual master generator 13 is loaded from the memory M16 for storing the time interval at which the set speed is transmitted to the virtual master generator.

Then, in Step P11, the modification value of the virtual current position is computed from the loaded previous set speed and the loaded time interval at which the set speed is transmitted by the central control device 12 to the virtual master generator 13, and the computed value is stored into the memory M17. Then, in Step P12, the virtual current position of the motor shaft of the master machine is loaded from the memory M12.

Then, in Step P13, the computed modification value of the virtual current position is added to the loaded virtual current position of the motor shaft of the master machine to compute the modified virtual current position of the motor shaft of the master machine, and the computed value is stored into the memory M18. Then, in Step P14, the virtual current position of the motor shaft of the slave machine is loaded from the memory M14.

Then, in Step P15, the computed modification value of the virtual current position is added to the loaded virtual current position of the motor shaft of the slave machine to compute the modified virtual current position of the motor shaft of the slave machine, and the computed value is stored into the memory M19. Then, in Step P16, the current set speed and the computed modified virtual current position of the motor shaft of the master machine are transmitted to the drive control device 14 for the master machine.

Then, in Step P17, the current set speed and the computed modified virtual current position of the motor shaft of the slave machine are transmitted to the drive control device 114 for the slave machine. Then, in Step P18, the current set speed is stored in the memory M10 for storing the previous set speed.

Then, in Step P19, the modified virtual current position of the motor shaft of the master machine is loaded from the memory M18. Then, in Step P20, the modified virtual current position of the motor shaft of the master machine is written into the memory M12 for storing the virtual current position of the motor shaft of the master machine.

Then, in Step P21, the modified virtual current position of the motor shaft of the slave machine is loaded from the memory M19. Then, in Step P22, the modified virtual current position of the motor shaft of the slave machine is written in the memory M14 for storing the virtual current position of the motor shaft of the slave machine. Then, the program returns to Step P7.

Then, in Step P23, it is determined whether the pattern phase deviation value DD has been transmitted from the central control device 12. If the answer is Y, in Step P24, the pattern phase deviation value DD is received from the central control device 12, and stored in the memory M20. If the answer is N, the program returns to Step P7.

Then, in Step P25, a pattern phase deviation correction control start command is transmitted to the drive control device (14, 114) of each printing press. Then, in Step P26, the virtual current position of the motor shaft of the slave machine is loaded from the memory M14.

Then, in Step P27, the received pattern phase deviation value DD is added to the loaded virtual current position of the motor shaft of the slave machine, and the memory M14 for storing the virtual current position of the motor shaft of the slave machine is overwritten with the obtained value. Then, in Step P28, it is determined whether the set speed has been transmitted from the central control device 12.

Then, if the answer is Y in the above Step P28, Step P29 is executed to receive the set speed from the central control device 12 and store it in the memory M15 for storing the current set speed. Then, in Step P30, the previous set speed is loaded from the memory M10 for storing the previous set speed.

Then, in Step P31, the time interval at which the set speed is transmitted by the central control device 12 to the virtual master generator 13 is loaded from the memory M16 for storing the time interval at which the set speed is transmitted to the virtual master generator. Then, in Step P32, the modification value of the virtual current position is computed from the loaded previous set speed and the loaded time interval at which the set speed is transmitted by the central control device to the virtual master generator, and the computed value is stored into the memory M17.

Then, in Step P33, the virtual current position of the motor shaft of the master machine is loaded from the memory M12. Then, in Step P34, the computed modification value of the virtual current position is added to the loaded virtual current position of the motor shaft of the master machine to compute the modified virtual current position of the motor shaft of the master machine, and the computed value is stored in the memory M18.

Then, in Step P35, the virtual current position of the motor shaft of the slave machine is loaded from the memory M14. Then, in Step P36, the computed modification value of the virtual current position is added to the loaded virtual current position of the motor shaft of the slave machine to compute the modified virtual current position of the motor shaft of the slave machine, and the computed value is stored into the memory M19.

Then, in Step P37, the current set speed and the computed modified virtual current position of the motor shaft of the master machine are transmitted to the drive control device 14 for the master machine. Then, in Step P38, the current set speed and the computed modified virtual current position of the motor shaft of the slave machine are transmitted to the drive control device 114 for the slave machine.

Then, in Step P39, the current set speed is stored in the memory M10 for storing the previous set speed. Then, in Step P40, the modified virtual current position of the motor shaft of the master machine is loaded from the memory M18. Then, in Step P41, the modified virtual current position of the motor shaft of the master machine is written in the memory M12 for storing the virtual current position of the motor shaft of the master machine.

Then, in Step P42, the modified virtual current position of the motor shaft of the slave machine is loaded from the memory M19. Then, in Step P43, the modified virtual current position of the motor shaft of the slave machine is written into the memory M14 for storing the virtual current position of the motor shaft of the slave machine. Then, the program returns to Step P28.

Then, if the answer is N in the aforementioned Step P28, it is determined in Step P44 whether a pattern phase deviation correction control completion signal has been transmitted from the drive control device (14, 114) of the printing press. If the answer is Y, in Step P45, the pattern phase deviation correction control completion signal is received from the drive control device (14, 114) of the printing press. If the answer is N, the program returns to Step P28.

Then, in Step P46, the number of the printing press having received the pattern phase deviation correction control completion signal is stored into the memory M21. Then, in Step P47, it is determined whether pattern phase deviation correction control has been completed in all printing presses. If the answer is Y, in Step P48, a pattern phase deviation correction completion signal is transmitted to the central control device 12, and the program returns to Step P7. If the answer is N, the program returns to Step P28. Afterwards, this procedure is repeated.

In accordance with the above-described motion flow, the current set speed and the virtual position where the motor shaft in each of the master machine and the slave machine should be located (in the slave machine, the position corrected with the pattern phase deviation value DD, if necessary) are computed, stored, and transmitted to the drive control devices 14, 114 for the master machine and the slave machine.

Then, the drive control devices 14, 114 for the master machine and the slave machine act in accordance with the motion flow shown in FIGS. 10 and 11.

In Step P1, it is determined whether the current set speed and the modified virtual current position of the motor shaft have been transmitted from the virtual master generator 13. If the answer is Y, in Step P2, the current set speed and the modified virtual current position of the motor shaft are received from the virtual master generator 13, and stored in the memory M22 for storing the current set speed, and the memory M23 for storing the virtual current position of the motor shaft. If the answer is N, the program shifts to Step P18 to be described later.

Then, in Step P3, the count value is loaded from the counter 59 for detecting the position of the motor shaft, and stored into the memory M24. Then, in Step P4, the current position of the motor shaft is computed from the loaded count value of the counter 59 for detecting the position of the motor shaft, and stored in the memory M25.

Then, in Step P5, the computed current position of the motor shaft is subtracted from the received virtual current position of the motor shaft to compute the difference of the current position of the motor shaft, which is stored into the memory M26. Then, in Step P6, the absolute value of the difference of the current position of the motor shaft is computed from the computed difference of the current position of the motor shaft, and stored into the memory M27.

Then, in Step P7, the allowable value of the difference in the position of the motor shaft is loaded from the memory M28. Then, in Step P8, it is determined whether the computed absolute value of the difference of the current position of the motor shaft is equal to or less than the loaded allowable value of the difference in the position of the motor shaft. If the answer is Y, in Step P9, the current set speed is loaded from the memory M2 for storing the current set speed. If the answer is N, the program shifts to Step P12, as described later.

Then, in Step P10, the current set speed is written into the memory M29 for storing the command speed. Then, in Step P11, the command speed is outputted to the driver 58 for the drive motor, and the program returns to Step P1.

Then, in Step P12, the table of conversion from the difference of the current position of the motor shaft to the correction value of the set speed is loaded from the memory M30. Then, in Step P13, the difference of the current position of the motor shaft is loaded from the memory M26.

Then, in Step P14, the correction value of the set speed is obtained from the difference of the current position of the motor shaft with the use of the table of conversion from the difference of the current position of the motor shaft to the correction value of the set speed, and the obtained value is stored into the memory M31. Then, in Step P15, the current set speed is loaded from the memory M22 for storing the current set speed.

Then, in Step P16, the obtained correction value of the set speed is added to the loaded current set speed to compute the command speed, which is stored into the memory M29. Then, in Step P17, the command speed is outputted to the driver 58 for the drive motor, and the program returns to Step P1.

Then, in Step P18, it is determined whether a pattern phase deviation correction control start command has been transmitted from the virtual master generator 13. If the answer is Y, in Step P19, the pattern phase deviation correction control start command is received from the virtual master generator 13. If the answer is N, the program returns to Step P1.

Then, if, in Step P20, the current set speed and the modified virtual current position of the motor shaft are transmitted from the virtual master generator 13, in Step P21, the current set speed and the modified virtual current position of the motor shaft are received from the virtual master generator 13, and stored into the memory M22 for storing the current set speed, and the memory M23 for storing the virtual current position of the motor shaft.

Then, in Step P22, the count value is loaded from the counter 59 for detecting the position of the motor shaft, and stored into the memory M24. Then, in Step P23, the current position of the motor shaft is computed from the loaded count value of the counter 59 for detecting the position of the motor shaft, and stored into the memory M25.

Then, in Step P24, the computed current position of the motor shaft is subtracted from the received virtual current position of the motor shaft to compute the difference of the current position of the motor shaft, which is stored into the memory M26. Then, in Step P25, the absolute value of the difference of the current position of the motor shaft is computed from the computed difference of the current position of the motor shaft, and stored into the memory M27.

Then, in Step P26, the allowable value of the difference in the position of the motor shaft is loaded from the memory M28. Then, in Step P27, it is determined whether the computed absolute value of the difference of the current position of the motor shaft is equal to or less than the loaded allowable value of the difference in the position of the motor shaft. If the answer is Y, in Step P28, the current set speed is loaded from the memory M22 for storing the current set speed. If the answer is N, the program shifts to Step P32 to be described later.

Then, in Step P29, the current set speed is written into the memory M29 for storing the command speed. Then, in Step P30, the command speed is outputted to the driver 58 for the drive motor. Then, in Step P31, a pattern phase deviation correction control completion signal is transmitted to the virtual master generator 13, and the program returns to Step P1.

Then, in Step P32, the table of conversion from the difference of the current position of the motor shaft to the correction value of the set speed is loaded from the memory M30. Then, in Step P33, the difference of the current position of the motor shaft is loaded from the memory M26.

Then, in Step P34, the correction value of the set speed is obtained from the difference of the current position of the motor shaft with the use of the table of conversion from the difference of the current position of the motor shaft to the correction value of the set speed, and the obtained value is stored into the memory M31. Then, in Step P35, the current set speed is loaded from the memory M22 for storing the current set speed.

Then, in Step P36, the obtained correction value of the set speed is added to the loaded current set speed to compute the command speed, which is stored in the memory M29. Then, in Step P37, the command speed is outputted to the driver 58 for the drive motor, and the program returns to Step P20. Afterwards, this procedure is repeated.

In accordance with the above-described motion flow, when the pattern phase deviation correction control start command is transmitted from the virtual master generator 13, the obtained correction value of the set speed is added to the loaded current set speed to compute the command speed, which is outputted to the driver 58 for the drive motor of the printing press. In response to the command speed, a correction is made such that the position of the pattern printed by the slave machine B and the position of the pattern printed by the master machine A are in predetermined position, whereupon the drive motors 15 and 115 of the printing presses are synchronously controlled.

In the present embodiment, as described above, the rotation phase of the drive motor 115 of the slave machine B is directly adjusted by the virtual master generator 13 based on the position of the pattern by the slave machine B detected by the pattern phase deviation detecting sensor 17. Thus, the position of the pattern printed by the master machine A and the position of the pattern printed by the slave machine B can be automatically brought into correct alignment.

Accordingly, burden on the operator can be lessened, and the amount of occurrence of defective printing products can be cut down. In the present embodiment, there may be a plurality of the slave machines B.

### Embodiment 2

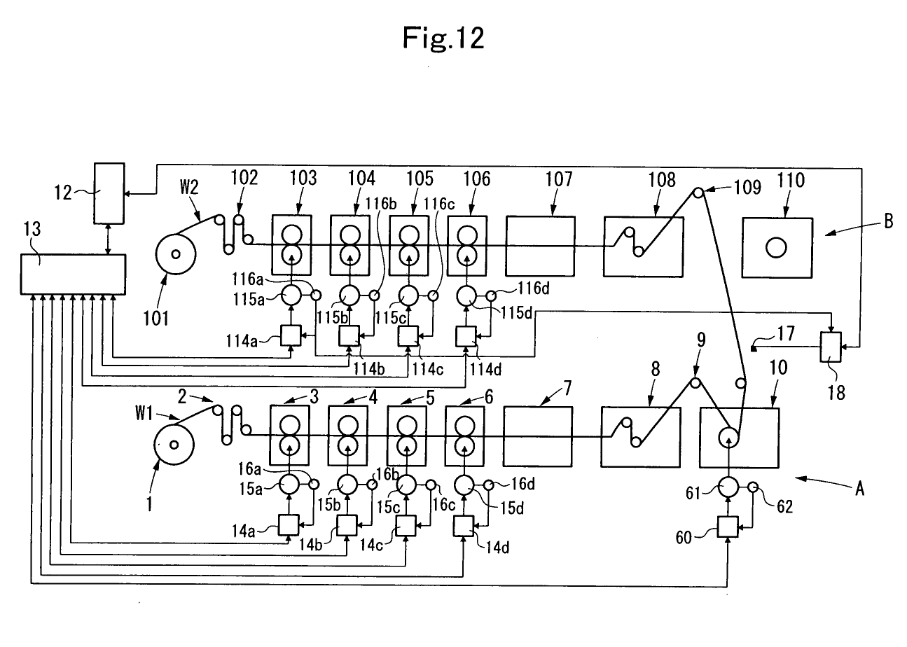

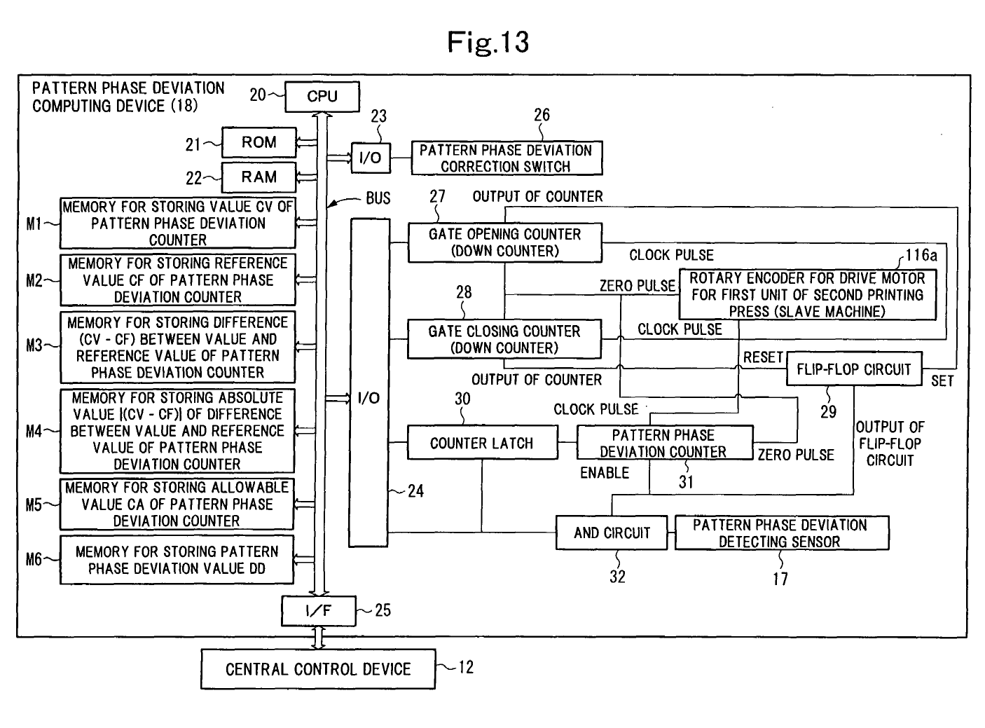

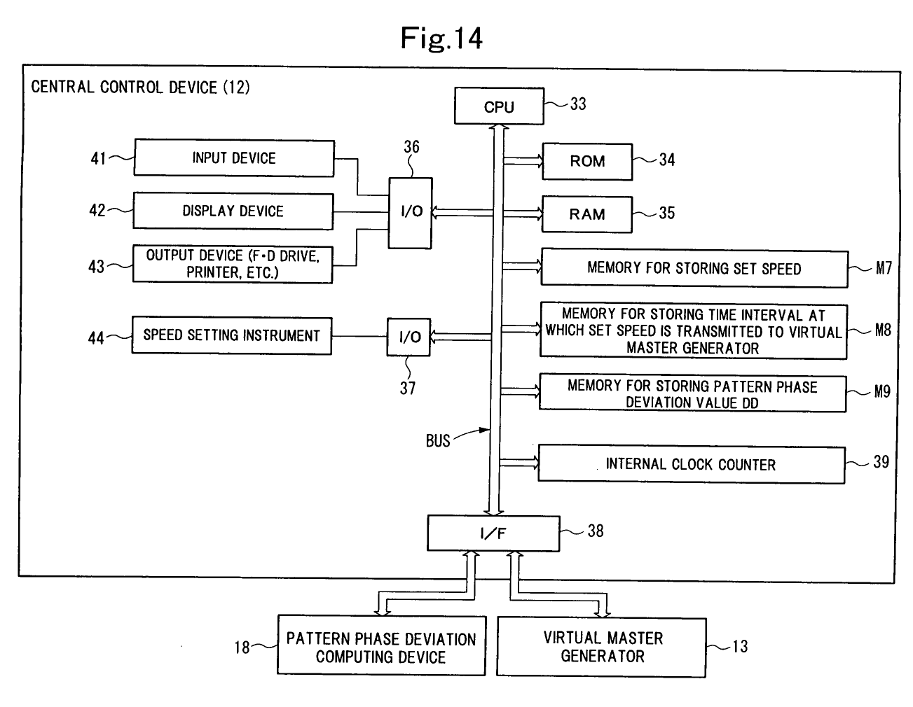

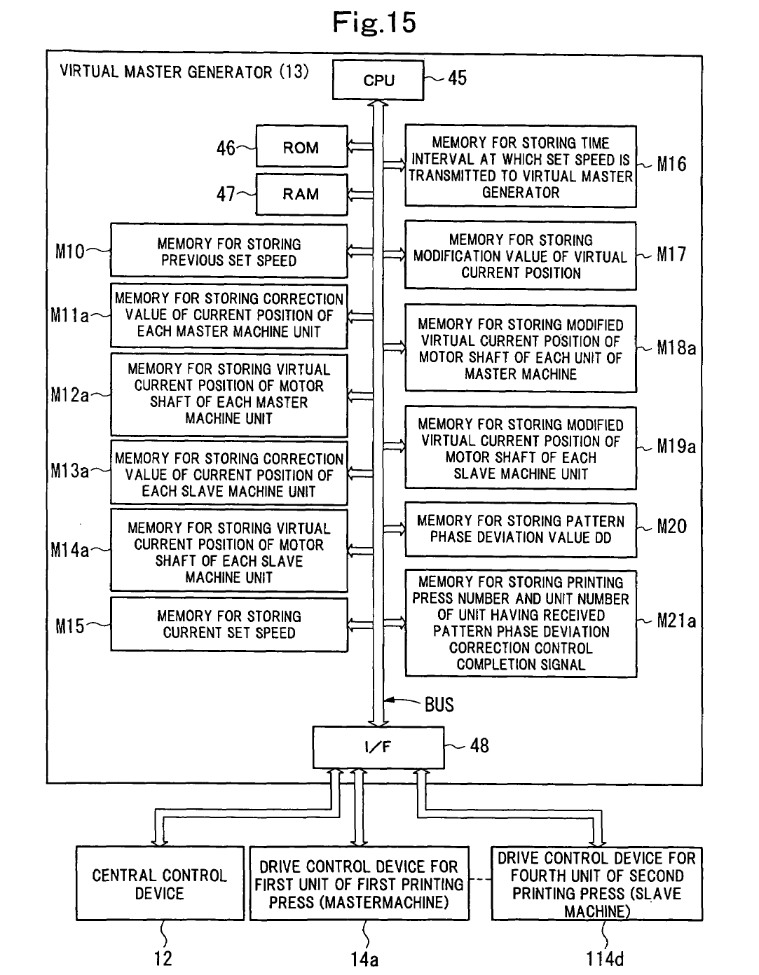

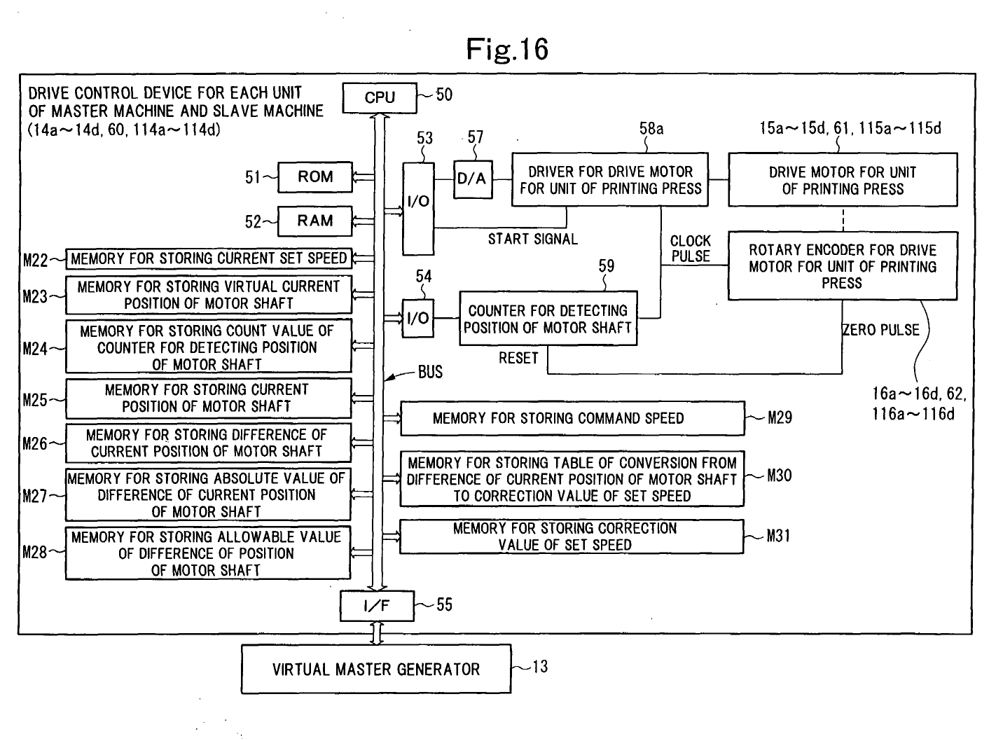

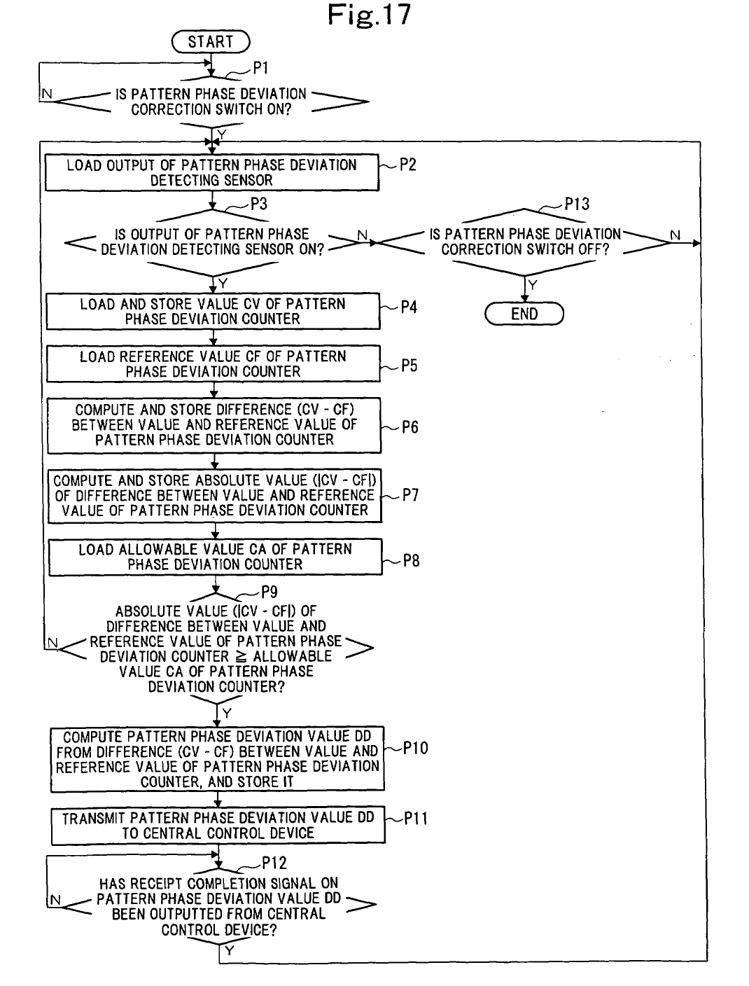

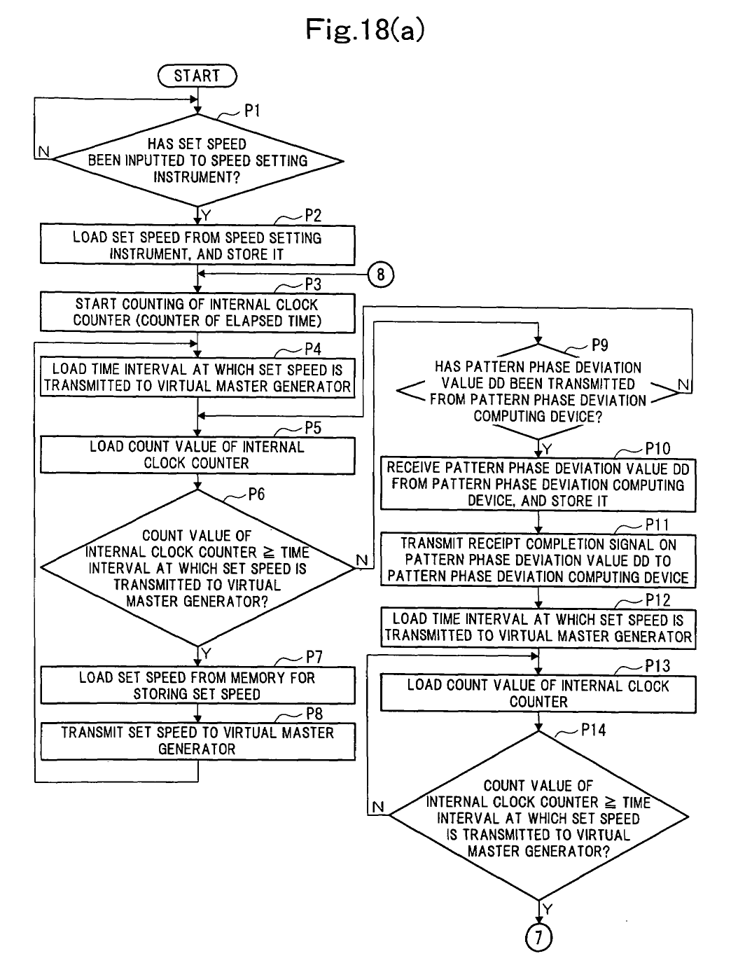

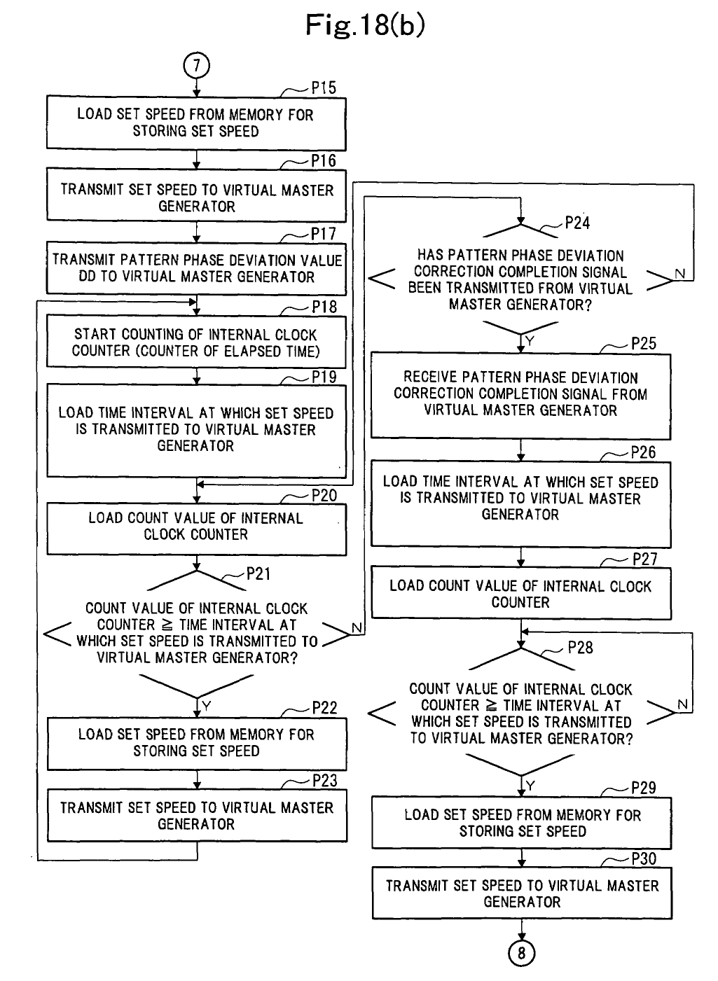

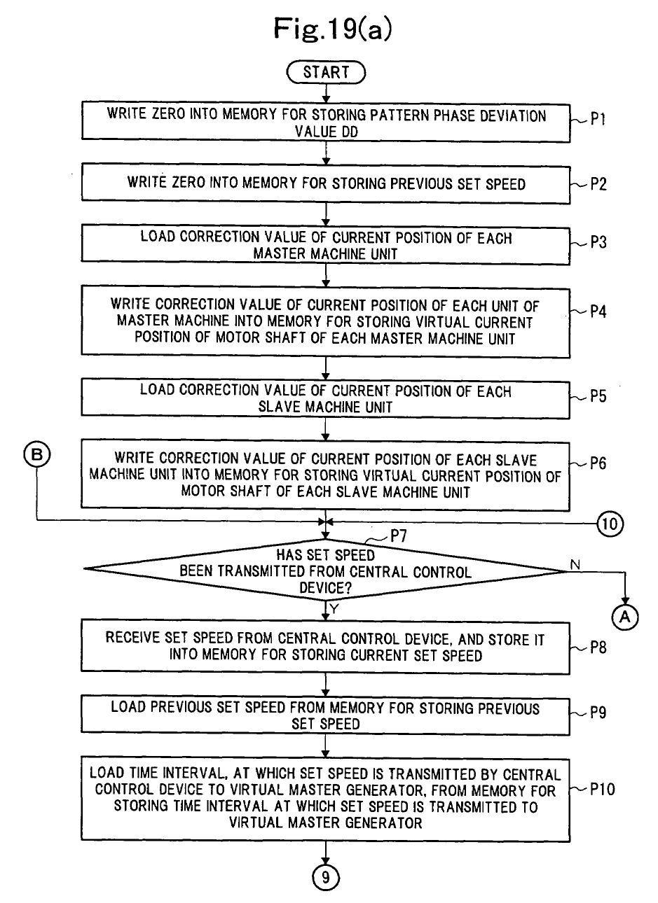

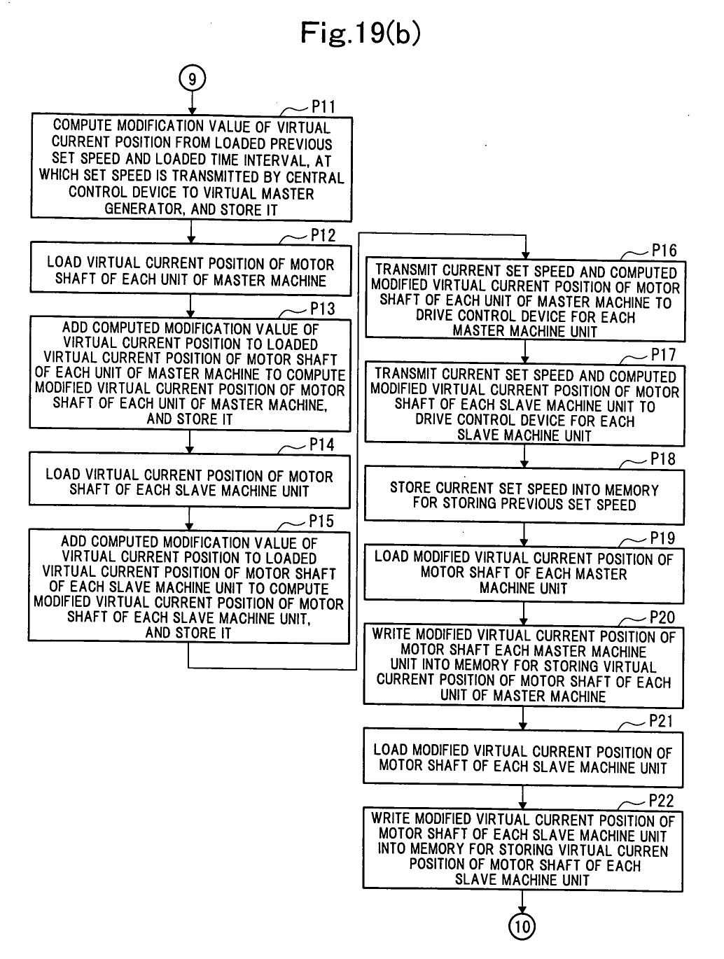

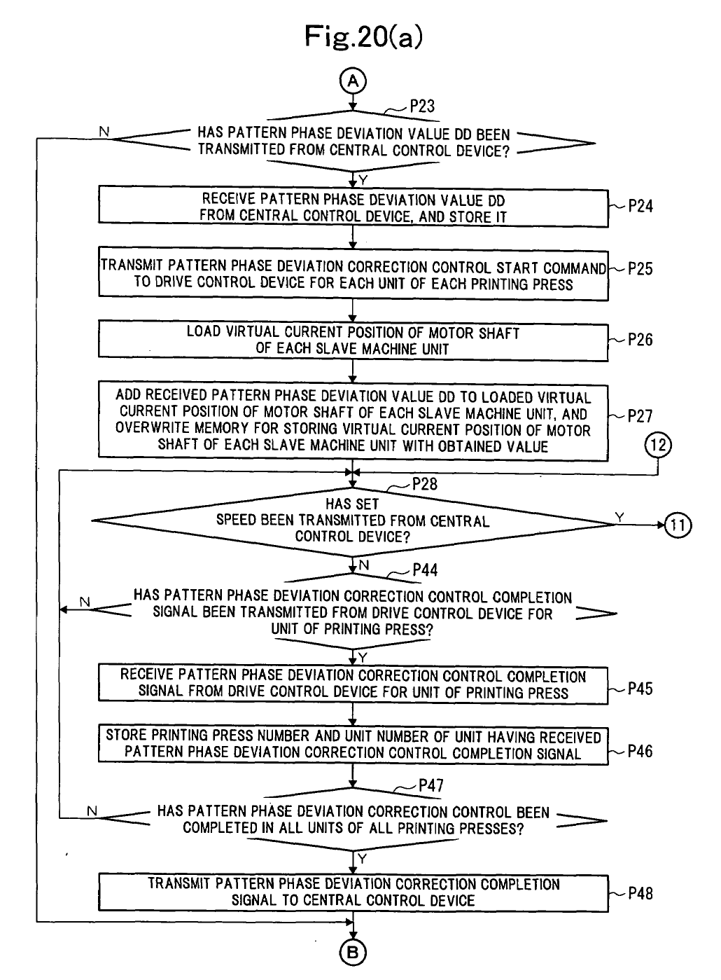

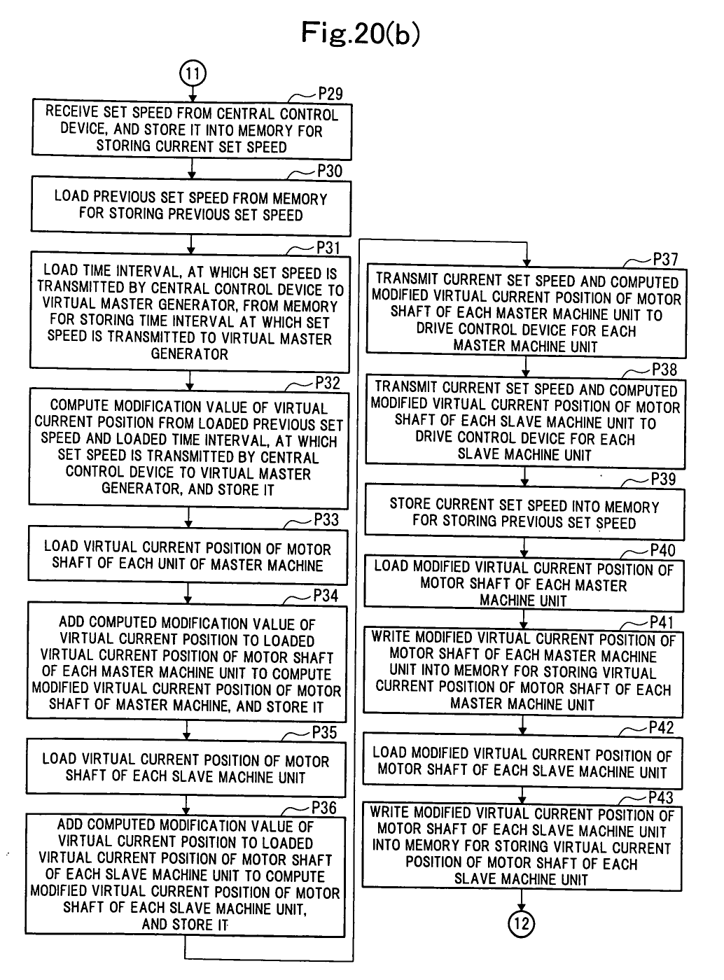

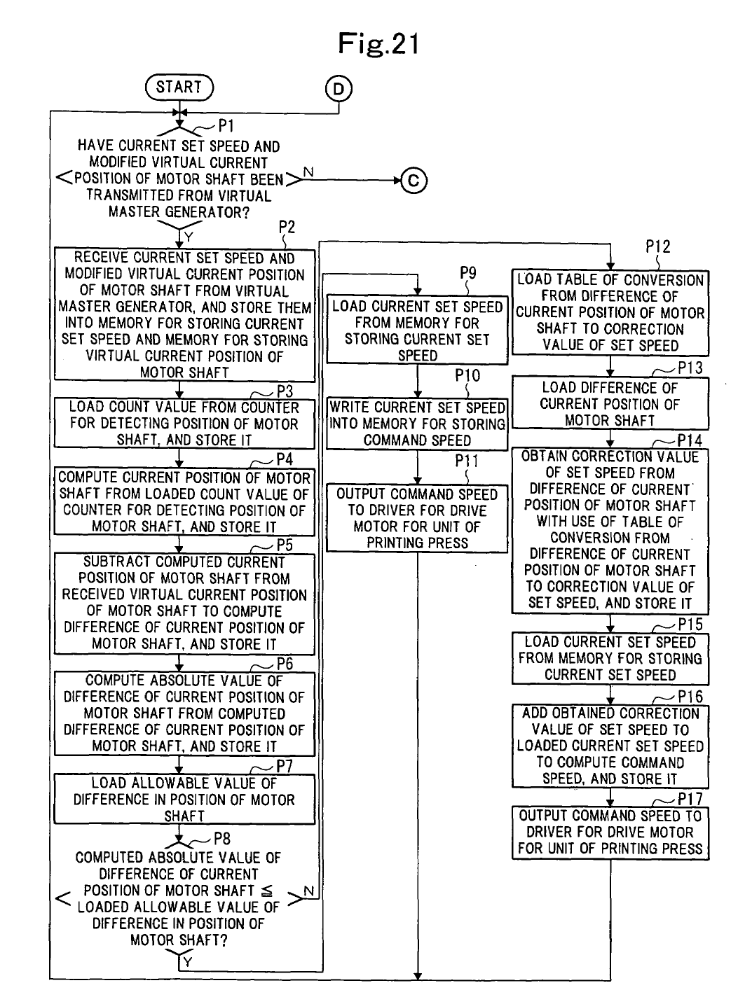

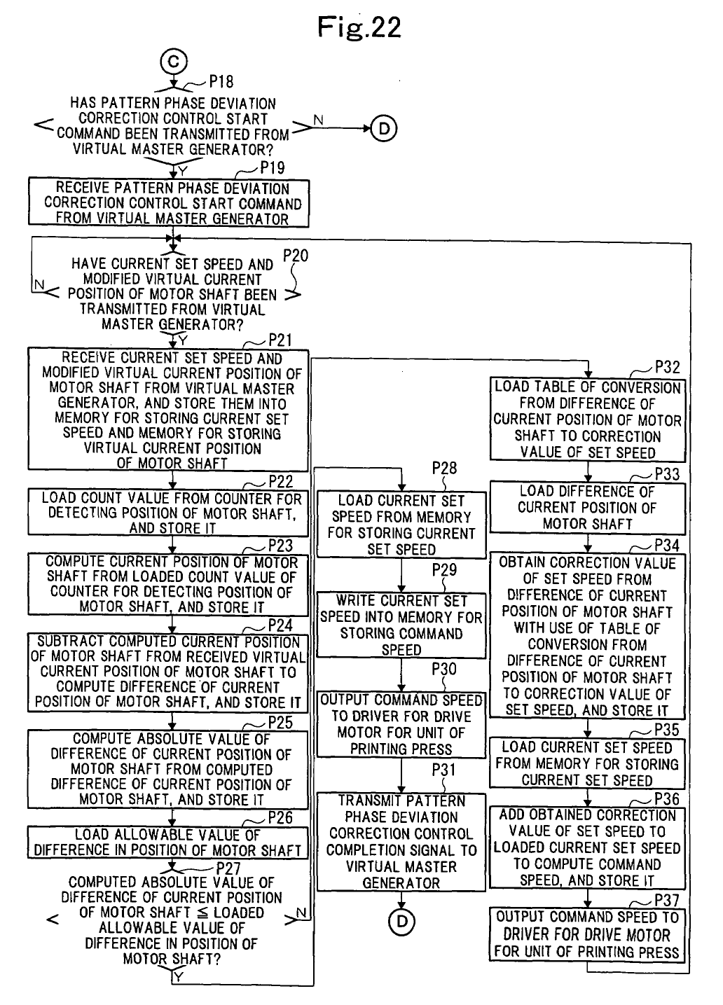

FIG. 12 is a schematic configurational drawing of a synchronous control apparatus for a web rotary printing press showing Embodiment 2 of the present invention. FIG. 13 is a block diagram of a pattern phase deviation computing device. FIG. 14 is a block diagram of a central control device. FIG. 15 is a block diagram of a virtual master generator. FIG. 16 is a block diagram of a drive control device for each unit of a master machine and a slave machine. FIG. 17 is a motion flow chart of the pattern phase deviation computing device. FIG. 18(a) is a motion flow chart of the central control device. FIG. 18(b) is a motion flow chart of the central control device. FIG. 19(a) is a motion flow chart of the virtual master generator. FIG. 19(b) is a motion flow chart of the virtual master generator. FIG. 20(a) is a motion flow chart of the virtual master generator. FIG. 20(b) is a motion flow chart of the virtual master generator. FIG. 21 is a motion flow chart of the drive control device for each unit of the master machine and the slave machine. FIG. 22 is a motion flow chart of the drive control device for each unit of the master machine and the slave machine.

In a first printing press (master machine) A comprising a web rotary printing press as a first rolled paper rotary printing press, as shown in FIG. 12, a roll of paper (web) W1 continuously fed from a feeder 1 and an infeed unit 2 is subjected to various printings as it passes through first to fourth (printing) units 3 to 6. Then, the web is heated to dry when it passes through a dryer 7, and is then cooled when it passes through a cooling unit 8. Then, when the web passes over a drag unit 9, its tension is controlled or its direction is changed. Then, the web is cut to a predetermined shape and folded by a folder 10.

The first to fourth printing units 3 to 6 and the folder 10 are driven individually by drive motors 15a to 15d and a drive motor 61. Rotary encoders 16a to 16d and 62 for detecting the rotational speeds of these drive motors 15a to 15d, 61 are connected to the drive motors 15a to 15d, 61. The drive motors 15a to 15d, 61 are drivingly controlled by drive control devices 14a to 14d, 60, and detection signals from the rotary encoders 16a to 16d, 62 are inputted to the drive control devices 14a to 14d, 60.

In a second printing press (slave machine) B having a web rotary printing press as a second rolled paper rotary printing press, on the other hand, a roll of paper (web) W2 continuously fed from a feeder 101 and an infeed unit 102 is subjected to various printings when it passes through first to fourth (printing) units 103 to 106. Then, the web is heated to dry when it passes through a dryer 107, and is then cooled when it passes through a cooling unit 108. Then, when the web passes over a drag unit 109, its tension is controlled or its direction is changed. Then, the web is cut to a predetermined shape and then folded by a folder 110.

The first to fourth printing units 103 to 106 are driven individually by drive motors 115a to 115d. Rotary encoders 116a to 116d for detecting the rotational speeds of the drive motors 115a to 115d are connected to the drive motors 115a to 115d. The drive motors 115a to 115d are drivingly controlled by drive control devices 114a to 114d, respectively, and detection signals from the rotary encoders 116a to 116d are inputted to the drive control devices 114a to 114d. The folder 110 may also be driven individually by a drive motor.

The drive control devices 14a to 14d, 60 and 114a to 114d for the respective units of the master machine and the slave machine are connected to a central control device (control means) 12 via a virtual master generator 13, and the master machine A and the slave machine B are synchronously controlled (operated) by the central control device 12. That is, in the present embodiment, the webs W1 and W2 printed by the master machine A and the slave machine B are both guided to the folder 10 of the master machine A, where they are folded.

A pattern phase deviation detecting sensor (pattern position measuring means) 17, such as a scanning sensor, for measuring the position of a pattern (strictly, a register mark), which is printed by the slave machine B, is provided halfway through a transport path on which the web W2 printed by the slave machine B is transferred so that it is superposed on the web W1 printed by the master machine A.

A detection signal from the pattern phase deviation detecting sensor 17 is inputted to a pattern phase deviation computing device (control means) 18, together with the detection signal from the rotary encoder 116a in the first unit 103 of the slave machine B. The amount of an error in the pattern position (pattern phase deviation value DD) computed by the pattern phase deviation computing device 18 is inputted to the central control device 12. The central control device 12 controls the rotation phase of the drive motors 115a to 115d of the slave machine B in accordance with this error amount (pattern phase deviation value DD), thereby bringing the position of the pattern printed by the master machine A and the position of the pattern printed by the slave machine B into alignment.

As shown in FIG. 13, the pattern phase deviation computing device 18 comprises CPU 20, ROM 21, RAM 22, input/output devices 23 and 24, and an interface 25 connected together by BUS (bus line). To the BUS, the following memories are connected: A memory M1 for storing the value CV of a pattern phase deviation counter, a memory M2 for storing the reference value CF of the pattern phase deviation counter, a memory M3 for storing the difference (CV−CF) between the value and the reference value of the pattern phase deviation counter, a memory M4 for storing the absolute value |(CV−CF)| of the difference between the value and the reference value of the pattern phase deviation counter, a memory M5 for storing the allowable value CA of the pattern phase deviation counter, and a memory M6 for storing the pattern phase deviation value DD.

A pattern phase deviation correction switch 26 is connected to the input/output device 23.

To the input/output device 24, a gate opening counter (down counter) 27 and a gate closing counter (down counter) 28 are connected, a pattern phase deviation counter 31 is connected via a counter latch 30, and the pattern phase deviation detecting sensor 17 is connected via an AND circuit 32, respectively. A rotary encoder 116a for the drive motor for the first unit of the second printing press (slave machine) is connected to the gate opening counter (down counter) 27 and the gate closing counter (down counter) 28, and the rotary encoder 116a for the drive motor for the first unit of the second printing press (slave machine) is also connected to the pattern phase deviation counter 31. A flip-flop circuit 29 is connected to the gate opening counter (down counter) 27 and the gate closing counter (down counter) 28, and the flip-flop circuit 29 is also connected to the pattern phase deviation counter 31 and the AND circuit 32. The AND circuit 32 is also connected to the counter latch 30.

In the input/output device 24, therefore, the gate opening counter 27, the gate closing counter 28, and the pattern phase deviation counter 31 are reset by a zero pulse generated by the rotary encoder 116a for the drive motor for the first unit of the second printing press in accordance with the rotation of the drive motor 115a for the first unit of the second printing press. Then, the gate opening counter 27 counts up in accordance with a clock pulse generated by the rotary encoder 116a, whereupon the flip-flop circuit 29 is set by the output of the counter 27. As a result, the pattern phase deviation counter 31 starts counting, and the AND circuit 32 is opened, in accordance with the output from the flip-flop circuit 29. When the signal from the pattern phase deviation detecting sensor 17 is inputted, the count value of the counter 31 at this time is held by the counter latch 30.

Then, the gate closing counter 28 counts up in accordance with the clock pulse generated by the rotary encoder 116a, whereupon the flip-flop circuit 29 is reset by the output of the counter 28. Consequently, the output from the flip-flop circuit 29 is stopped, whereby the pattern phase deviation counter 31 stops counting, and the AND circuit 32 is closed, so that the input signal from the pattern phase deviation detecting sensor 17 is shut off. In this manner, the pattern phase deviation is detected only with a predetermined timing preset by the gate opening counter 27 and the gate closing counter 28.

The central control device 12 to be described later is connected to the interface 25.

As shown in FIG. 14, the central control device 12 has CPU 33, ROM 34, RAM 35, input/output devices 36, 37, and an interface 38 connected together by BUS (bus line). To the BUS, the following are connected: a memory M7 for storing a set speed, a memory M8 for storing a time interval at which the set speed is transmitted to the virtual master generator, a memory M9 for storing the pattern phase deviation value DD, and an internal clock counter 39.

To the input/output device 36, the following are connected: an input device 41 such as a keyboard, various switches, buttons, a display device 42 such as CRT and lamps, and an output device 43 such as a printer and a floppy disk (registered trademark) drive. A speed setting instrument 44 is connected to the input/output device 37. The aforementioned pattern phase deviation computing device 18 and the virtual master generator 13 (as described later) are connected to the interface 38.

As shown in FIG. 15, the virtual master generator 13 comprises CPU 45, ROM 46, RAM 47, and an interface 48 connected together by BUS (bus line). To the BUS, the following memories are connected: a memory M10 for storing the previous set speed, a memory M11a for storing the correction value of the current position of each unit of the master machine, a memory M12a for storing the virtual current position of the motor shaft of each unit of the master machine, a memory M13a for storing the correction value of the current position of each unit of the slave machine, a memory M14a for storing the virtual current position of the motor shaft of each unit of the slave machine, a memory M15 for storing the current set speed, a memory M16 for storing a time interval at which the set speed is transmitted to the virtual master generator, a memory M17 for storing a modification value of the virtual current position, a memory M18a for storing the modified virtual current position of the motor shaft of each unit of the master machine, a memory M19a for storing the modified virtual current position of the motor shaft of each unit of the slave machine, a memory M20 for storing the pattern phase deviation value DD, and a memory M21a for storing the printing press number and the unit number of the unit having received a pattern phase deviation correction control completion signal.

To the interface 48, the following are connected: the aforementioned central control device 12, drive control device 14a (to be described later) for the first unit of the first printing press (master machine), and drive control device 114d (to be described later) for the fourth unit of the second printing press (slave machine).

As shown in FIG. 16, the drive control device (14a to 14d, 60, 114a to 114d) of each unit of the master machine and the slave machine comprises CPU 50, ROM 51, RAM 52, input/output devices 53, 54, and an interface 55 connected together by BUS (bus line). To the BUS, the following memories are connected: a memory M22 for storing the current set speed, a memory M23 for storing the virtual current position of the motor shaft, a memory M24 for storing the count value of a counter for detecting the position of the motor shaft, a memory M25 for storing the current position of the motor shaft, a memory M26 for storing the difference of the current position of the motor shaft, a memory M27 for storing the absolute value of the difference of the current position of the motor shaft, a memory M28 for storing the allowable value of the difference of the position of the motor shaft, a memory M29 for storing a command speed, a memory M30 for storing a table of conversion from the difference of the current position of the motor shaft to the correction value of the set speed, and a memory M31 for storing the correction value of the set speed.

The drive motor (15a to 15d, 61, 115a to 115d) for the unit of the printing press is connected to the input/output device 53 via a D/A converter 57 and a driver 58a for the drive motor for the unit of the printing press. A counter 59 for detecting the position of the motor shaft is connected to the input/output device 54. The rotary encoder (16a to 16d, 62, 116a to 116d) for the drive motor for the unit of the printing press, which is drivingly coupled to the drive motor (15a to 15d, 61, 115a to 115d) for the unit of the printing press, is connected to the driver 58a for the drive motor for the unit of the printing press and the counter 59 for detecting the position of the motor shaft. The aforementioned virtual master generator 13 is connected to the interface 55.

Because of the above configurations, when the master machine A and the slave machine B are to be synchronously controlled, the pattern phase deviation computing device 18 acts in accordance with a motion flow shown in FIG. 17 in the same manner as in FIG. 6.

If the pattern phase deviation correction switch 26 is ON in Step P1, the output of the pattern phase deviation detecting sensor 17 is loaded in Step P2. Then, in Step P3, it is determined whether the output of the pattern phase deviation detecting sensor 17 is ON.

If the answer is Y (yes) in the above Step P3, the value CV of the pattern phase deviation counter 31 is loaded and stored into the memory M1 in Step P4. If the answer is N (no) in Step P3, it is determined in Step P13 whether the pattern phase deviation correction switch 26 is OFF. If the answer is Y in Step P13, the action is completed. If the answer is N, the program returns to Step P2.

Then, in Step P5, the reference value CF of the pattern phase deviation counter 31 is loaded from the memory M2. Then, in Step P6, the difference (CV−CF) between the value and the reference value of the pattern phase deviation counter is computed, and then stored in the memory M3. The reference value CF of the pattern phase deviation counter corresponds to the rotation phase of the first unit of the slave machine B, in which the pattern printed by the slave machine B is detected by the pattern phase deviation detecting sensor 17, with the position of the pattern printed by the master machine A (first printing press) and the position of the pattern printed by the slave machine B (second printing press) being aligned in the folder 10, in consideration of the amount of elongation of the web W1 printed by the master machine A.

Then, in Step P7, the absolute value (|CV-CF|) of the difference between the value and the reference value of the pattern phase deviation counter is computed, and then stored in the memory M4. Then, in Step P8, the allowable value CA of the pattern phase deviation counter is loaded from the memory M5.

Then, in Step P9, it is determined whether the absolute value (|CV−CF|) of the difference between the value and the reference value of the pattern phase deviation counter is equal to or greater than the allowable value CA of the pattern phase deviation counter. If the answer is Y, in Step P10, the pattern phase deviation value DD is computed from the difference (CV−CF) between the value and the reference value of the pattern phase deviation counter, and stored into the memory M6. If the answer is N, the program returns to Step P2.

Then, in Step P11, the pattern phase deviation value DD is transmitted to the central control device 12. Then, if, in Step P12, a receipt completion signal on the pattern phase deviation value DD is outputted from the central control device 12, the program returns to Step P2. Then, this procedure is repeated.

In accordance with the above motion flow, the pattern phase deviation value DD (the amount of an error in the pattern position) is computed, and the result of the computation is transmitted to the central control device 12.

Then, the central control device 12 acts in accordance with the motion flow shown in FIGS. 18(a), 18(b) as in the case of FIGS. 7(a), 7(b).

If the set speed is inputted to the speed setting instrument 44 in Step P1, the set speed is loaded from the speed setting instrument 44, and stored into the memory M7, in Step P2. Then, in Step P3, counting of the internal clock counter (counter of elapsed time) 39 is started.

Then, in Step P4, the time interval at which the set speed is transmitted to the virtual master generator 13 is loaded from the memory M8, whereafter the count value of the internal clock counter 39 is loaded in Step P5.

Then, in Step P6, it is determined whether the count value of the internal clock counter is equal to or greater than the time interval at which the set speed is transmitted to the virtual master generator. If the answer is Y, in Step P7, the set speed is loaded from the memory M7 for storing the set speed. Then, in Step P8, the set speed is transmitted to the virtual master generator 13, whereafter the program returns to Step P4. If the answer is N, the program shifts to Step P9.

Then, in Step P9, it is determined whether the pattern phase deviation value DD has been transmitted from the pattern phase deviation computing device 18. If the answer is Y, in Step P10, the pattern phase deviation value DD is received from the pattern phase deviation computing device 18, and stored into the memory M9. If the answer is N, the program returns to Step P5.

Then, in Step P11, a receipt completion signal on the pattern phase deviation value DD is transmitted to the pattern phase deviation computing device 18. Then, in Step P12, the time interval at which the set speed is transmitted to the virtual master generator 13 is loaded from the memory M8. Then, in Step P13, the count value of the internal clock counter 39 is loaded.

Then, in Step P14, it is determined whether the count value of the internal clock counter is equal to or greater than the time interval at which the set speed is transmitted to the virtual master generator. If the answer is Y, in Step P15, the set speed is loaded from the memory M7 for storing the set speed. If the answer is N, the program returns to Step P13.

Then, in Step P16, the set speed is transmitted to the virtual master generator 13. Then, in Step P17, the pattern phase deviation value DD is transmitted to the virtual master generator 13. Then, in Step P18, counting of the internal clock counter (counter of elapsed time) 39 is started.

Then, in Step P19, the time interval at which the set speed is transmitted to the virtual master generator 13 is loaded from the memory M8. Then, in Step P20, the count value of the internal clock counter 39 is loaded.

Then, in Step P21, it is determined whether the count value of the internal clock counter is equal to or greater than the time interval at which the set speed is transmitted to the virtual master generator. If the answer is Y, in Step P22, the set speed is loaded from the memory M7 for storing the set speed. Then, in Step P23, the set speed is transmitted to the virtual master generator 13, and the program returns to Step P18. If the answer is N, the program shifts to Step P24.

Then, in Step P24, it is determined whether a pattern phase deviation correction completion signal has been transmitted from the virtual master generator 13. If the answer is Y, in Step P25, the pattern phase deviation correction completion signal is received from the virtual master generator 13. If the answer is N, the program returns to Step P20.

Then, in Step P26, the time interval at which the set speed is transmitted to the virtual master generator 13 is loaded from the memory M8. Then, in Step P27, the count value of the internal clock counter 39 is loaded.

Then, if, in Step P28, the count value of the internal clock counter is equal to or greater than the time interval at which the set speed is transmitted to the virtual master generator, in Step P29, the set speed is loaded from the memory M7 for storing the set speed. Then, in Step P30, the set speed is transmitted to the virtual master generator 13, and the program returns to Step P3. Then, this procedure is repeated.

In accordance with the above-mentioned motion flow, the set speed and the pattern phase deviation value DD (the amount of an error in the pattern position) are transmitted to the virtual master generator 13 at predetermined time intervals.

Then, the virtual master generator 13 acts in accordance with the motion flow shown in FIGS. 19(a), 19(b) and 20(a) and 20(b).

In Step P1, zero is written into the memory M20 for storing the pattern phase deviation value DD, and then in Step P2, zero is written into the memory M10 for storing the previous set speed.

Then, in Step P3, the correction value of the current position of each unit of the master machine is loaded from the memory M11a. Then, in Step P4, the correction value of the current position of each unit of the master machine is written into the memory M12a for storing the virtual current position of the motor shaft of each unit of the master machine.

Then, in Step P5, the correction value of the current position of each unit of the slave machine is loaded from the memory M13a. Then, in Step P6, the correction value of the current position of each unit of the slave machine is written into the memory M14a for storing the virtual current position of the motor shaft of each unit of the slave machine.

Then, in Step P7, it is determined whether the set speed has been transmitted from the central control device 12. If the answer is Y, in Step P8, the set speed is received from the central control device 12, and then stored in the memory M15 for storing the current set speed. If the answer is N, the program shifts to Step P23 to be described later.

Then, in Step P9, the previous set speed is loaded from the memory M10 for storing the previous set speed. Then, in Step P10, the time interval at which the set speed is transmitted by the central control device 12 to the virtual master generator 13 is loaded from the memory M16 for storing the time interval at which the set speed is transmitted to the virtual master generator.

Then, in Step P11, the modification value of the virtual current position is computed from the loaded previous set speed and the loaded time interval at which the set speed is transmitted by the central control device 12 to the virtual master generator 13, and the computed value is stored into the memory M17. Then, in Step P12, the virtual current position of the motor shaft of each unit of the master machine is loaded from the memory M12a.

Then, in Step P13, the computed modification value of the virtual current position is added to the loaded virtual current position of the motor shaft of each unit of the master machine to compute the modified virtual current position of the motor shaft of each unit of the master machine, and the computed value is stored into the memory M18a. Then, in Step P14, the virtual current position of the motor shaft of each unit of the slave machine is loaded from the memory M14a.

Then, in Step P15, the computed modification value of the virtual current position is added to the loaded virtual current position of the motor shaft of each unit of the slave machine to compute the modified virtual current position of the motor shaft of each unit of the slave machine, and the computed value is stored into the memory M19a. Then, in Step P16, the current set speed and the computed modified virtual current position of the motor shaft of each unit of the master machine are transmitted to the drive control device (14a to 14d, 60) for each unit of the master machine A.

Then, in Step P17, the current set speed and the computed modified virtual current position of the motor shaft of each unit of the slave machine are transmitted to the drive control device (114a to 114d) for each unit of the slave machine B. Then, in Step P18, the current set speed is stored into the memory M10 for storing the previous set speed.

Then, in Step P19, the modified virtual current position of the motor shaft of each unit of the master machine is loaded from the memory M18a. Then, in Step P20, the modified virtual current position of the motor shaft of each unit of the master machine is written into the memory M12a for storing the virtual current position of the motor shaft of each unit of the master machine.

Then, in Step P21, the modified virtual current position of the motor shaft of each unit of the slave machine is loaded from the memory M19a. Then, in Step P22, the modified virtual current position of the motor shaft of each unit the slave machine is written into the memory M14a for storing the virtual current position of the motor shaft of each unit of the slave machine. Then, the program returns to Step P7.

Then, in Step P23, it is determined whether the pattern phase deviation value DD has been transmitted from the central control device 12. If the answer is Y, in Step P24, the pattern phase deviation value DD is received from the central control device 12, and stored into the memory M20. If the answer is N, the program returns to Step P7.

Then, in Step P25, a pattern phase deviation correction control start command is transmitted to the drive control device (14a to 14d, 60, 114a to 114d) for each unit of each printing press. Then, in Step P26, the virtual current position of the motor shaft of each unit of the slave machine is loaded from the memory M14a.

Then, in Step P27, the received pattern phase deviation value DD is added to the loaded virtual current position of the motor shaft of each unit of the slave machine, and the memory M14a for storing the virtual current position of the motor shaft of each unit of the slave machine is overwritten with the obtained value. Then, in Step P28, it is determined whether the set speed has been transmitted from the central control device 12.

Then, if the answer is Y in the above Step P28, Step P29 is executed to receive the set speed from the central control device 12 and store it into the memory M15 for storing the current set speed. Then, in Step P30, the previous set speed is loaded from the memory M10 for storing the previous set speed.

Then, in Step P31, the time interval at which the set speed is transmitted by the central control device 12 to the virtual master generator 13 is loaded from the memory M16 for storing the time interval at which the set speed is transmitted to the virtual master generator. Then, in Step P32, the modification value of the virtual current position is computed from the loaded previous set speed and the loaded time interval at which the set speed is transmitted by the central control device to the virtual master generator, and the computed value is stored in the memory M17.

Then, in Step P33, the virtual current position of the motor shaft of each unit of the master machine is loaded from the memory M12a. Then, in Step P34, the computed modification value of the virtual current position is added to the loaded virtual current position of the motor shaft of each unit of the master machine to compute the modified virtual current position of the motor shaft of each unit of the master machine, and the computed value is stored into the memory M18a.

Then, in Step P35, the virtual current position of the motor shaft of each unit of the slave machine is loaded from the memory M14a. Then, in Step P36, the computed modification value of the virtual current position is added to the loaded virtual current position of the motor shaft of each unit of the slave machine to compute the modified virtual current position of the motor shaft of each unit of the slave machine, and the computed value is stored into the memory M19a.

Then, in Step P37, the current set speed and the computed modified virtual current position of the motor shaft of each unit of the master machine are transmitted to the drive control device (14a to 14d, 60) for each unit of the master machine A. Then, in Step P38, the current set speed and the computed modified virtual current position of the motor shaft of each unit of the slave machine are transmitted to the drive control device (114a to 114d) for each unit of the slave machine B.

Then, in Step P39, the current set speed is stored into the memory M10 for storing the previous set speed. Then, in Step P40, the modified virtual current position of the motor shaft of each unit of the master machine is loaded from the memory M18a. Then, in Step P41, the modified virtual current position of the motor shaft of each unit of the master machine is written into the memory M12a for storing the virtual current position of the motor shaft of each unit of the master machine.

Then, in Step P42, the modified virtual current position of the motor shaft of each unit of the slave machine is loaded from the memory M19a. Then, in Step P43, the modified virtual current position of the motor shaft of each unit of the slave machine is written into the memory M14a for storing the virtual current position of the motor shaft of each unit of the slave machine. Then, the program returns to Step P28.

Then, if the answer is N in the aforementioned Step P28, it is determined in Step P44 whether a pattern phase deviation correction control completion signal has been transmitted from the drive control device (14a to 14d, 60, 114a to 114d) for the unit of the printing press. If the answer is Y, in Step P45, the pattern phase deviation correction control completion signal is received from the drive control device (14a to 14d, 60, 114a to 114d) for each unit of the printing press. If the answer is N, the program returns to Step P28.

Then, in Step P46, the printing press number and the unit number of the unit having received the pattern phase deviation correction control completion signal are stored in the memory M21a. Then, in Step P47, it is determined whether pattern phase deviation correction control has been completed in all units of all printing presses. If the answer is Y, in Step P48, a pattern phase deviation correction completion signal is transmitted to the central control device 12, and the program returns to Step P7. If the answer is N, the program returns to Step P28. Afterwards, this procedure is repeated.

In accordance with the above-described motion flow, the current set speed and the virtual position where the motor shaft of each unit in the master machine and the slave machine should be located (in the slave machine, the position corrected with the pattern phase deviation value DD, if necessary) are computed, stored, and transmitted to the drive control device (14a to 14d, 60, 114a to 114d) for each unit of the master machine and the slave machine.

Then, the drive control device (14a to 14d, 60, 114a to 114d) for each unit of the master machine and the slave machine act in accordance with the motion flow shown in FIGS. 21 and 22.

In Step P1, it is determined whether the current set speed and the modified virtual current position of the motor shaft have been transmitted from the virtual master generator 13. If the answer is Y, in Step P2, the current set speed and the modified virtual current position of the motor shaft are received from the virtual master generator 13, and then stored in the memory M22 for storing the current set speed, and the memory M23 for storing the virtual current position of the motor shaft. If the answer is N, the program shifts to Step P18, as described later.

Then, in Step P3, the count value is loaded from the counter 59 for detecting the position of the motor shaft, and stored into the memory M24. Then, in Step P4, the current position of the motor shaft is computed from the loaded count value of the counter 59 for detecting the position of the motor shaft, and stored into the memory M25.

Then, in Step P5, the computed current position of the motor shaft is subtracted from the received virtual current position of the motor shaft to compute the difference of the current position of the motor shaft, which is stored into the memory M26. Then, in Step P6, the absolute value of the difference of the current position of the motor shaft is computed from the computed difference of the current position of the motor shaft, and stored into the memory M27.

Then, in Step P7, the allowable value of the difference in the position of the motor shaft is loaded from the memory M28. Then, in Step P8, it is determined whether the computed absolute value of the difference of the current position of the motor shaft is equal to or less than the loaded allowable value of the difference in the position of the motor shaft. If the answer is Y, in Step P9, the current set speed is loaded from the memory M22 for storing the current set speed. If the answer is N, the program shifts to Step P12, as described later.

Then, in Step P10, the current set speed is written into the memory M29 for storing the command speed. Then, in Step P11, the command speed is outputted to the driver 58a for the drive motor for the unit of the printing press, and the program returns to Step P1.

Then, in Step P12, the table of conversion from the difference of the current position of the motor shaft to the correction value of the set speed is loaded from the memory M30. Then, in Step P13, the difference of the current position of the motor shaft is loaded from the memory M26.

Then, in Step P14, the correction value of the set speed is obtained from the difference of the current position of the motor shaft with the use of the table of conversion from the difference of the current position of the motor shaft to the correction value of the set speed, and the obtained value is stored into the memory M31. Then, in Step P15, the current set speed is loaded from the memory M22 for storing the current set speed.

Then, in Step P16, the obtained correction value of the set speed is added to the loaded current set speed to compute the command speed, which is stored into the memory M29. Then, in Step P17, the command speed is outputted to the driver 58a for the drive motor for the unit of the printing press, and the program returns to Step P1.

Then, in Step P18, it is determined whether a pattern phase deviation correction control start command has been transmitted from the virtual master generator 13. If the answer is Y, in Step P19, the pattern phase deviation correction control start command is received from the virtual master generator 13. If the answer is N, the program returns to Step P1.

Then, if, in Step P20, the current set speed and the modified virtual current position of the motor shaft are transmitted from the virtual master generator 13, in Step P21, the current set speed and the modified virtual current position of the motor shaft are received from the virtual master generator 13, and stored in the memory M22 for storing the current set speed, and the memory M23 for storing the virtual current position of the motor shaft.

Then, in Step P22, the count value is loaded from the counter 59 for detecting the position of the motor shaft, and stored into the memory M24. Then, in Step P23, the current position of the motor shaft is computed from the loaded count value of the counter 59 for detecting the position of the motor shaft, and then stored in the memory M25.

Then, in Step P24, the computed current position of the motor shaft is subtracted from the received virtual current position of the motor shaft to compute the difference of the current position of the motor shaft, which is stored in the memory M26. Then, in Step P25, the absolute value of the difference of the current position of the motor shaft is computed from the computed difference of the current position of the motor shaft, and stored in the memory M27.

Then, in Step P26, the allowable value of the difference in the position of the motor shaft is loaded from the memory M28. Then, in Step P27, it is determined whether the computed absolute value of the difference of the current position of the motor shaft is equal to or less than the loaded allowable value of the difference in the position of the motor shaft. If the answer is Y, in Step P28, the current set speed is loaded from the memory M22 for storing the current set speed. If the answer is N, the program shifts to Step P32 to be described later.

Then, in Step P29, the current set speed is written into the memory M29 for storing the command speed. Then, in Step P30, the command speed is outputted to the driver 58a for the drive motor for the unit of the printing press. Then, in Step P31, a pattern phase deviation correction control completion signal is transmitted to the virtual master generator 13, and the program returns to Step P1.

Then, in Step P32, the table of conversion from the difference of the current position of the motor shaft to the correction value of the set speed is loaded from the memory M30. Then, in Step P33, the difference of the current position of the motor shaft is loaded from the memory M26.

Then, in Step P34, the correction value of the set speed is obtained from the difference of the current position of the motor shaft with the use of the table of conversion from the difference of the current position of the motor shaft to the correction value of the set speed, and the obtained value is stored into the memory M31. Then, in Step P35, the current set speed is loaded from the memory M22 for storing the current set speed.

Then, in Step P36, the obtained correction value of the set speed is added to the loaded current set speed to compute the command speed, which is stored into the memory M29. Then, in Step P37, the command speed is outputted to the driver 58a for the drive motor for the unit of the printing press, and the program returns to Step P20. Afterwards, this procedure is repeated.

In accordance with the above-described motion flow, when the pattern phase deviation correction control start command is transmitted from the virtual master generator 13, the obtained correction value of the set speed is added to the loaded current set speed to compute the command speed, which is outputted to the driver 58a for the drive motor for each unit of the slave machine B. In response to the command speed, a correction is made such that the position of the pattern printed by the slave machine B and the position of the pattern printed by the master machine A are in the predetermined position, whereupon the drive motors 15a to 15d, 61, 115a to 115d for the units of the printing presses are synchronously controlled.

In the present embodiment, as described above, the rotation phase of the drive motor (115a to 115d) for each unit of the slave machine B is directly adjusted by the virtual master generator 13 based on the position of the pattern of the slave machine B detected by the pattern phase deviation detecting sensor 17. Thus, the position of the pattern printed by the master machine A and the position of the pattern printed by the slave machine B can be automatically brought into a proper position.

Accordingly, burden on the operator can be lessened, and the amount of occurrence of defective printing products can be cut down. In the present embodiment, there may be a plurality of the slave machines B.

### Embodiment 3

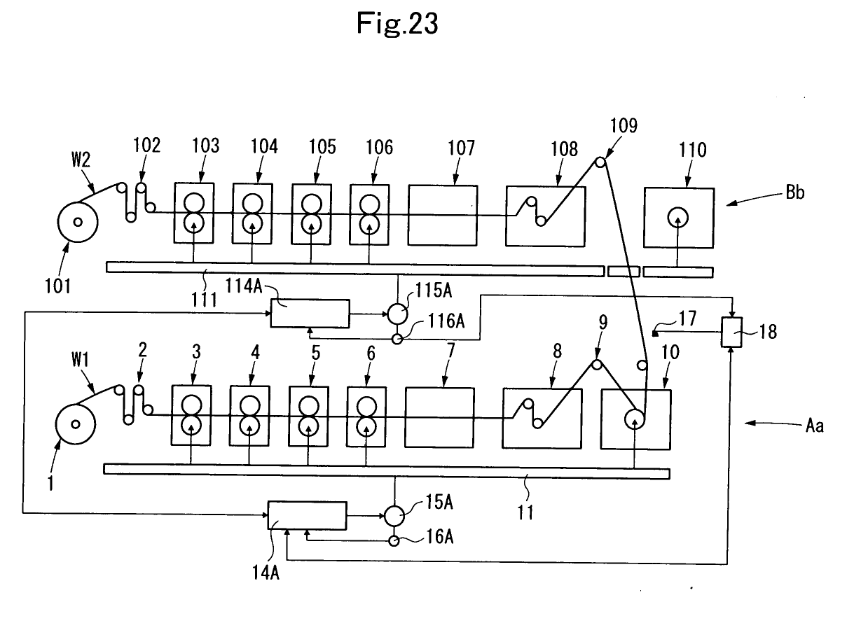

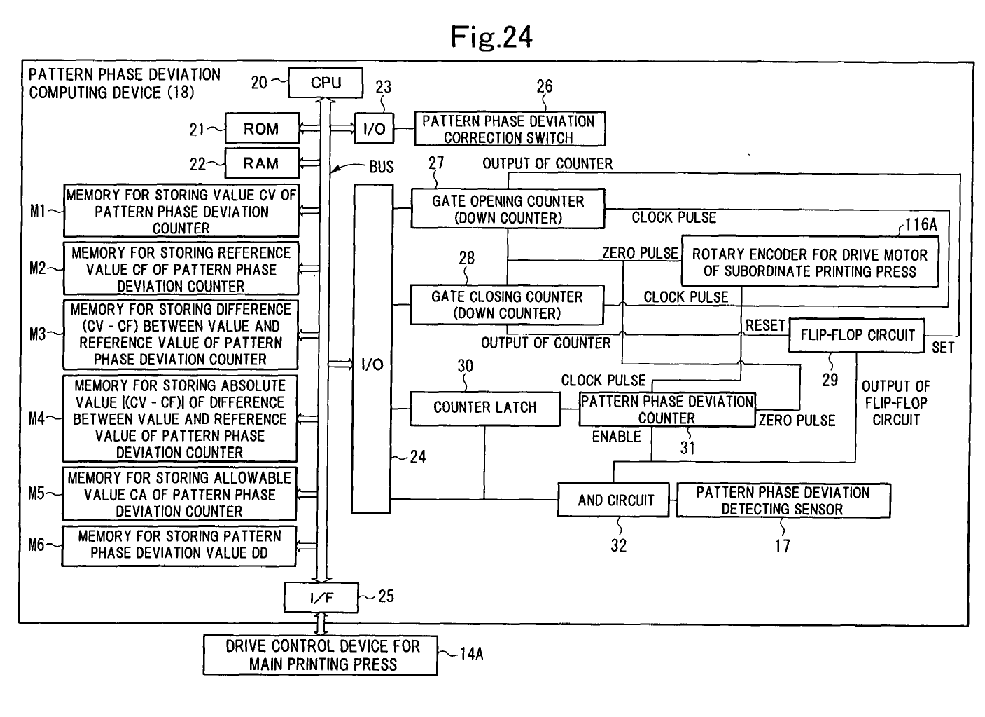

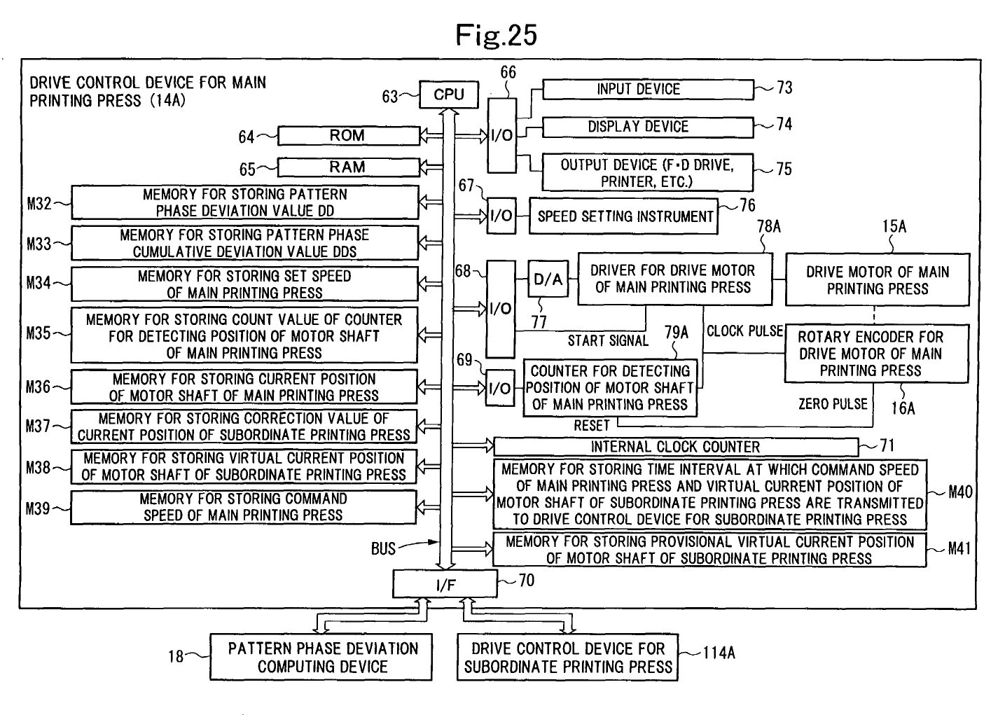

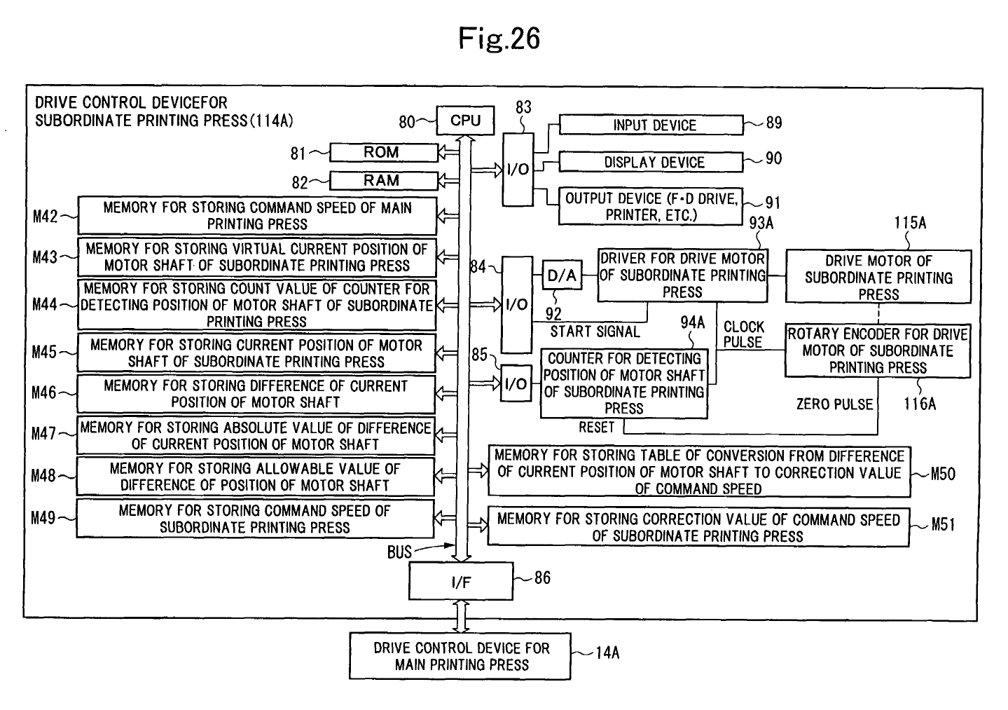

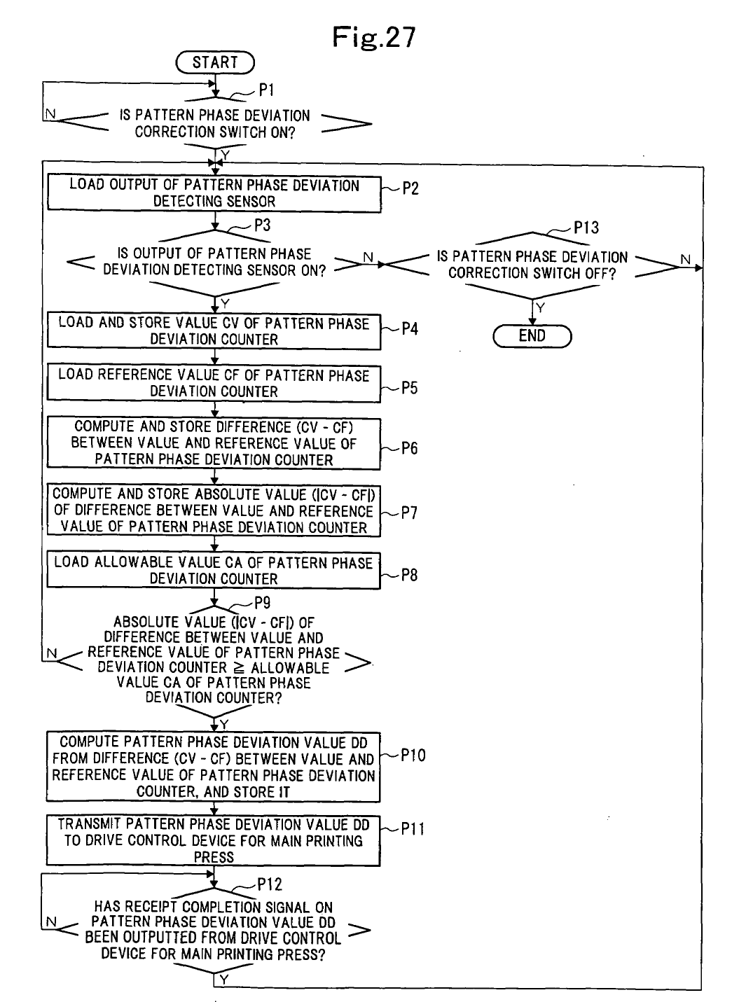

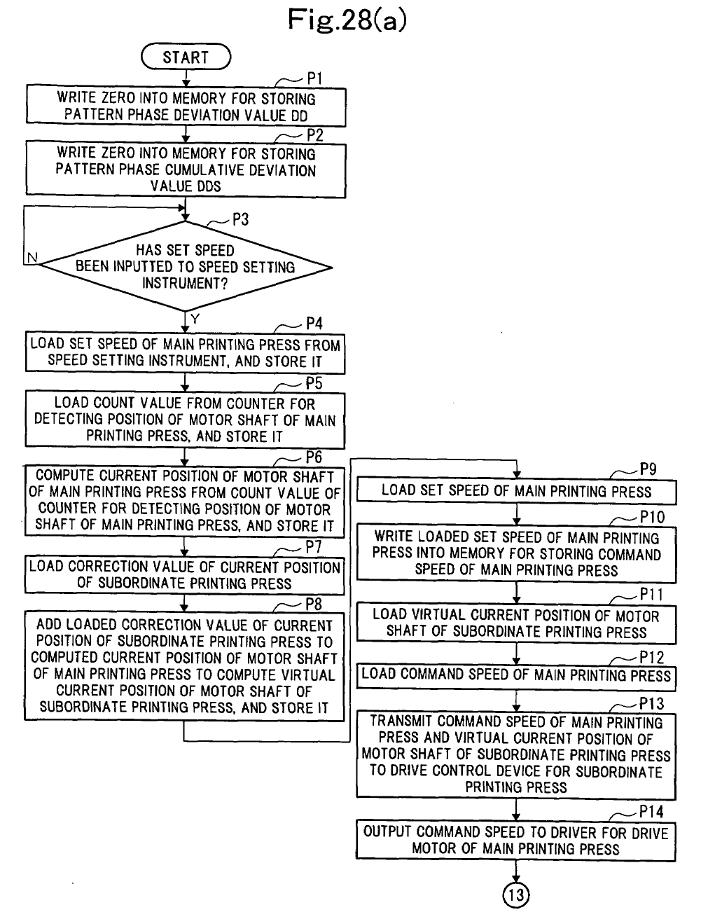

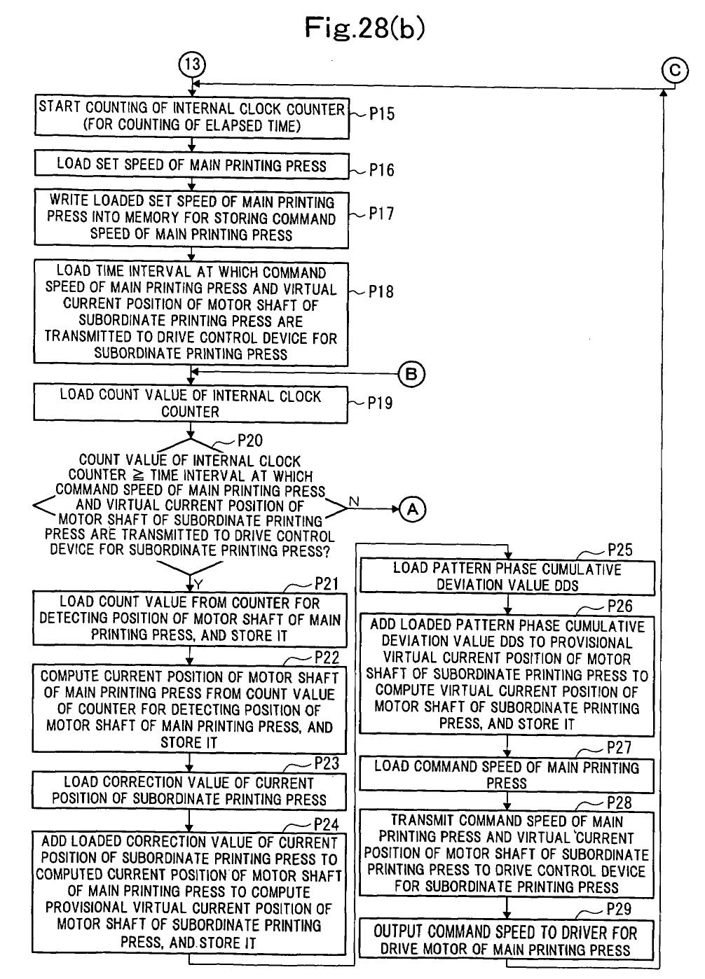

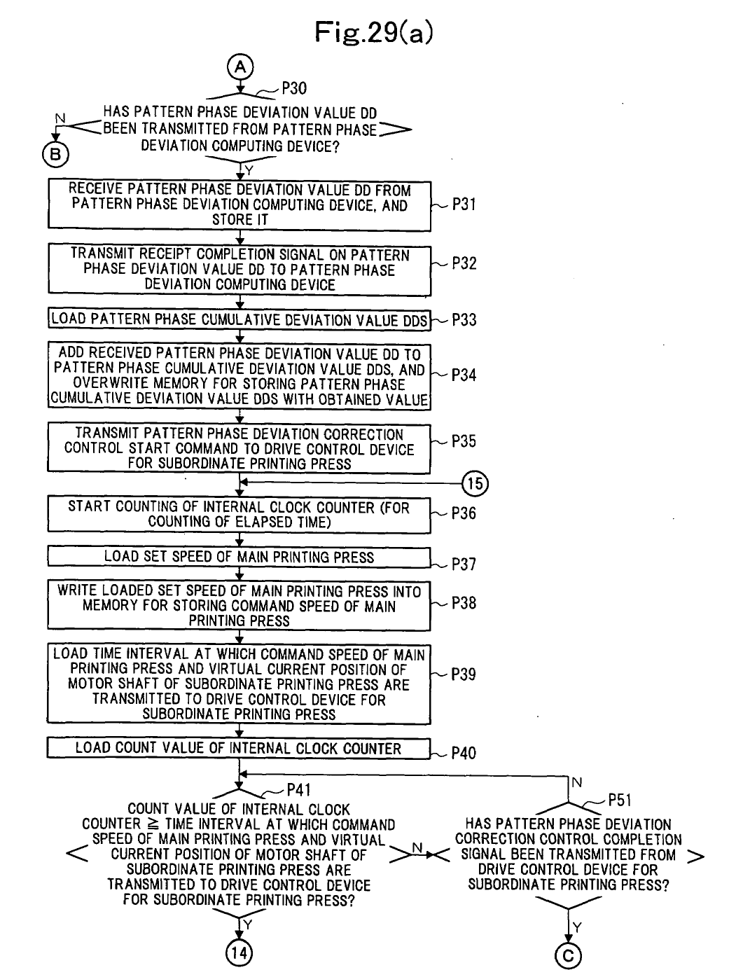

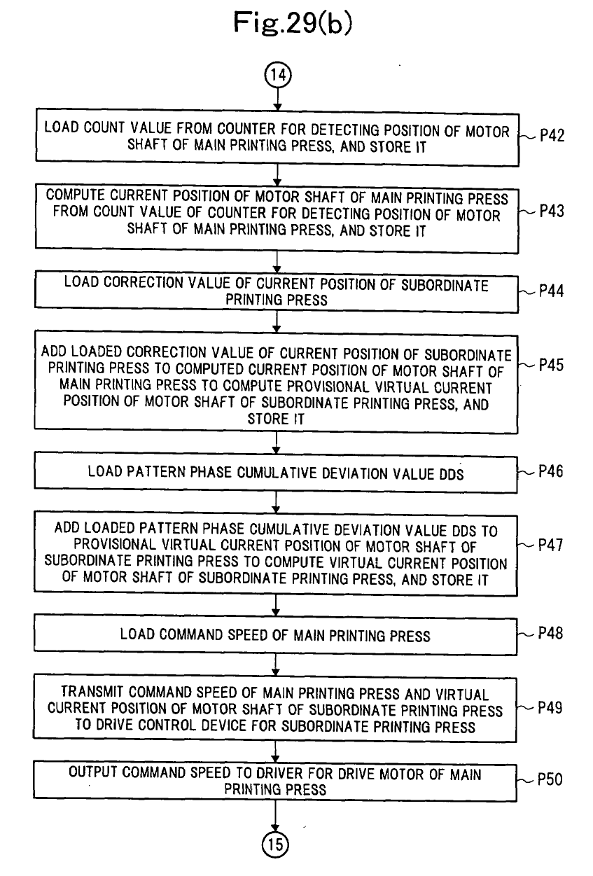

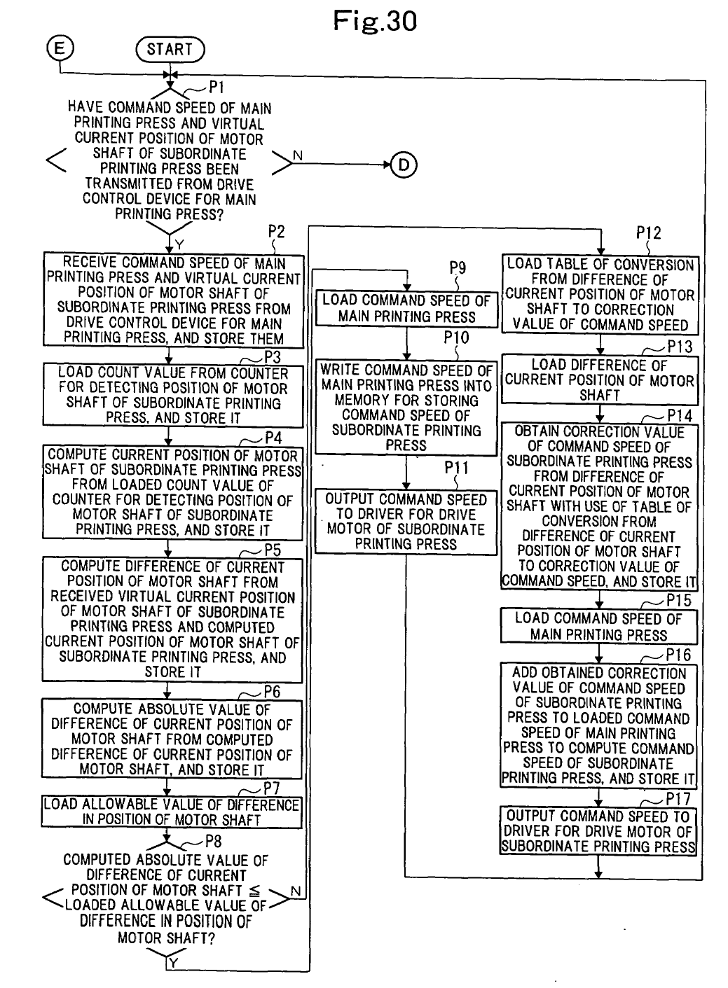

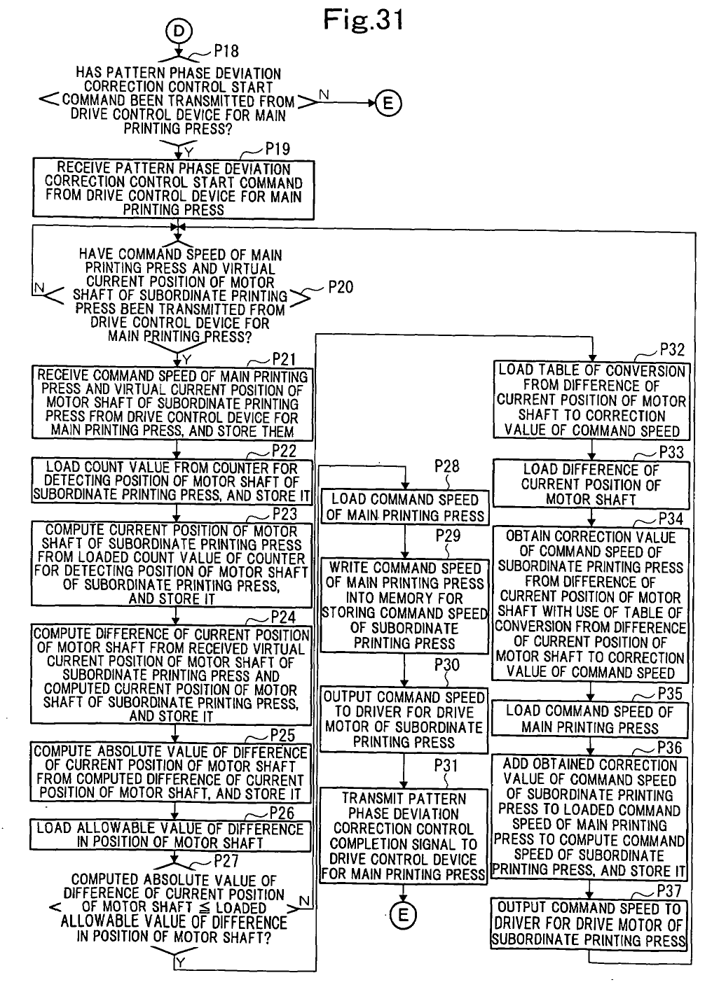

FIG. 23 is a schematic configurational drawing of a synchronous control apparatus for a web rotary printing press showing Embodiment 3 of the present invention. FIG. 24 is a block diagram of a pattern phase deviation computing device. FIG. 25 is a block diagram of a drive control device for a main printing press. FIG. 26 is a block diagram of a drive control device for a subordinate printing press. FIG. 27 is a motion flow chart of the pattern phase deviation computing device. FIG. 28(a) is a motion flow chart of the drive control device for the main printing press. FIG. 28(b) is a motion flow chart of the drive control device for the main printing press. FIG. 29(a) is a motion flow chart of the drive control device for the main printing press. FIG. 29(b) is a motion flow chart of the drive control device for the main printing press. FIG. 30 is a motion flow chart of the drive control device for the subordinate printing press. FIG. 31 is a motion flow chart of the drive control device for the subordinate printing press.

In a main printing press Aa having a web rotary printing press as a first rolled paper rotary printing press, as shown in FIG. 23, a roll of paper (web) W1 continuously fed from a feeder 1 and an infeed unit 2 is subjected various printings as it passes through first to fourth printing units 3 to 6. Then, the web is heated to dry when it passes through a dryer 7, and is then cooled when it passes through a cooling unit 8. Then, when the web passes over a drag unit 9, its tension is controlled or its direction is changed. Then, the web is cut to a predetermined shape and then folded by a folder 10.

The first to fourth printing units 3 to 6 and the folder 10 are driven by a drive motor 15A of the main printing press via a machine shaft (line shaft) 11. A rotary encoder 16A for detecting the rotational speed of the drive motor 15A is connected to the drive motor 15A. The drive motor 15A is drivingly controlled by a drive control device (control means) 14A for the main printing press, and a detection signal from the rotary encoder 16A is inputted to the drive control device 14A for the main printing press.

In a subordinate printing press Bb comprising a web rotary printing press as a second rolled paper rotary printing press, on the other hand, a roll of paper (web) W2 continuously fed from a feeder 101 and an infeed unit 102 is subjected to various printings when it passes through first to fourth printing units 103 to 106. Then, the web is heated to dry when it passes through a dryer 107, and is then cooled when it passes through a cooling unit 108. Then, when the web passes over a drag unit 109, its tension is controlled or its direction is changed. Then, the web is cut to a predetermined shape and then folded by a folder 110.

The first to fourth printing units 103 to 106 and the folder 110 are driven by a drive motor 115A of the subordinate printing press via a machine shaft (line shaft) 111. A rotary encoder 116A for detecting the rotational speed of the drive motor 115A is connected to the drive motor 115A. The drive motor 115A is drivingly controlled by a drive control device (control means) 114A for the subordinate printing press, and a detection signal from the rotary encoder 116A is inputted to the drive control device 114A for the subordinate printing press.

In the present embodiment, the drive motor 15A of the main printing press Aa and the drive motor 115A of the subordinate printing press Bb are synchronously controlled (operated) by the drive control device 14A for the main printing press and the drive control device 114a for the subordinate printing press. That is, in the present embodiment, the webs W1 and W2 printed by the main printing press Aa and the subordinate printing press Bb are both guided to the folder 10 of the main printing press Aa, where they are folded.

A pattern phase deviation detecting sensor (pattern position measuring means) 17, such as a scanning sensor, for measuring the position of a pattern (strictly, a register mark) printed by the subordinate printing press Bb is provided halfway through a transport path on which the web W2 printed by the subordinate printing press Bb is transferred so that it is superposed on the web W1 printed by the main printing press Aa.

A detection signal from the pattern phase deviation detecting sensor 17 is inputted to a pattern phase deviation computing device (control means) 18, together with the detection signal from the rotary encoder 116A in the subordinate printing press Bb. The amount of an error in the pattern position (pattern phase deviation value DD) computed by the pattern phase deviation computing device 18 is inputted to the drive control device 14A for the main printing press. The drive control device 14A for the main printing press controls the rotation phase of the drive motor 115A of the subordinate printing press Bb in accordance with this error amount (pattern phase deviation value DD), thereby bringing the position of the pattern printed by the main printing press Aa and the position of the pattern printed by the subordinate printing press Bb into the predetermined position.

As shown in FIG. 24, the pattern phase deviation computing device 18 comprises CPU 20, ROM 21, RAM 22, input/output devices 23 and 24, and an interface 25 connected together by BUS (bus line). To the BUS, the following memories are connected: a memory M1 for storing the value CV of a pattern phase deviation counter, a memory M2 for storing the reference value CF of the pattern phase deviation counter, a memory M3 for storing the difference (CV−CF) between the value and the reference value of the pattern phase deviation counter, a memory M4 for storing the absolute value |(CV−CF)| of the difference between the value and the reference value of the pattern phase deviation counter, a memory M5 for storing the allowable value CA of the pattern phase deviation counter, and a memory M6 for storing the pattern phase deviation value DD.

To the input/output device 23, a pattern phase deviation correction switch 26 is connected.

To the input/output device 24, a gate opening counter (down counter) 27 and a gate closing counter (down counter) 28 are connected, a pattern phase deviation counter 31 is connected via a counter latch 30, and the pattern phase deviation detecting sensor 17 is connected via an AND circuit 32. The rotary encoder 116A for the drive motor of the subordinate printing press Bb is connected to the gate opening counter (down counter) 27 and the gate closing counter (down counter) 28, and the rotary encoder 116A for the drive motor of the subordinate printing press Bb is also connected to the pattern phase deviation counter 31. A flip-flop circuit 29 is connected to the gate opening counter (down counter) 27 and the gate closing counter (down counter) 28, and the flip-flop circuit 29 is also connected to the pattern phase deviation counter 31 and the AND circuit 32. The AND circuit 32 is also connected to the counter latch 30.

In the input/output device 24, therefore, the gate opening counter 27, the gate closing counter 28, and the pattern phase deviation counter 31 are reset by a zero pulse generated by the rotary encoder 116A for the drive motor of the subordinate printing press in accordance with the rotation of the drive motor 115A of the subordinate printing press. Then, the gate opening counter 27 counts up in accordance with a clock pulse generated by the rotary encoder 116A, whereupon the flip-flop circuit 29 is set by the output of the counter 27. As a result, the pattern phase deviation counter 31 starts counting, and the AND circuit 32 is opened, in accordance with the output from the flip-flop circuit 29. When the signal from the pattern phase deviation detecting sensor 17 is inputted, the count value of the counter 31 at this time is held by the counter latch 30.

Then, the gate closing counter 28 counts up in accordance with the clock pulse generated by the rotary encoder 116A, whereupon the flip-flop circuit 29 is reset by the output of the counter 28. Consequently, the output from the flip-flop circuit 29 is stopped, whereby the pattern phase deviation counter 31 stops counting, and the AND circuit 32 is closed, so that the input signal from the pattern phase deviation detecting sensor 17 is shut off. In this manner, the pattern phase deviation is detected only with a predetermined timing preset by the gate opening counter 27 and the gate closing counter 28.

The drive control device 14A for the main printing press to be described later is connected to the interface 25.

As shown in FIG. 25, the drive control device 14A for the main printing press comprises CPU 63, ROM 64, RAM 65, input/output devices 66 to 69, and an interface 70 connected together via BUS (bus line). To the BUS, the following are connected: a memory M32 for storing the pattern phase deviation value DD, a memory M33 for storing the pattern phase cumulative deviation value DDS, a memory M34 for storing the set speed of the main printing press, a memory M35 for storing the count value of the counter for detecting the position of the motor shaft of the main printing press, a memory M36 for storing the current position of the motor shaft of the main printing press, a memory M37 for storing the correction value of the current position of the subordinate printing press, a memory M38 for storing the virtual current position of the motor shaft of the subordinate printing press, a memory M39 for storing the command speed of the main printing press, a memory M40 for storing the time interval at which the command speed of the main printing press and the virtual current position of the motor shaft of the subordinate printing press are transmitted to the drive control device for the subordinate printing press, a memory M41 for storing the provisional virtual current position of the motor shaft of the subordinate printing press, and an internal clock counter 71.

To the input/output device 66, the following are connected: an input device 73 such as a keyboard, various switches, and buttons, a display device 74 such as CRT and lamps, and an output device 75 such as a printer and a floppy disk (registered trademark) drive. A speed setting instrument 76 is connected to the input/output device 67. To the input/output device 68, the drive motor 15A of the main printing press is connected via a D/A converter 77 and a driver 78A for the drive motor of the main printing press. The rotary encoder 16A for the drive motor of the main printing press, which is drivingly coupled to the drive motor 15A of the main printing press, is connected to the driver 78A for the drive motor of the main printing press. A counter 79A for detecting the position of the motor shaft of the main printing press is connected to the input/output device 69, and the rotary encoder 16A for the drive motor of the main printing press is connected to the counter 79A for detecting the position of the motor shaft of the main printing press. The aforementioned pattern phase deviation computing device 18 and the drive control device 114A for the subordinate printing press (to be described later) are connected to the interface 70.

As shown in FIG. 26, the drive control device 114A for the subordinate printing press comprises CPU 80, ROM 81, RAM 82, input/output devices 83 to 85, and an interface 86 connected together via BUS (bus line). To the BUS, the following memories are connected: A memory M42 for storing the command speed of the main printing press, a memory M43 for storing the virtual current position of the motor shaft of the subordinate printing press, a memory M44 for storing the count value of the counter for detecting the position of the motor shaft of the subordinate printing press, a memory M45 for storing the current position of the motor shaft of the subordinate printing press, a memory M46 for storing the difference of the current position of the motor shaft, a memory M47 for storing the absolute value of the difference of the current position of the motor shaft, a memory M48 for storing the allowable value of the difference of the position of the motor shaft, a memory M49 for storing the command speed of the subordinate printing press, a memory M50 for storing a table of conversion from the difference of the current position of the motor shaft to the correction value of the command speed, and a memory M51 for storing the correction value of the command speed of the subordinate printing press.

To the input/output device 83, the following are connected: an input device 89 such as a keyboard, various switches, and buttons, a display device 90 such as CRT and lamps, and an output device 91 such as a printer and a floppy disk (registered trademark) drive. To the input/output device 84, the drive motor 115A of the subordinate printing press is connected via a D/A converter 92 and a driver 93A for the drive motor of the subordinate printing press. The rotary encoder 116A for the drive motor of the subordinate printing press, which is drivingly coupled to the drive motor 115A of the subordinate printing press, is connected to the driver 93A for the drive motor of the subordinate printing press. A counter 94A for detecting the position of the motor shaft of the subordinate printing press is connected to the input/output device 85, and the rotary encoder 116A for the drive motor of the subordinate printing press is connected to the counter 94A for detecting the position of the motor shaft of the subordinate printing press. The aforementioned drive control device 14A for the main printing press is connected to the interface 86.

Because of the above configurations, when the main printing press Aa and the subordinate printing press Bb are to be synchronously controlled, the pattern phase deviation computing device 18 acts in accordance with the motion flow shown in FIG. 27.

If the pattern phase deviation correction switch 26 is ON in Step P1, the output of the pattern phase deviation detecting sensor 17 is loaded in Step P2. Then, in Step P3, it is determined whether the output of the pattern phase deviation detecting sensor 17 is ON.

If the answer is Y (yes) in the above Step P3, the value CV of the pattern phase deviation counter 31 is loaded and stored in the memory M1 in Step P4. If the answer is N (no) in Step P3, it is determined in Step P13 whether the pattern phase deviation correction switch 26 is OFF. If the answer is Y in Step P13, the action is completed. If the answer is N, the program returns to Step P2.

Then, in Step P5, the reference value CF of the pattern phase deviation counter 31 is loaded from the memory M2. Then, in Step P6, the difference (CV−CF) between the value and the reference value of the pattern phase deviation counter is computed, and stored into the memory M3.

Then, in Step P7, the absolute value (|CV−CF|) of the difference between the value and the reference value of the pattern phase deviation counter is computed, and stored into the memory M4. Then, in Step P8, the allowable value CA of the pattern phase deviation counter is loaded from the memory M5.

Then, in Step P9, it is determined whether the absolute value (|CV−CF|) of the difference between the value and the reference value of the pattern phase deviation counter is equal to or greater than the allowable value CA of the pattern phase deviation counter. If the answer is Y, in Step P10, the pattern phase deviation value DD is computed from the difference (CV−CF) between the value and the reference value of the pattern phase deviation counter, and stored in the memory M6. If the answer is N, the program returns to Step P2.

Then, in Step P11, the pattern phase deviation value DD is transmitted to the drive control device 14A for the main printing press. Then, if, in Step P12, a receipt completion signal on the pattern phase deviation value DD is outputted from the drive control device 14A for the main printing press, the program returns to Step P2. Then, this procedure is repeated.

In accordance with the above motion flow, the pattern phase deviation value DD (the amount of an error in the pattern position) is computed, and the result of the computation is transmitted to the drive control device 14A for the main printing press. The reference value CF of the pattern phase deviation counter corresponds to the rotation phase of the subordinate printing press Bb, in which the pattern printed by the subordinate printing press Bb is detected by the pattern phase deviation detecting sensor 17, with the position of the pattern printed by the main printing press Aa (first printing press) and the position of the pattern printed by the subordinate printing press Bb (second printing press) being aligned in the folder 10, in consideration of the amount of elongation of the web W1 printed by the main printing press Aa.

Then, the drive control device 14A for the main printing press acts in accordance with the motion flow shown in FIGS. 28(a), 28(b), 29(a) and 29(b).

In Step P1, zero is written into the memory M32 for storing the pattern phase deviation value DD. Then, in Step P2, zero is written into the memory M33 for storing the pattern phase cumulative deviation value DDS. Then, if the set speed is inputted to the speed setting instrument 76 in Step P3, Step P4 is executed to load the set speed of the main printing press from the speed setting instrument 76, and store it in the memory M34.

Then, in Step P5, the count value is loaded from the counter 79A for detecting the position of the motor shaft of the main printing press, and stored in the memory M35. Then, in Step P6, the current position of the motor shaft of the main printing press is computed from the count value of the counter 79A for detecting the position of the motor shaft of the main printing press, and then stored in the memory M36.

Then, in Step P7, the correction value of the current position of the subordinate printing press is loaded from the memory M37. Then, in Step P8, the loaded correction value of the current position of the subordinate printing press is added to the computed current position of the motor shaft of the main printing press to compute the virtual current position of the motor shaft of the subordinate printing press, and the computed value is stored in the memory M38.

Then, in Step P9, the set speed of the main printing press is loaded from the memory M34. Then, in Step P10, the loaded set speed of the main printing press is written into the memory M39 for storing the command speed of the main printing press. Then, in Step P11, the virtual current position of the motor shaft of the subordinate printing press is loaded from the memory M38.

Then, in Step P12, the command speed of the main printing press is loaded from the memory M39. Then, in Step P13, the command speed of the main printing press and the virtual current position of the motor shaft of the subordinate printing press are transmitted to the drive control device 114A for the subordinate printing press.

Then, in Step P14, the command speed is outputted to the driver 78A for the drive motor of the main printing press. Then, in Step P15, counting of the internal clock counter (for counting of elapsed time) 71 is started. Then, in Step P16, the set speed of the main printing press is loaded from the memory M34.

Then, in Step P17, the loaded set speed of the main printing press is written into the memory M39 for storing the command speed of the main printing press. Then, in Step P18, the time interval, at which the command speed of the main printing press and the virtual current position of the motor shaft of the subordinate printing press are transmitted to the drive control device for the subordinate printing press, is loaded from the memory M40.

The, in Step P19, the count value of the internal clock counter 71 is loaded. Then, in Step P20, it is determined whether the count value of the internal clock counter is equal to or greater than the time interval at which the command speed of the main printing press and the virtual current position of the motor shaft of the subordinate printing press are transmitted to the drive control device for the subordinate printing press. If the answer is Y, in Step P21, the count value of the counter 79A for detecting the position of the motor shaft of the main printing press is loaded, and stored in the memory M35. If the answer is N, the program shifts to Step P30, as described later.

Then, in Step P22, the current position of the motor shaft of the main printing press is computed from the count value of the counter 79A for detecting the position of the motor shaft of the main printing press, and stored into the memory M36. Then, in Step P23, the correction value of the current position of the subordinate printing press is loaded from the memory M37.

Then, in Step P24, the loaded correction value of the current position of the subordinate printing press is added to the computed current position of the motor shaft of the main printing press to compute the provisional virtual current position of the motor shaft of the subordinate printing press, and the computed value is stored in the memory M41. Then, in Step P25, the pattern phase cumulative deviation value DDS is loaded from the memory M33.

Then, in Step P26, the loaded pattern phase cumulative deviation value DDS is added to the provisional virtual current position of the motor shaft of the subordinate printing press to compute the virtual current position of the motor shaft of the subordinate printing press, which is stored into the memory M38. Then, in Step P27, the command speed of the main printing press is loaded from the memory M39.

Then, in Step P28, the command speed of the main printing press and the virtual current position of the motor shaft of the subordinate printing press are transmitted to the drive control device 114A for the subordinate printing press. Then, in Step P29, the command speed is outputted to the driver 78A for the drive motor of the main printing press.

Then, in the aforementioned Step P30, it is determined whether the pattern phase deviation value DD has been transmitted from the pattern phase deviation computing device 18. If the answer is Y, in Step P31, the pattern phase deviation value DD is received from the pattern phase deviation computing device 18, and stored in the memory M32. If the answer is N, the program returns to Step P19.

Then, in Step P32, a receipt completion signal on the pattern phase deviation value DD is transmitted to the pattern phase deviation computing device 18. Then, in Step P33, the pattern phase cumulative deviation value DDS is loaded from the memory M33. Then, in Step P34, the received pattern phase deviation value DD is added to the pattern phase cumulative deviation value DDS, and the memory M33 for storing the pattern phase cumulative deviation value DDS is overwritten with the obtained value. Then, in Step P35, a pattern phase deviation correction control start command is transmitted to the drive control device 114A for the subordinate printing press.

Then, in Step P36, counting of the internal clock counter (for counting of elapsed time) 71 is started. Then, in Step P37, the set speed of the main printing press is loaded from the memory M34.

Then, in Step P38, the loaded set speed of the main printing press is written into the memory M39 for storing the command speed of the main printing press. Then, in Step P39, the time interval, at which the command speed of the main printing press and the virtual current position of the motor shaft of the subordinate printing press are transmitted to the drive control device for the subordinate printing press, is loaded from the memory M40.

The, in Step P40, the count value of the internal clock counter 71 is loaded. Then, in Step P41, it is determined whether the count value of the internal clock counter is equal to or greater than the time interval, at which the command speed of the main printing press and the virtual current position of the motor shaft of the subordinate printing press are transmitted to the drive control device for the subordinate printing press. If the answer is Y, in Step P42, the count value of the counter 79A for detecting the position of the motor shaft of the main printing press is loaded, and stored into the memory M35.

If the answer is N in the above Step P41, it is determined in Step P51 whether a pattern phase deviation correction control completion signal has been transmitted from the drive control device 114A for the subordinate printing press. If the answer is Y, the program returns to Step P15. If the answer is N, the program returns to Step P41.

Then, in Step P43, the current position of the motor shaft of the main printing press is computed from the count value of the counter 79A for detecting the position of the motor shaft of the main printing press, and stored into the memory M36. Then, in Step P44, the correction value of the current position of the subordinate printing press is loaded from the memory M37.

Then, in Step P45, the loaded correction value of the current position of the subordinate printing press is added to the computed current position of the motor shaft of the main printing press to compute the provisional virtual current position of the motor shaft of the subordinate printing press, and then the computed value is stored in the memory M41. Then, in Step P46, the pattern phase cumulative deviation value DDS is loaded from the memory M33.

Then, in Step P47, the loaded pattern phase cumulative deviation value DDS is added to the provisional virtual current position of the motor shaft of the subordinate printing press to compute the virtual current position of the motor shaft of the subordinate printing press, which is stored into the memory M38. Then, in Step P48, the command speed of the main printing press is loaded from the memory M39.

Then, in Step P49, the command speed of the main printing press and the virtual current position of the motor shaft of the subordinate printing press are transmitted to the drive control device 114A for the subordinate printing press. Then, in Step P50, the command speed is outputted to the driver 78A for the drive motor of the main printing press. Then, the program returns to Step P36. Afterwards, this procedure is repeated.

In accordance with the above-described motion flow, the command speed of the main printing press and the virtual current position of the motor shaft of the subordinate printing press (if necessary, the position corrected with the pattern phase cumulative deviation value DDS) are transmitted to the drive control device 114A for the subordinate printing press.

Then, the drive control device 114A for the subordinate printing press acts in accordance with the motion flow shown in FIGS. 30 and 31.

In Step P1, it is determined whether the command speed of the main printing press and the virtual current position of the motor shaft of the subordinate printing press have been transmitted from the drive control device 14A for the main printing press. If the answer is Y, in Step P2, the command speed of the main printing press and the virtual current position of the motor shaft of the subordinate printing press are received from the drive control device 14A for the main printing press, and stored into the memory M42 and the memory M43. If the answer is N, the program shifts to Step P18, as described later.

Then, in Step P3, the count value of the counter 94A for detecting the position of the motor shaft of the subordinate printing press is loaded, and stored into the memory M44. Then, in Step P4, the current position of the motor shaft of the subordinate printing press is computed from the loaded count value of the counter 94A for detecting the position of the motor shaft of the subordinate printing press, and then stored in the memory M45.

Then, in Step P5, the difference of the current position of the motor shaft is computed from the received virtual current position of the motor shaft of the subordinate printing press and the computed current position of the motor shaft of the subordinate printing press, and is stored in the memory M46. Then, in Step P6, the absolute value of the difference of the current position of the motor shaft is computed from the computed difference of the current position of the motor shaft, and then stored in the memory M47.

Then, in Step P7, the allowable value of the difference in the position of the motor shaft is loaded from the memory M48. Then, in Step P8, it is determined whether the computed absolute value of the difference of the current position of the motor shaft is equal to or less than the loaded allowable value of the difference in the position of the motor shaft. If the answer is Y, in Step P9, the command speed of the main printing press is loaded from the memory M42. If the answer is N, the program shifts to Step P12 to be described later.

Then, in Step P10, the command speed of the main printing press is written into the memory M49 for storing the command speed of the subordinate printing press. Then, in Step P11, the command speed is outputted to the driver 93A for the drive motor of the subordinate printing press, and the program returns to Step P1.

Then, in Step P12, the table of conversion from the difference of the current position of the motor shaft to the correction value of the command speed is loaded from the memory M50. Then, in Step P13, the difference of the current position of the motor shaft is loaded from the memory M46.

Then, in Step P14, the correction value of the command speed of the subordinate printing press is obtained from the difference of the current position of the motor shaft with the use of the table of conversion from the difference of the current position of the motor shaft to the correction value of the command speed, and the obtained value is stored into the memory M51. Then, in Step P15, the command speed of the main printing press is loaded from the memory M42.

Then, in Step P16, the obtained correction value of the command speed of the subordinate printing press is added to the loaded command speed of the main printing press to compute the command speed of the subordinate printing press, which is stored in the memory M49. Then, in Step P17, the command speed is outputted to the driver 93A for the drive motor of the subordinate printing press, and the program returns to Step P1.

Then, in the aforementioned Step P18, it is determined whether a pattern phase deviation correction control start command has been transmitted from the drive control device 14A for the main printing press. If the answer is Y, in Step P19, the pattern phase deviation correction control start command is received from the drive control device 14A for the main printing press. If the answer is N, the program returns to Step P1.

Then, if, in Step P20, the command speed of the main printing press and the virtual current position of the motor shaft of the subordinate printing press have been transmitted from the drive control device 14A for the main printing press, in Step P21, the command speed of the main printing press and the virtual current position of the motor shaft of the subordinate printing press are received from the drive control device 14A for the main printing press, and stored into the memory M42 and the memory M43.

Then, in Step P22, the count value of the counter 94A for detecting the position of the motor shaft of the subordinate printing press is loaded, and stored in the memory M44. Then, in Step P23, the current position of the motor shaft of the subordinate printing press is computed from the loaded count value of the counter 94A for detecting the position of the motor shaft of the subordinate printing press, and stored into the memory M45.

Then, in Step P24, the difference of the current position of the motor shaft is computed from the received virtual current position of the motor shaft of the subordinate printing press and the computed current position of the motor shaft of the subordinate printing press, and is stored in the memory M46. Then, in Step P25, the absolute value of the difference of the current position of the motor shaft is computed from the computed difference of the current position of the motor shaft, and stored into the memory M47.

Then, in Step P26, the allowable value of the difference in the position of the motor shaft is loaded from the memory M48. Then, in Step P27, it is determined whether the computed absolute value of the difference of the current position of the motor shaft is equal to or less than the loaded allowable value of the difference in the position of the motor shaft. If the answer is Y, in Step P28, the command speed of the main printing press is loaded from the memory M42. If the answer is N, the program shifts to Step P32, as described later.

Then, in Step P29, the command speed of the main printing press is written into the memory M49 for storing the command speed of the subordinate printing press. Then, in Step P30, the command speed is outputted to the driver 93A for the drive motor of the subordinate printing press. Then, in Step P31, a pattern phase deviation correction control completion signal is transmitted to the drive control device 14A for the main printing press, and the program returns to Step P1.

Then, in Step P32, the table of conversion from the difference of the current position of the motor shaft to the correction value of the command speed is loaded from the memory M50. Then, in Step P33, the difference of the current position of the motor shaft is loaded from the memory M46.

Then, in Step P34, the correction value of the command speed of the subordinate printing press is obtained from the difference of the current position of the motor shaft with the use of the table of conversion from the difference of the current position of the motor shaft to the correction value of the command speed, and the obtained value is stored into the memory M51. Then, in Step P35, the command speed of the main printing press is loaded from the memory M42.

Then, in Step P36, the obtained correction value of the command speed of the subordinate printing press is added to the loaded command speed of the main printing press to compute the command speed of the subordinate printing press, which is stored in the memory M49. Then, in Step P37, the command speed is outputted to the driver 93A for the drive motor of the subordinate printing press, and the program returns to Step P20. Afterwards, this procedure is repeated.

In accordance with the above-described motion flow, when the pattern phase deviation correction control start command is transmitted from the drive control device 14A for the main printing press, the obtained correction value of the command speed of the subordinate printing press Bb is added to the loaded command speed of the main printing press Aa to compute the command speed of the subordinate printing press Bb, which is outputted to the driver 93A for the drive motor of the subordinate printing press. In response to the command speed, a correction is made such that the position of the pattern printed by the subordinate printing press Bb and the position of the pattern printed by the main printing press Aa are in the proper position, whereupon the drive motor 115A of the subordinate printing press Bb is controlled in synchronization with the drive motor 15A of the main printing press Aa.

In the present embodiment, as described above, the rotation phase of the drive motor 115A of the subordinate printing press Bb is directly adjusted by the drive control device 14A for the main printing press in accordance with the position of the pattern of the subordinate printing press Bb detected by the pattern phase deviation detecting sensor 17. Thus, the position of the pattern printed by the main printing press Aa and the position of the pattern printed by the subordinate printing press Bb can be automatically brought into the proper position.

Accordingly, burden on the operator can be lessened, and the amount of occurrence of defective printing products can be cut down. In the present embodiment, there may be a plurality of the subordinate printing presses B.

### Embodiment 4

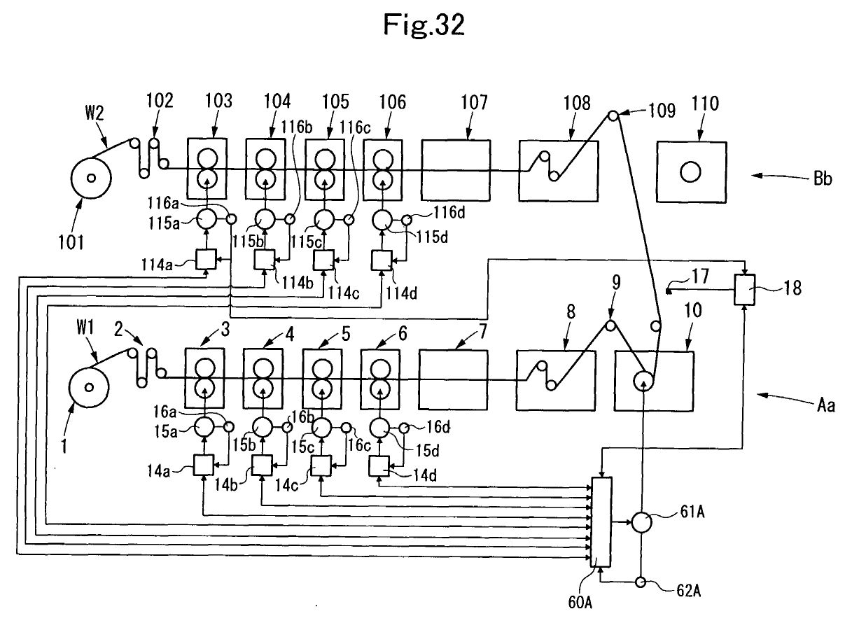

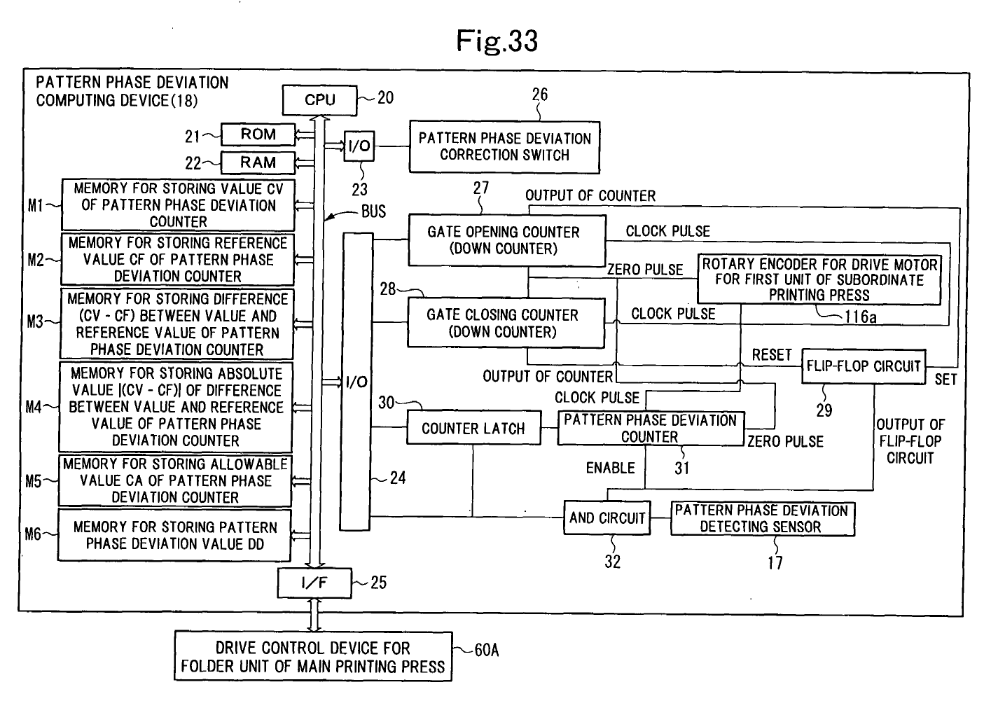

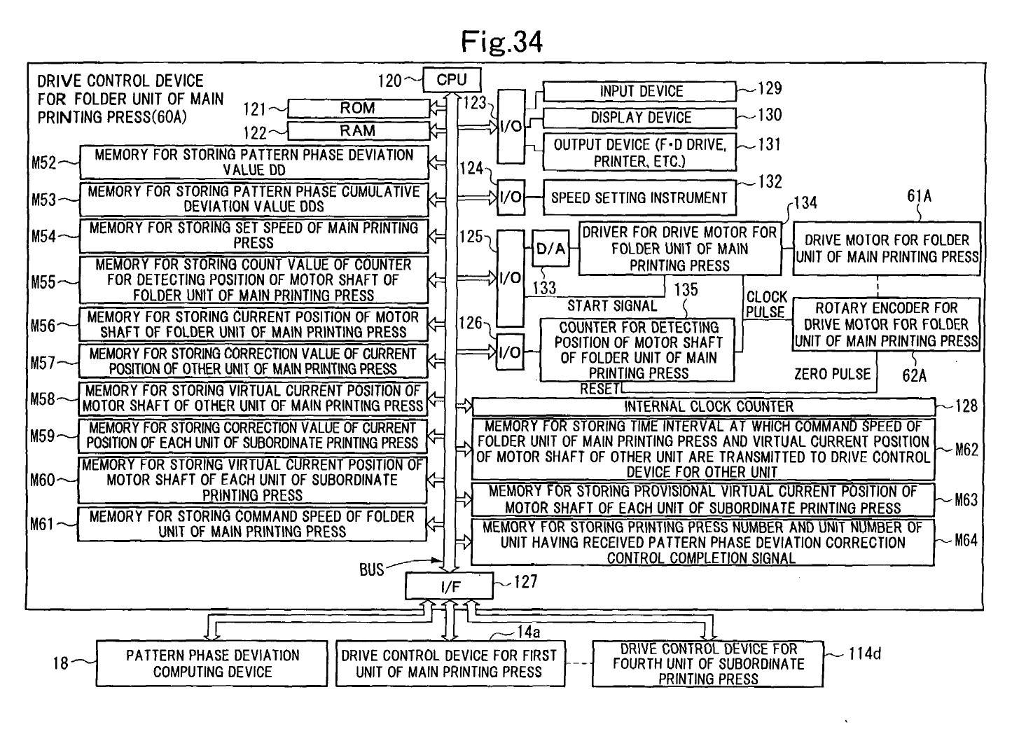

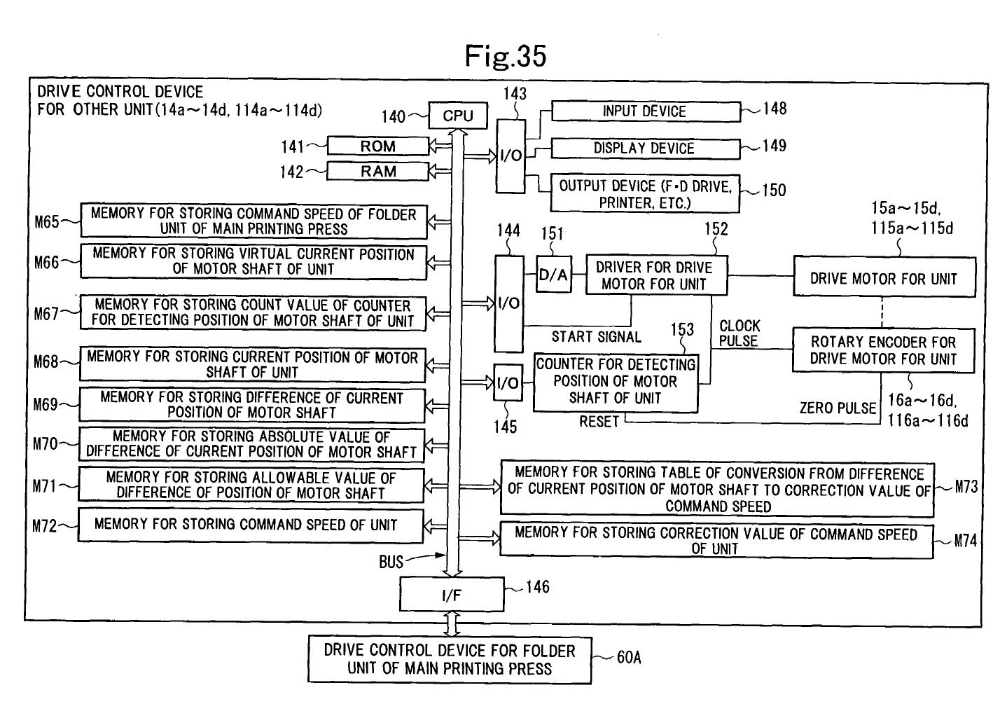

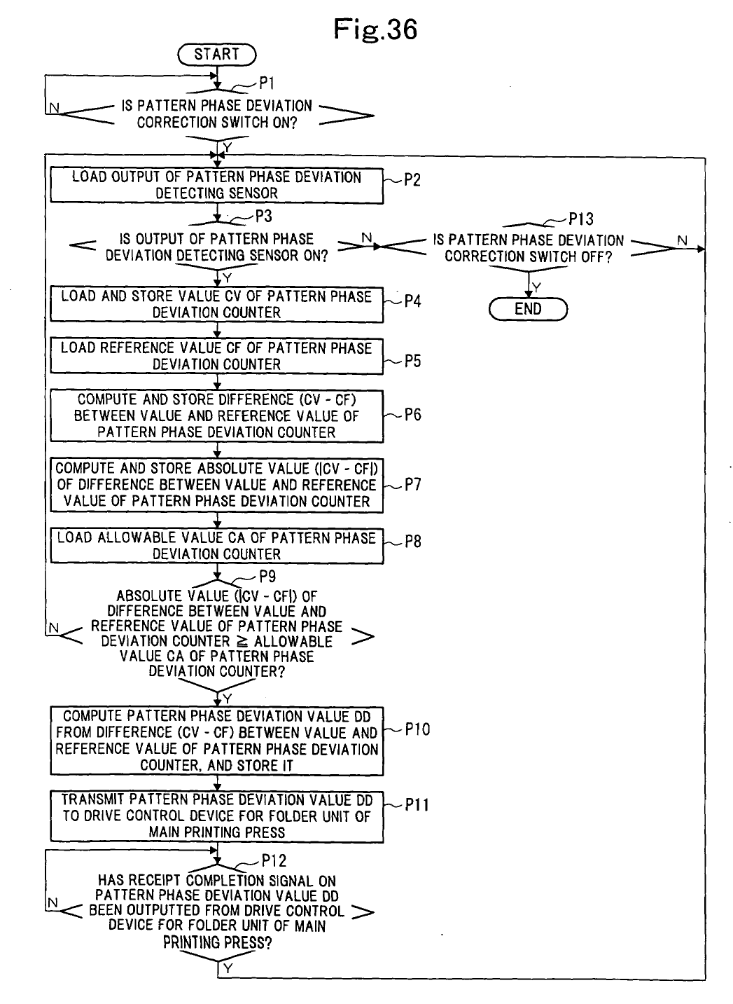

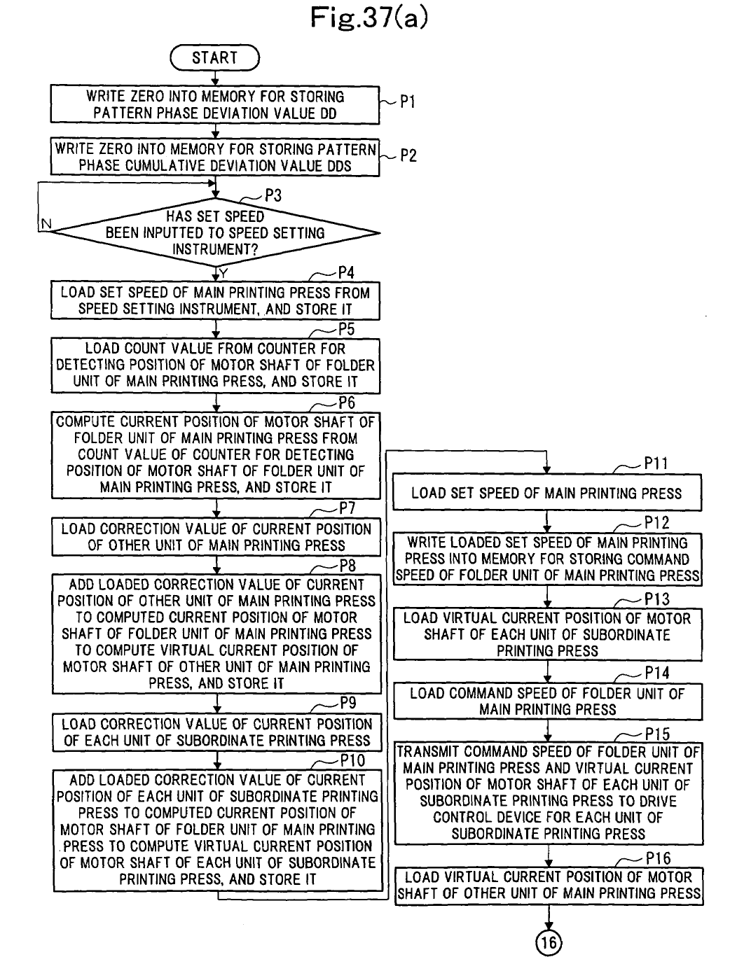

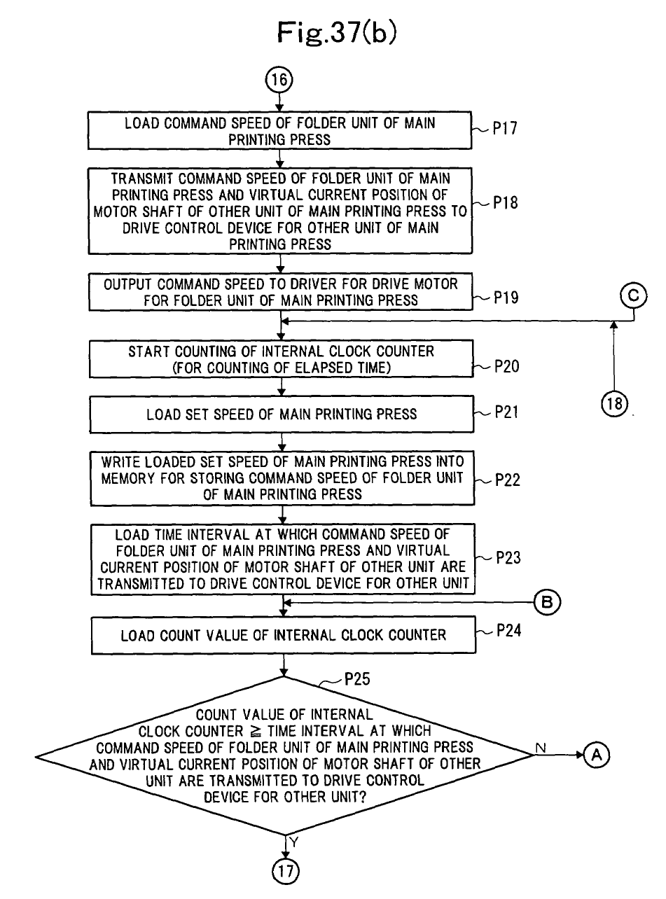

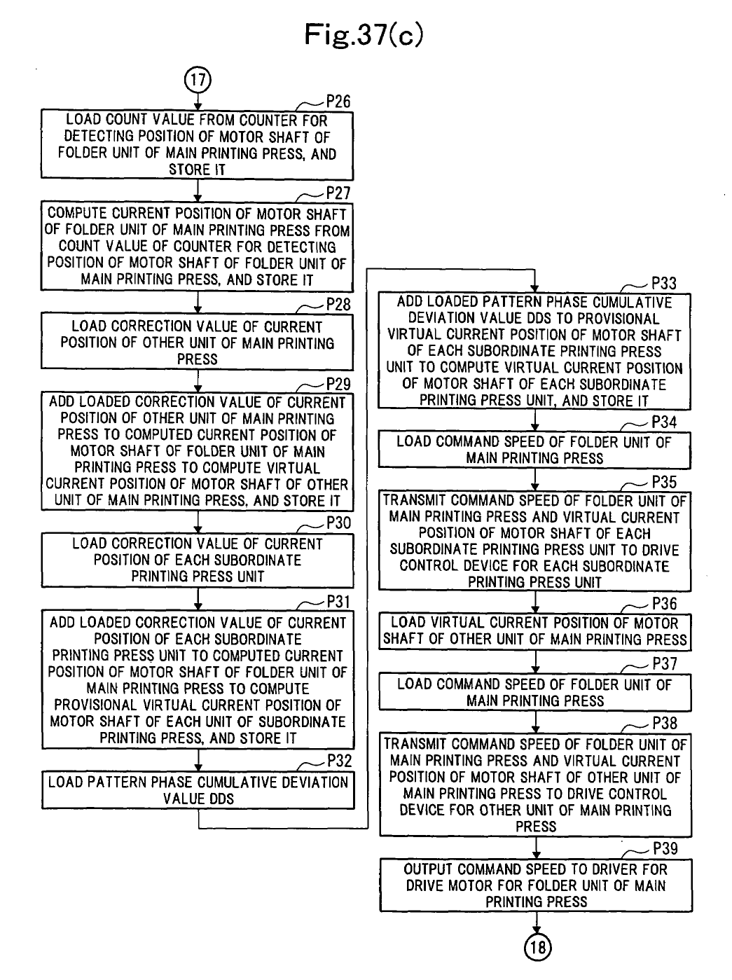

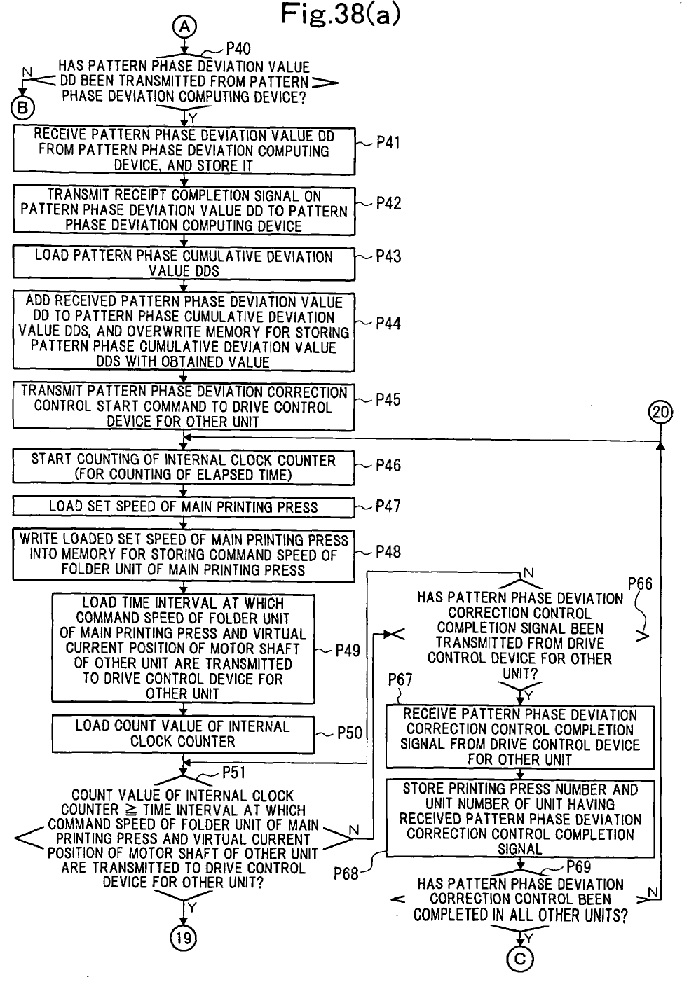

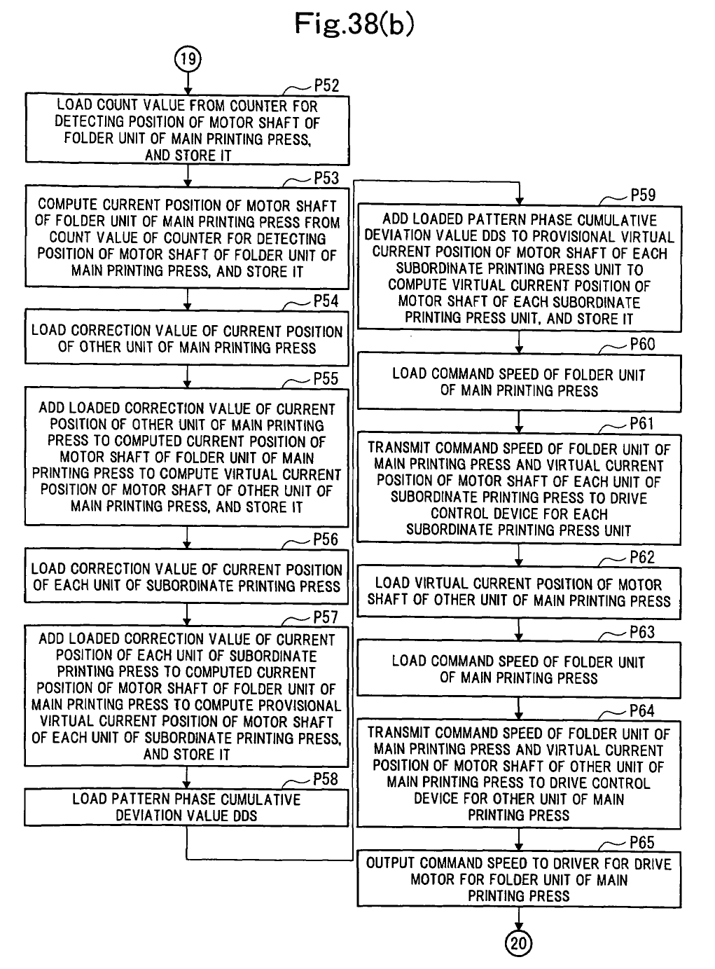

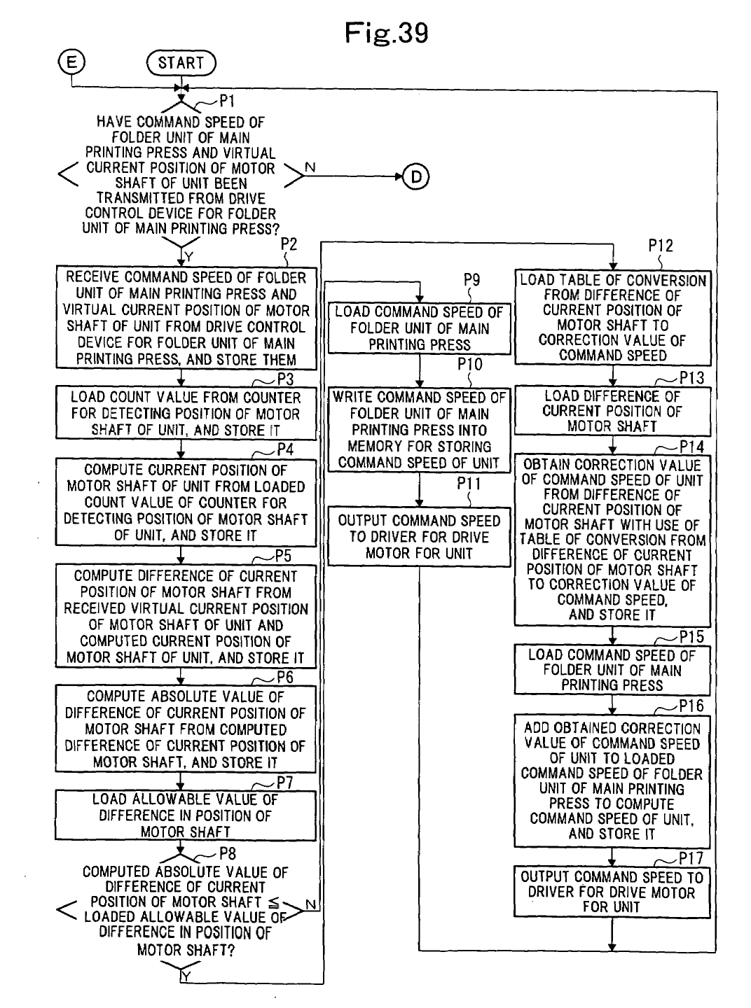

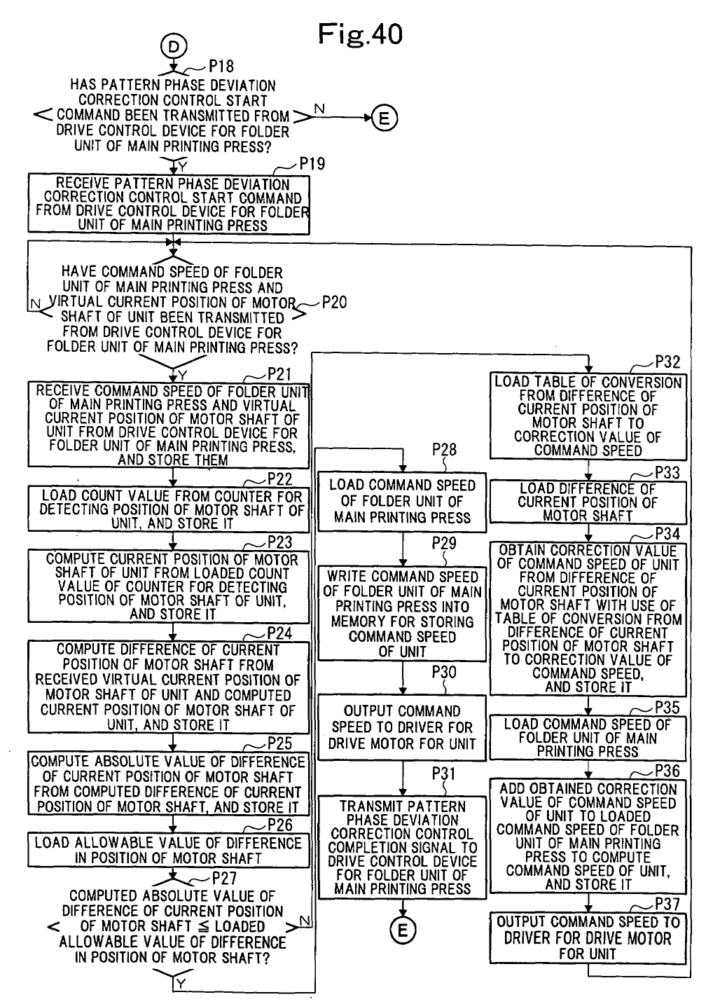

FIG. 32 is a schematic configurational drawing of a synchronous control apparatus for a web rotary printing press showing Embodiment 4 of the present invention. FIG. 33 is a block diagram of a pattern phase deviation computing device. FIG. 34 is a block diagram of a drive control device for a folder unit of a main printing press. FIG. 35 is a block diagram of a drive control device for other unit. FIG. 36 is a motion flow chart of the pattern phase deviation computing device. FIG. 37(a) is a motion flow chart of the drive control device for the folder unit of the main printing press. FIG. 37(b) is a motion flow chart of the drive control device for the folder unit of the main printing press. FIG. 37(c) is a motion flow chart of the drive control device for the folder unit of the main printing press. FIG. 38(a) is a motion flow chart of the drive control device for the folder unit of the main printing press. FIG. 38(b) is a motion flow chart of the drive control device for the folder unit of the main printing press. FIG. 39 is a motion flow chart of the drive control device for other unit. FIG. 40 is a motion flow chart of the drive control device for other unit.

In a main printing press Aa having a web rotary printing press as a first rolled paper rotary printing press, as shown in FIG. 32, a roll of paper (web) W1, which is continuously fed from a feeder 1 and an infeed unit 2, is subjected to various printings as it passes through first to fourth (printing) units 3 to 6. Then, the web is heated to dry when it passes through a dryer 7, and is then cooled when it passes through a cooling unit 8. Then, when the web passes over a drag unit 9, its tension is controlled or its direction is changed. Then, the web is cut into a predetermined shape and folded by a folder 10.

The first to fourth printing units 3 to 6 and the folder 10 are driven individually by drive motors 15a to 15d and a drive motor 61A. Rotary encoders 16a to 16d and 62A for detecting the rotational speeds of these drive motors 15a to 15d, 61A are annexed to the drive motors 15a to 15d, 61A. The drive motors 15a to 15d, 61A are drivingly controlled by drive control devices 14a to 14d, 60A, and detection signals from the rotary encoders 16a to 16d, 62A are inputted to the drive control devices 14a to 14d, 60A.

In a subordinate printing press Bb comprising a web rotary printing press as a second rolled paper rotary printing press, on the other hand, a roll of paper (web) W2 continuously fed from a feeder 101 and an infeed unit 102 is subjected to various printings as it passes through first to fourth (printing) units 103 to 106. Then, the web is heated to dry when it passes through a dryer 107, and is then cooled when it passes through a cooling unit 108. Then, when the web passes over a drag unit 109, its tension is controlled or its direction is changed. Then, the web is cut into a predetermined shape and folded by a folder 110.

The first to fourth printing units 103 to 106 are driven individually by drive motors 115a to 115d. Rotary encoders 116a to 116d for detecting the rotational speeds of the drive motors 115a to 115d are connected to the drive motors 115a to 115d. The drive motors 115a to 115d are drivingly controlled by drive control devices 114a to 114d, respectively, and detection signals from the rotary encoders 116a to 116d are inputted to the drive control devices 114a to 114d. The folder 110 may also be driven individually by a drive motor.

The drive control devices 14a to 14d and 114a to 114d for the respective units of the main printing press Aa and the subordinate printing press Bb are synchronously controlled by the drive control device (control means) 60A for the folder unit of the main printing press, whereby the main printing press Aa and the subordinate printing press Bb are synchronously operated. That is, in the present embodiment, the webs W1 and W2 printed by the main printing press Aa and the subordinate printing press Bb are both guided to the folder 10 of the main printing press Aa, where they are folded.

A pattern phase deviation detecting sensor (pattern position measuring means) 17, such as a scanning sensor, for measuring the position of a pattern (strictly, a register mark) printed by the subordinate printing press Bb is provided halfway through a transport path on which the web W2 printed by the subordinate printing press Bb is transferred so that it is superposed on the web W1 printed by the main printing press Aa.

A detection signal from the pattern phase deviation detecting sensor 17 is inputted to a pattern phase deviation computing device (control means) 18, together with the detection signal from the rotary encoder 116a in the first unit 103 of the subordinate printing press Bb. The amount of an error in the pattern position (pattern phase deviation value DD) computed by the pattern phase deviation computing device 18 is inputted to the drive control device 60A for the folder unit of the main printing press. The drive control device 60A for the folder unit of the main printing press controls the rotation phase of the drive motors 115a to 115d for the subordinate printing press Bb in accordance with this error amount (pattern phase deviation value DD), thereby bringing the position of the pattern printed by the main printing press Aa and the position of the pattern printed by the subordinate printing press Bb into the predetermined position.

As shown in FIG. 33, the pattern phase deviation computing device 18 comprises CPU 20, ROM 21, RAM 22, input/output devices 23 and 24, and an interface 25 connected together via BUS (bus line). To the BUS, the following memories are connected: a memory M1 for storing the value CV of a pattern phase deviation counter, a memory M2 for storing the reference value CF of the pattern phase deviation counter, a memory M3 for storing the difference (CV−CF) between the value and the reference value of the pattern phase deviation counter, a memory M4 for storing the absolute value |(CV−CF)| of the difference between the value and the reference value of the pattern phase deviation counter, a memory M5 for storing the allowable value CA of the pattern phase deviation counter, and a memory M6 for storing the pattern phase deviation value DD.

A pattern phase deviation correction switch 26 is connected to the input/output device 23.

To the input/output device 24, a gate opening counter (down counter) 27 and a gate closing counter (down counter) 28 are connected, a pattern phase deviation counter 31 is connected via a counter latch 30, and the pattern phase deviation detecting sensor 17 is connected via an AND circuit 32. A rotary encoder 116a for the drive motor for the first unit of the subordinate printing press is connected to the gate opening counter (down counter) 27 and the gate closing counter (down counter) 28, and the rotary encoder 116a for the drive motor for the first unit of the subordinate printing press is also connected to the pattern phase deviation counter 31. A flip-flop circuit 29 is connected to the gate opening counter (down counter) 27 and the gate closing counter (down counter) 28, and the flip-flop circuit 29 is also connected to the pattern phase deviation counter 31 and the AND circuit 32. The AND circuit 32 is also connected to the counter latch 30.

In the input/output device 24, therefore, the gate opening counter 27, the gate closing counter 28, and the pattern phase deviation counter 31 are reset by a zero pulse generated by the rotary encoder 116a for the drive motor for the first unit of the subordinate printing press in accordance with the rotation of the drive motor 115a for the first unit of the subordinate printing press. Then, the gate opening counter 27 counts up in accordance with a clock pulse generated by the rotary encoder 116a, whereupon the flip-flop circuit 29 is set by the output of the counter 27. As a result, the pattern phase deviation counter 31 starts counting, and the AND circuit 32 is opened, in accordance with the output from the flip-flop circuit 29. When the signal from the pattern phase deviation detecting sensor 17 is inputted, the count value of the counter 31 at this time is held by the counter latch 30.

Then, the gate closing counter 28 counts up in accordance with the clock pulse generated by the rotary encoder 116a, whereupon the flip-flop circuit 29 is reset by the output of the counter 28. Consequently, the output from the flip-flop circuit 29 is stopped, whereby the pattern phase deviation counter 31 stops counting, and the AND circuit 32 is closed, and then the input signal from the pattern phase deviation detecting sensor 17 is shut off. In this manner, the pattern phase deviation is detected only with a predetermined timing preset by the gate opening counter 27 and the gate closing counter 28.

The drive control device 60A for the folder unit of the main printing press to be described later is connected to the interface 25.

As shown in FIG. 34, the drive control device 60A for the folder unit of the main printing press comprises CPU 120, ROM 121, RAM 122, input/output devices 123 to 126, and an interface 127 connected together via BUS (bus line). To the BUS, the following are connected: a memory M52 for storing the pattern phase deviation value DD, a memory M53 for storing the pattern phase cumulative deviation value DDS, a memory M54 for storing the set speed of the main printing press, a memory M55 for storing the count value of the counter for detecting the position of the motor shaft of the folder unit of the main printing press, a memory M56 for storing the current position of the motor shaft of the folder unit of the main printing press, a memory M57 for storing the correction value of the current position of other unit of the main printing press, a memory M58 for storing the virtual current position of the motor shaft of other unit of the main printing press, a memory M59 for storing the correction value of the current position of each unit of the subordinate printing press, a memory M60 for storing the virtual current position of the motor shaft of each unit of the subordinate printing press, a memory M61 for storing the command speed of the folder unit of the main printing press, a memory M62 for storing the time interval at which the command speed of the folder unit of the main printing press and the virtual current position of the motor shaft of other unit are transmitted to the drive control device for other unit, a memory M63 for storing the provisional virtual current position of the motor shaft of each unit of the subordinate printing press, a memory M64 for storing the printing press number and the unit number of the unit having received the pattern phase deviation correction control completion signal, and an internal clock counter 128.

To the input/output device 123, the following are connected: an input device 129 such as a keyboard, various switches, and buttons, a display device 130 such as CRT and lamps, and an output device 131 such as a printer and a floppy disk (registered trademark) drive. A speed setting instrument 132 is connected to the input/output device 124. To the input/output device 125, the drive motor 61A for the folder unit of the main printing press is connected via a D/A converter 133 and a driver 134 for the drive motor for the folder unit of the main printing press. The rotary encoder 62A for the drive motor for the folder unit of the main printing press, which is drivingly coupled to the drive motor 61A for the folder unit of the main printing press, is connected to the driver 134 for the drive motor for the folder unit of the main printing press. A counter 135 for detecting the position of the motor shaft of the folder unit of the main printing press is connected to the input/output device 126, and the rotary encoder 62A for the drive motor for the folder unit of the main printing press is connected to the counter 135 for detecting the position of the motor shaft of the folder unit of the main printing press. The aforementioned pattern phase deviation computing device 18 and the drive control device 14a for the first unit of the main printing press to the drive control device 114d for the fourth unit of the subordinate printing press (to be described later) are connected to the interface 127.

As shown in FIG. 35, the drive control devices 14a to 14d and 114a to 114d for other units (i.e., other units of the main printing press and each unit of the subordinate printing press) each comprise CPU 140, ROM 141, RAM 142, input/output devices 143 to 145, and an interface 146 connected together by BUS (bus line). To the BUS, the following memories are connected: a memory M65 for storing the command speed of the folder unit of the main printing press, a memory M66 for storing the virtual current position of the motor shaft of the unit, a memory M67 for storing the count value of the counter for detecting the position of the motor shaft of the unit, a memory M68 for storing the current position of the motor shaft of the unit, a memory M69 for storing the difference of the current position of the motor shaft, a memory M70 for storing the absolute value of the difference of the current position of the motor shaft, a memory M71 for storing the allowable value of the difference of the position of the motor shaft, a memory M72 for storing the command speed of the unit, a memory M73 for storing a table of conversion from the difference of the current position of the motor shaft to the correction value of the command speed, and a memory M74 for storing the correction value of the command speed of the unit.

To the input/output device 143, the following are connected: An input device 148 such as a keyboard, various switches, and buttons, a display device 149 such as CRT and lamps, and an output device 150 such as a printer and a floppy disk (registered trademark) drive. To the input/output device 144, the drive motor (15a to 15d and 115a to 115d) for the unit is connected via a D/A converter 151 and a driver 152 for the drive motor for the unit. The rotary encoder (16a to 16d, 116a to 116d) for the drive motor for the unit, which is drivingly coupled to the drive motor (15a to 15d, 115a to 115d) for the unit, is connected to the driver 152 for the drive motor for the unit. A counter 153 for detecting the position of the motor shaft of the unit is connected to the input/output device 145, and the rotary encoder (16a to 16d, 116a to 116d) for the drive motor for the unit is connected to the counter 153 for detecting the position of the motor shaft of the unit. The aforementioned drive control device 60A for the folder unit of the main printing press is connected to the interface 146.

Because of the above configurations, when the main printing press Aa and the subordinate printing press Bb are to be synchronously controlled, the pattern phase deviation computing device 18 acts in accordance with the motion flow shown in FIG. 36.

If the pattern phase deviation correction switch 26 is ON in Step P1, the output of the pattern phase deviation detecting sensor 17 is loaded in Step P2. Then, in Step P3, it is determined whether the output of the pattern phase deviation detecting sensor 17 is ON.

If the answer is Y (yes) in the above Step P3, the value CV of the pattern phase deviation counter 31 is loaded and stored into the memory M1 in Step P4. If the answer is N (no) in Step P3, it is determined in Step P13 whether the pattern phase deviation correction switch 26 is OFF. If the answer is Y in Step P13, the action is completed. If the answer is N, the program returns to Step P2.

Then, in Step P5, the reference value CF of the pattern phase deviation counter 31 is loaded from the memory M2. Then, in Step P6, the difference (CV−CF) between the value and the reference value of the pattern phase deviation counter is computed, and stored into the memory M3. The reference value CF of the pattern phase deviation counter corresponds to the rotation phase of the subordinate printing press Bb, in which the pattern printed by the subordinate printing press Bb is detected by the pattern phase deviation detecting sensor 17, with the position of the pattern printed by the main printing press Aa (first printing press) and the position of the pattern printed by the subordinate printing press Bb (second printing press) being aligned in the folder 10, in consideration of the amount of elongation of the web W1 printed by the main printing press Aa.

Then, in Step P7, the absolute value (|CV−CF|) of the difference between the value and the reference value of the pattern phase deviation counter is computed, and stored into the memory M4. Then, in Step P8, the allowable value CA of the pattern phase deviation counter is loaded from the memory M5.

Then, in Step P9, it is determined whether the absolute value (|CV−CF|) of the difference between the value and the reference value of the pattern phase deviation counter is equal to or greater than the allowable value CA of the pattern phase deviation counter. If the answer is Y, in Step P10, the pattern phase deviation value DD is computed from the difference (CV−CF) between the value and the reference value of the pattern phase deviation counter, and stored into the memory M6. If the answer is N, the program returns to Step P2.

Then, in Step P11, the pattern phase deviation value DD is transmitted to the drive control device 60A for the folder unit of the main printing press. Then, if a receipt completion signal on the pattern phase deviation value DD is outputted from the drive control device 60A for the folder unit of the main printing press, the program returns to Step P2. Then, this procedure is repeated.

In accordance with the above motion flow, the pattern phase deviation value DD (the amount of an error in the pattern position) is computed, and the result of the computation is transmitted to the drive control device 60A for the folder unit of the main printing press.

Then, the drive control device 60A for the folder unit of the main printing press acts in accordance with the motion flow shown in FIGS. 37(a), 37(b), 37(c), 38(a) and 38(b).

In Step P1, zero is written into the memory M52 for storing the pattern phase deviation value DD. Then, in Step P2, zero is written into the memory M53 for storing the pattern phase cumulative deviation value DDS. Then, if the set speed is inputted to the speed setting instrument 132 in Step P3, Step P4 is executed to load the set speed of the main printing press Aa from the speed setting instrument 132, and store it in the memory M54.

Then, in Step P5, the count value is loaded from the counter 135 for detecting the position of the motor shaft of the folder unit of the main printing press, and stored in the memory M55. Then, in Step P6, the current position of the motor shaft of the folder unit of the main printing press is computed from the count value of the counter 135 for detecting the position of the motor shaft of the folder unit of the main printing press, and stored into the memory M56.

Then, in Step P7, the correction value of the current position of other unit of the main printing press is loaded from the memory M57. Then, in Step P8, the loaded correction value of the current position of other unit of the main printing press is added to the computed current position of the motor shaft of the folder unit of the main printing press to compute the virtual current position of the motor shaft of other unit of the main printing press, and the computed value is stored in the memory M58.

Then, in Step P9, the correction value of the current position of each unit of the subordinate printing press is loaded from the memory M59. Then, in Step P10, the loaded correction value of the current position of each unit of the subordinate printing press is added to the computed current position of the motor shaft of the folder unit of the main printing press to compute the virtual current position of the motor shaft of each unit of the subordinate printing press, and the computed value is stored in the memory M60.

Then, in Step P11, the set speed of the main printing press is loaded from the memory M54. Then, in Step P12, the loaded set speed of the main printing press is written into the memory M61 for storing the command speed of the folder unit of the main printing press. Then, in Step P13, the virtual current position of the motor shaft of each unit of the subordinate printing press is loaded from the memory M60.

Then, in Step P14, the command speed of the folder unit of the main printing press is loaded from the memory M61. Then, in Step P15, the command speed of the folder unit of the main printing press and the virtual current position of the motor shaft of each unit of the subordinate printing press are transmitted to the drive control device (114a to 114d) for each unit of the subordinate printing press.

Then, in Step P16, the virtual current position of the motor shaft of other unit of the main printing press is loaded from the memory M58. Then, in Step P17, the command speed of the folder unit of the main printing press is loaded from the memory M61.

Then, in Step P18, the command speed of the folder unit of the main printing press and the virtual current position of the motor shaft of other unit of the main printing press are transmitted to the drive control device (14a to 14d) for other unit of the main printing press. Then, in Step P19, the command speed is outputted to the driver 134 for the drive motor for the folder unit of the main printing press.

Then, in Step P20, counting of the internal clock counter (for counting of elapsed time) 128 is started. Then, in Step P21, the set speed of the main printing press is loaded from the memory M54.

Then, in Step P22, the loaded set speed of the main printing press is written into the memory M61 for storing the command speed of the folder unit of the main printing press. Then, in Step P23, the time interval at which the command speed of the folder unit of the main printing press and the virtual current position of the motor shaft of other unit are transmitted to the drive control device (14a to 14d, 114a to 114d) for other unit is loaded from the memory M62.

The, in Step P24, the count value of the internal clock counter 128 is loaded. Then, in Step P25, it is determined whether the count value of the internal clock counter is equal to or greater than the time interval at which the command speed of the folder unit of the main printing press and the virtual current position of the motor shaft of other unit are transmitted to the drive control device for other unit. If the answer is Y, in Step P26, the count value of the counter 135 for detecting the position of the motor shaft of the folder unit of the main printing press is loaded, and stored into the memory M55. If the answer is N, the program shifts to Step P40, as described later.

Then, in Step P27, the current position of the motor shaft of the folder unit of the main printing press is computed from the count value of the counter 135 for detecting the position of the motor shaft of the folder unit of the main printing press, and stored into the memory M56. Then, in Step P28, the correction value of the current position of other unit of the main printing press is loaded from the memory M57.

Then, in Step P29, the loaded correction value of the current position of other unit of the main printing press is added to the computed current position of the motor shaft of the folder unit of the main printing press to compute the virtual current position of the motor shaft of other unit of the main printing press, and the computed value is stored into the memory M58. Then, in Step P30, the correction value of the current position of each unit of the subordinate printing press is loaded from the memory M59.

Then, in Step P31, the loaded correction value of the current position of each unit of the subordinate printing press is added to the computed current position of the motor shaft of the folder unit of the main printing press to compute the provisional virtual current position of the motor shaft of each unit of the subordinate printing press, and the computed value is stored into the memory M63. Then, in Step P32, the pattern phase cumulative deviation value DDS is loaded from the memory M53.

Then, in Step P33, the loaded pattern phase cumulative deviation value DDS is added to the provisional virtual current position of the motor shaft of each unit of the subordinate printing press to compute the virtual current position of the motor shaft of each unit of the subordinate printing press, which is stored into the memory M60. Then, in Step P34, the command speed of the folder unit of the main printing press is loaded from the memory M61.

Then, in Step P35, the command speed of the folder unit of the main printing press and the virtual current position of the motor shaft of each unit of the subordinate printing press are transmitted to the drive control device (114a to 114d) for each unit of the subordinate printing press. Then, in Step P36, the virtual current position of the motor shaft of other unit of the main printing press is loaded from the memory M58.

Then, in Step P37, the command speed of the folder unit of the main printing press is loaded from the memory M61. Then, in Step P38, the command speed of the folder unit of the main printing press and the virtual current position of the motor shaft of other unit of the main printing press are transmitted to the drive control device (14a to 14d) for other unit of the main printing press. Then, in Step P39, the command speed is outputted to the driver 134 for the drive motor for the folder unit of the main printing press, and the program returns to Step P20.

Then, in the aforementioned Step P40, it is determined whether the pattern phase deviation value DD has been transmitted from the pattern phase deviation computing device 18. If the answer is Y, in Step P41, the pattern phase deviation value DD is received from the pattern phase deviation computing device 18, and stored into the memory M52. If the answer is N, the program returns to Step P24.

Then, in Step P42, a receipt completion signal on the pattern phase deviation value DD is transmitted to the pattern phase deviation computing device 18. Then, in Step P43, the pattern phase cumulative deviation value DDS is loaded from the memory M53. Then, in Step P44, the received pattern phase deviation value DD is added to the pattern phase cumulative deviation value DDS, and the memory M53 for storing the pattern phase cumulative deviation value DDS is overwritten with the obtained value. Then, in Step P45, a pattern phase deviation correction control start command is transmitted to the drive control device (14a to 14d, 114a to 114d) for other unit.

Then, in Step P46, counting of the internal clock counter (for counting of elapsed time) 128 is started. Then, in Step P47, the set speed of the main printing press is loaded from the memory M54.

Then, in Step P48, the loaded set speed of the main printing press is written into the memory M61 for storing the command speed of the folder unit of the main printing press. Then, in Step P49, the time interval at which the command speed of the folder unit of the main printing press and the virtual current position of the motor shaft of other unit are transmitted to the drive control device for other unit is loaded from the memory M62.

The, in Step P50, the count value of the internal clock counter 128 is loaded. Then, in Step P51, it is determined whether the count value of the internal clock counter is equal to or greater than the time interval at which the command speed of the folder unit of the main printing press and the virtual current position of the motor shaft of other unit are transmitted to the drive control device for other unit. If the answer is Y, in Step P52, the count value of the counter 135 for detecting the position of the motor shaft of the folder unit of the main printing press is loaded, and stored into the memory M55. If the answer is N, the program shifts to Step P66.

Then, in Step P53, the current position of the motor shaft of the folder unit of the main printing press is computed from the count value of the counter 135 for detecting the position of the motor shaft of the folder unit of the main printing press, and stored into the memory M56. Then, in Step P54, the correction value of the current position of other unit of the main printing press is loaded from the memory M57.

Then, in Step P55, the loaded correction value of the current position of other unit of the main printing press is added to the computed current position of the motor shaft of the folder unit of the main printing press to compute the virtual current position of the motor shaft of other unit of the main printing press, which is stored into the memory M58. Then, in Step P56, the correction value of the current position of each unit of the subordinate printing press is loaded from the memory M59.

Then, in Step P57, the loaded correction value of the current position of each unit of the subordinate printing press is added to the computed current position of the motor shaft of the folder unit of the main printing press to compute the provisional virtual current position of the motor shaft of each unit of the subordinate printing press, and the computed value is stored in the memory M63. Then, in Step P58, the pattern phase cumulative deviation value DDS is loaded from the memory M53.

Then, in Step P59, the loaded pattern phase cumulative deviation value DDS is added to the provisional virtual current position of the motor shaft of each unit of the subordinate printing press to compute the virtual current position of the motor shaft of each unit of the subordinate printing press, which is stored in the memory M60. Then, in Step P60, the command speed of the folder unit of the main printing press is loaded from the memory M61.

Then, in Step P61, the command speed of the folder unit of the main printing press and the virtual current position of the motor shaft of each unit of the subordinate printing press are transmitted to the drive control device (114a to 114d) for each unit of the subordinate printing press. Then, in Step P62, the virtual current position of the motor shaft of other unit of the main printing press is loaded from the memory M58.

Then, in Step P63, the command speed of the folder unit of the main printing press is loaded from the memory M61. Then, in Step P64, the command speed of the folder unit of the main printing press and the virtual current position of the motor shaft of other unit of the main printing press are transmitted to the drive control device (14a to 14d) for other unit of the main printing press. Then, in Step P65, the command speed is outputted to the driver 134 for the drive motor for the folder unit of the main printing press. Then, the program returns to Step P46.

Then, in Step P66, it is determined whether a pattern phase deviation correction control completion signal has been transmitted from the drive control device for other unit. If the answer is Y, in Step P67, the pattern phase deviation correction control completion signal is received from the drive control device for other unit. If the answer is N, the program returns to Step P51.

Then, in Step P68, the printing press number and the unit number of the unit having received the pattern phase deviation correction control completion signal are stored in the memory M64. Then, in Step P69, it is determined whether pattern phase deviation correction control has been completed in all other units. If the answer is Y, the program returns to Step P20. If the answer is N, the program returns to Step P46. Afterwards, this procedure is repeated.

In accordance with the above-described motion flow, the command speed of the folder unit of the main printing press and the virtual current position of the motor shaft of other unit of the main printing press are transmitted to the drive control device (14a to 14d) for other unit of the main printing press. Moreover, the command speed of the folder unit of the main printing press and the virtual current position of the motor shaft of each unit of the subordinate printing press (if necessary, the position corrected with the pattern phase cumulative deviation value DDS) are transmitted to the drive control device (114a to 114d) for each unit of the subordinate printing press.

Then, the drive control device (14a to 14d, 114a to 114d) for other unit acts in accordance with the motion flow shown in FIGS. 39 and 40.

In Step P1, it is determined whether the command speed of the folder unit of the main printing press and the virtual current position of the motor shaft of the unit have been transmitted from the drive control device 60A for the folder unit of the main printing press. If the answer is Y, in Step P2, the command speed of the folder unit of the main printing press and the virtual current position of the motor shaft of the unit are received from the drive control device 60A for the folder unit of the main printing press, and stored into the memory M65 and the memory M66. If the answer is N, the program shifts to Step P18 to be described later.

Then, in Step P3, the count value of the counter 153 for detecting the position of the motor shaft of the unit is loaded, and stored into the memory M67. Then, in Step P4, the current position of the motor shaft of the unit is computed from the loaded count value of the counter 153 for detecting the position of the motor shaft of the unit, and stored into the memory M68.

Then, in Step P5, the difference of the current position of the motor shaft is computed from the received virtual current position of the motor shaft of the unit and the computed current position of the motor shaft of the unit, and is stored in the memory M69. Then, in Step P6, the absolute value of the difference of the current position of the motor shaft is computed from the computed difference of the current position of the motor shaft, and stored in the memory M70.

Then, in Step P7, the allowable value of the difference in the position of the motor shaft is loaded from the memory M71. Then, in Step P8, it is determined whether the computed absolute value of the difference of the current position of the motor shaft is equal to or less than the loaded allowable value of the difference in the position of the motor shaft. If the answer is Y, in Step P9, the command speed of the folder unit of the main printing press is loaded from the memory M65. If the answer is N, the program shifts to Step P12, as described later.

Then, in Step P10, the command speed of the folder unit of the main printing press is written into the memory M72 for storing the command speed of the unit. Then, in Step P11, the command speed is outputted to the driver 152 for the drive motor for the unit, and the program returns to Step P1.

Then, in the aforementioned Step P12, the table of conversion from the difference of the current position of the motor shaft to the correction value of the command speed is loaded from the memory M73. Then, in Step P13, the difference of the current position of the motor shaft is loaded from the memory M69.

Then, in Step P14, the correction value of the command speed of the unit is obtained from the difference of the current position of the motor shaft with the use of the table of conversion from the difference of the current position of the motor shaft to the correction value of the command speed, and the obtained value is stored in the memory M74. Then, in Step P15, the command speed of the folder unit of the main printing press is loaded from the memory M65.

Then, in Step P16, the obtained correction value of the command speed of the unit is added to the loaded command speed of the folder unit of the main printing press to compute the command speed of the unit, which is stored in the memory M72. Then, in Step P17, the command speed is outputted to the driver 152 for the drive motor for the unit, and the program returns to Step P1.

Then, in the aforementioned Step P18, it is determined whether a pattern phase deviation correction control start command has been transmitted from the drive control device 60A for the folder unit of the main printing press. If the answer is Y, in Step P19, the pattern phase deviation correction control start command is received from the drive control device 60A for the folder unit of the main printing press. If the answer is N, the program returns to Step P1.

Then, if, in Step P20, the command speed of the folder unit of the main printing press and the virtual current position of the motor shaft of the unit have been transmitted from the drive control device 60A for the folder unit of the main printing press, in Step P21, the command speed of the folder unit of the main printing press and the virtual current position of the motor shaft of the unit are received from the drive control device 60A for the folder unit of the main printing press, and then stored in the memory M65 and the memory M66.

Then, in Step P22, the count value of the counter 153 for detecting the position of the motor shaft of the unit is loaded, and stored into the memory M67. Then, in Step P23, the current position of the motor shaft of the unit is computed from the loaded count value of the counter 153 for detecting the position of the motor shaft of the unit, and then stored in the memory M68.

Then, in Step P24, the difference of the current position of the motor shaft is computed from the received virtual current position of the motor shaft of the unit and the computed current position of the motor shaft of the unit, and is stored into the memory M69. Then, in Step P25, the absolute value of the difference of the current position of the motor shaft is computed from the computed difference of the current position of the motor shaft, and stored into the memory M70.

Then, in Step P26, the allowable value of the difference in the position of the motor shaft is loaded from the memory M71. Then, in Step P27, it is determined whether the computed absolute value of the difference of the current position of the motor shaft is equal to or less than the loaded allowable value of the difference in the position of the motor shaft. If the answer is Y, in Step P28, the command speed of the folder unit of the main printing press is loaded from the memory M65. If the answer is N, the program shifts to Step P32, as described later.

Then, in Step P29, the command speed of the folder unit of the main printing press is written into the memory M72 for storing the command speed of the unit. Then, in Step P30, the command speed is outputted to the driver 152 for the drive motor for the unit. Then, in Step P31, a pattern phase deviation correction control completion signal is transmitted to the drive control device 60A for the folder unit of the main printing press, and the program returns to Step P1.

Then, in Step P32, the table of conversion from the difference of the current position of the motor shaft to the correction value of the command speed is loaded from the memory M73. Then, in Step P33, the difference of the current position of the motor shaft is loaded from the memory M69.

Then, in Step P34, the correction value of the command speed of the unit is obtained from the difference of the current position of the motor shaft with the use of the table of conversion from the difference of the current position of the motor shaft to the correction value of the command speed, and the obtained value is stored into the memory M74. Then, in Step P35, the command speed of the folder unit of the main printing press is loaded from the memory M65.

Then, in Step P36, the obtained correction value of the command speed of the unit is added to the loaded command speed of the folder unit of the main printing press to compute the command speed of the unit, which is stored in the memory M72. Then, in Step P37, the command speed is outputted to the driver 152 for the drive motor for the unit, and the program returns to Step P20. Afterwards, this procedure is repeated.

In accordance with the above-described motion flow, when the pattern phase deviation correction control start command is transmitted from the drive control device 60A for the folder unit of the main printing press, in each unit of the subordinate printing press Bb, the obtained correction value of the command speed of the unit is added to the loaded command speed of the folder unit of the main printing press to compute the command speed of the unit, which is outputted to the driver 152 for the drive motor for the unit. In response to the command speed, a correction is made such that the position of the pattern printed by the subordinate printing press Bb and the position of the pattern printed by the main printing press Aa are in a correct position, whereupon the drive motor (15a to 15d, 115a to 115d) for other unit is controlled in synchronization with the drive motor 61A for the folder unit of the main printing press.

In the present embodiment, as described above, the rotation phase of the drive motor (115a to 115d) for the unit of the subordinate printing press is directly adjusted by the drive control device 60A for the folder unit of the main printing press in accordance with the position of the pattern of the subordinate printing press Bb detected by the pattern phase deviation detecting sensor 17. Thus, the position of the pattern printed by the main printing press Aa and the position of the pattern printed by the subordinate printing press Bb can be automatically brought into a proper position.

Accordingly, burden on the operator can be lessened, and the amount of occurrence of defective printing products can be cut down. In the present embodiment, there may be a plurality of the subordinate printing presses B.

### Embodiment 5

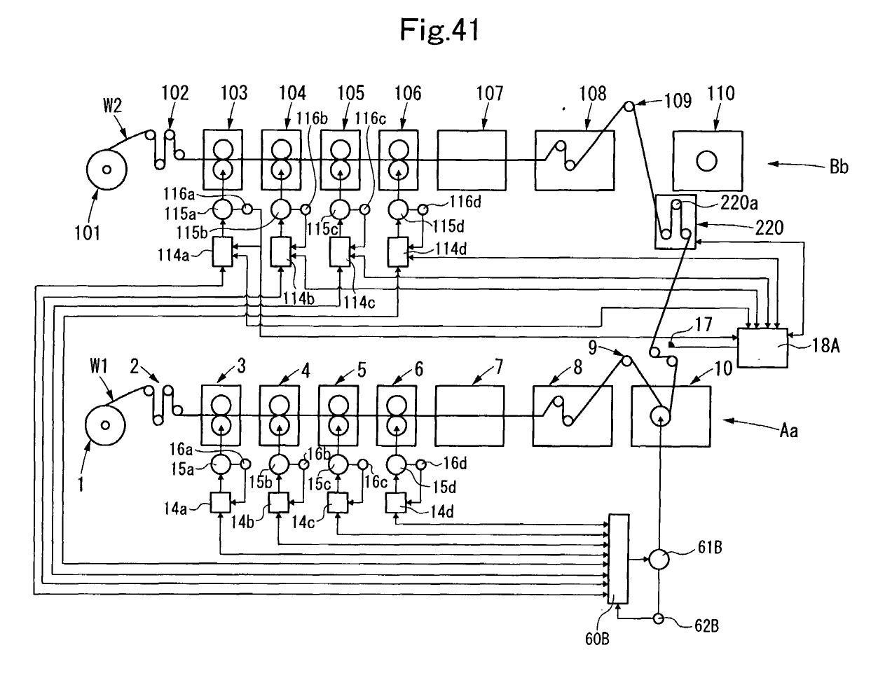

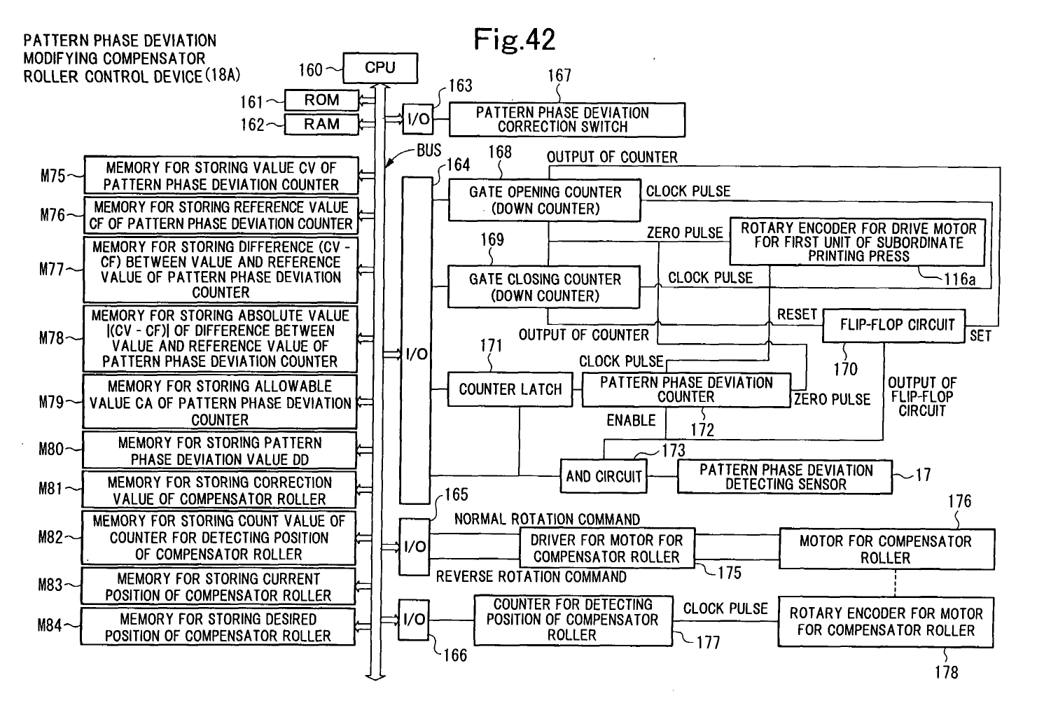

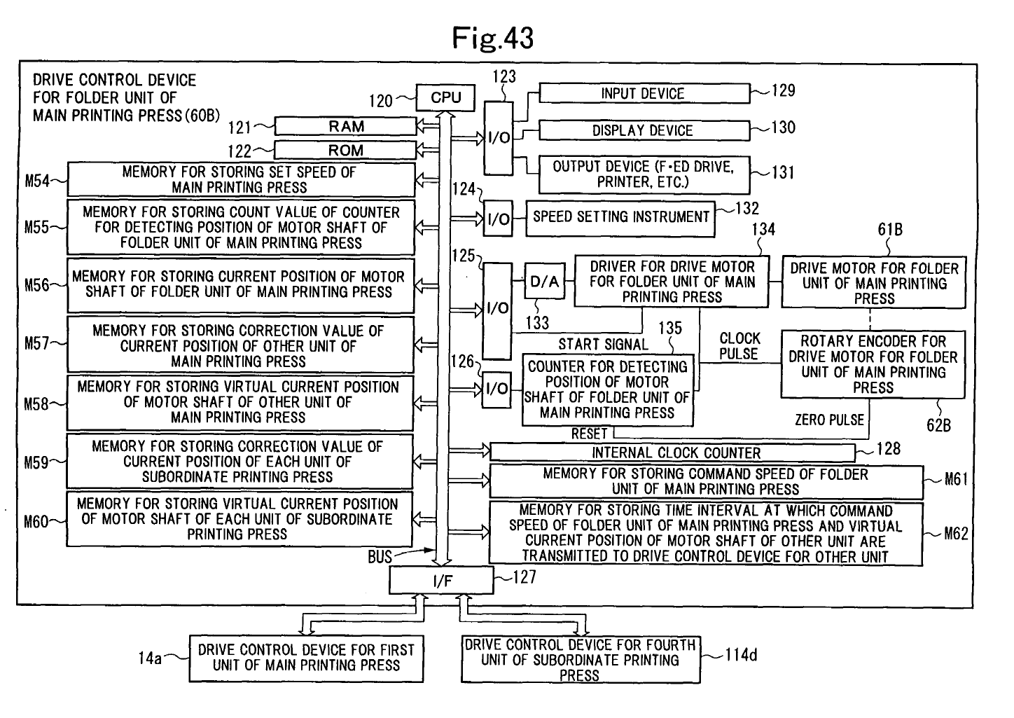

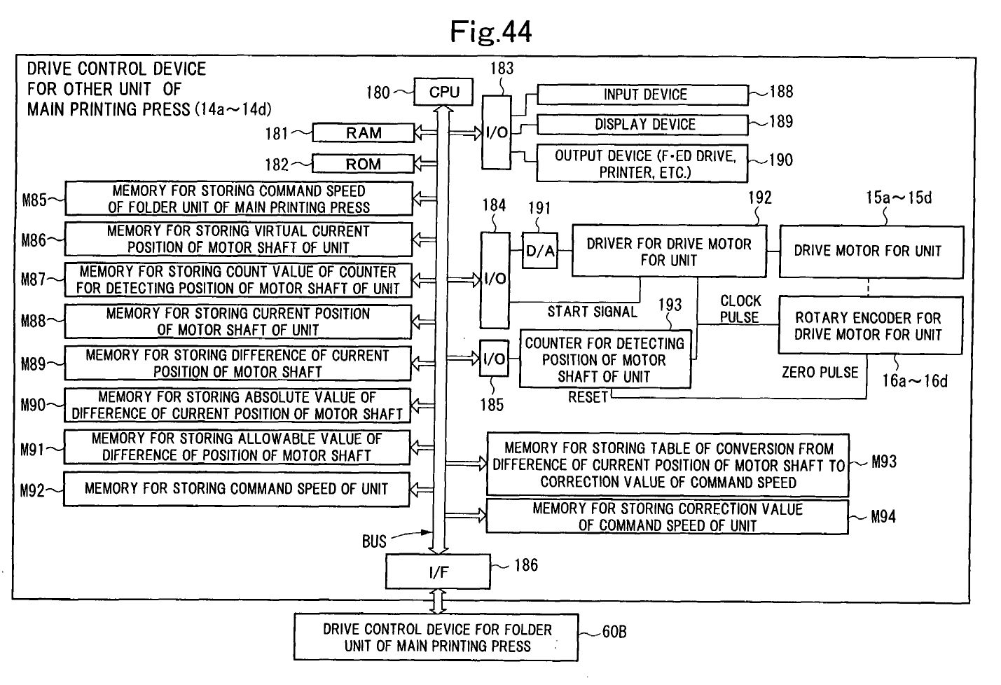

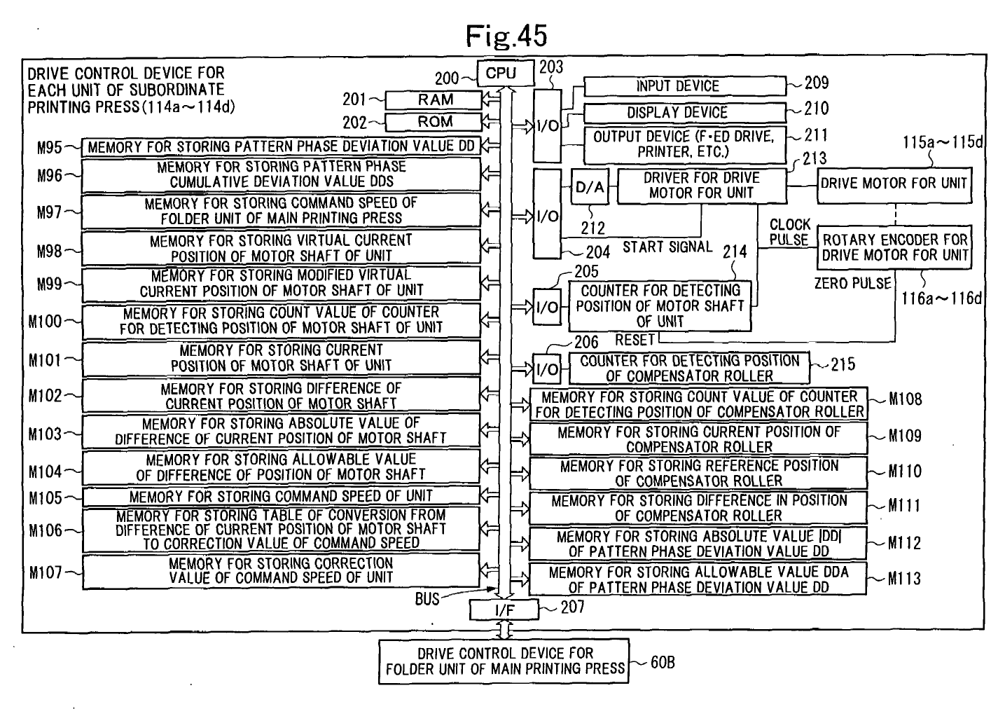

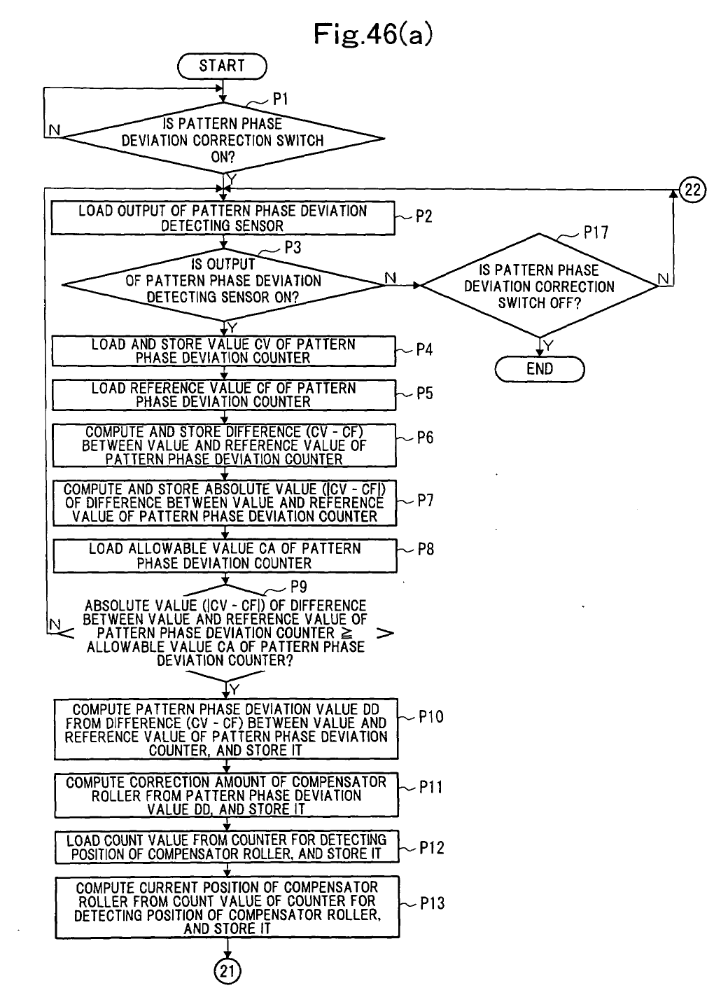

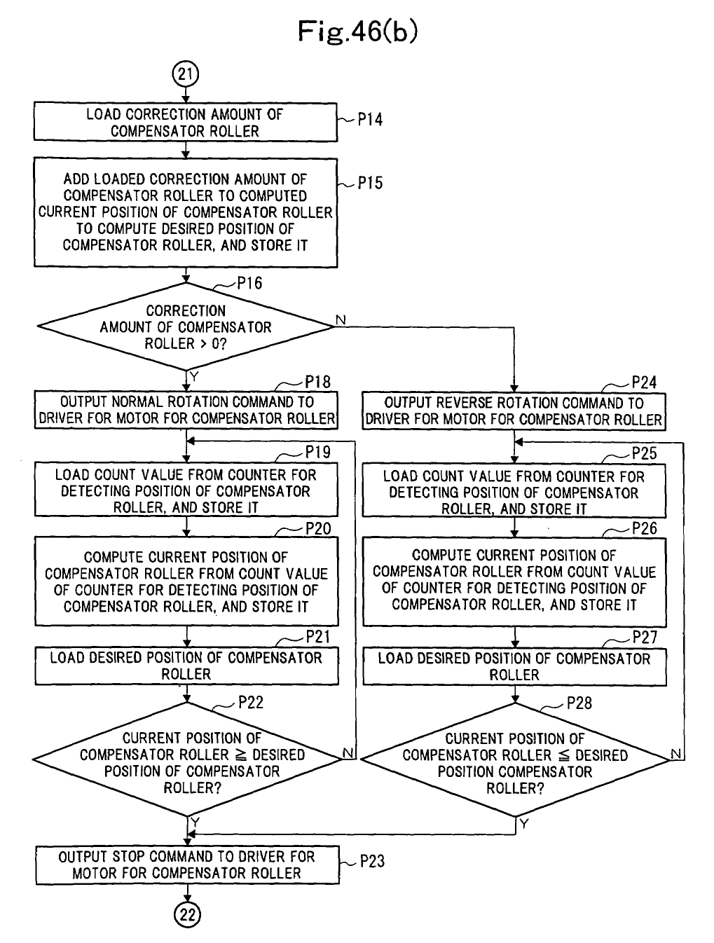

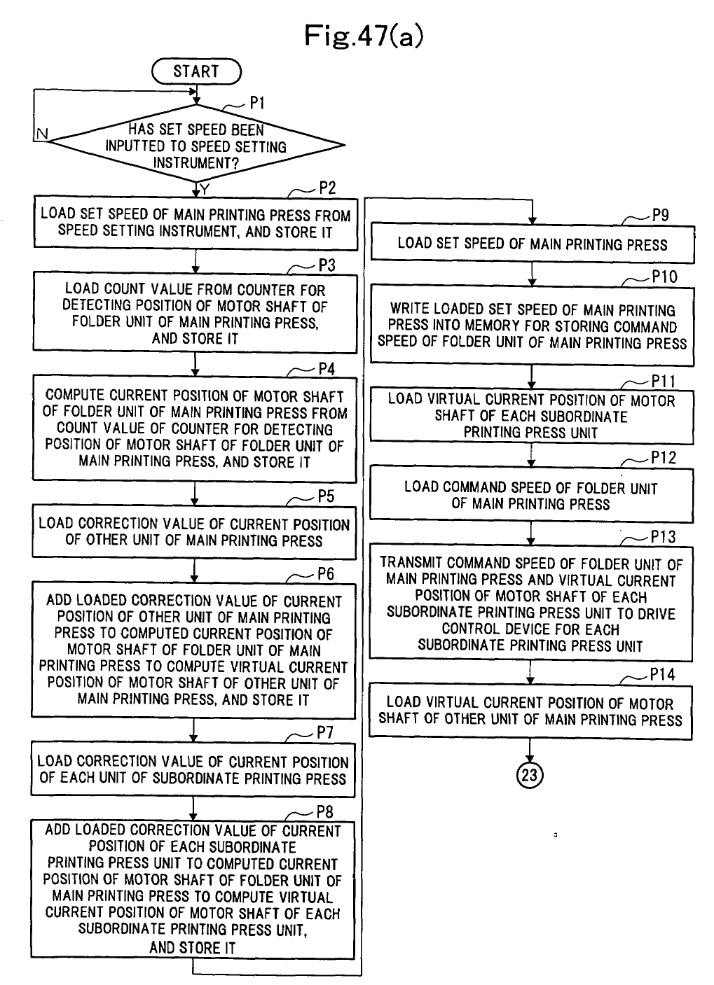

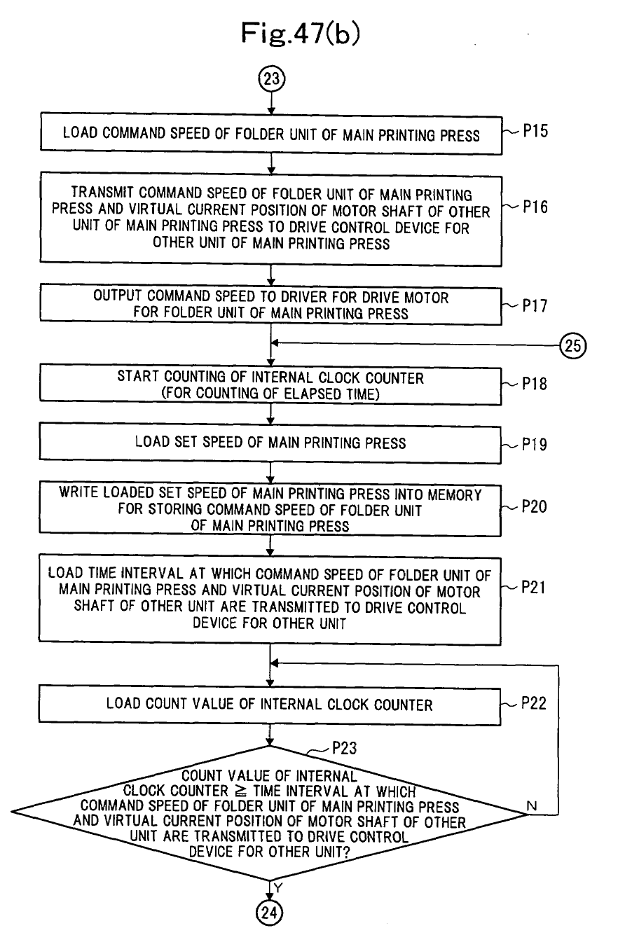

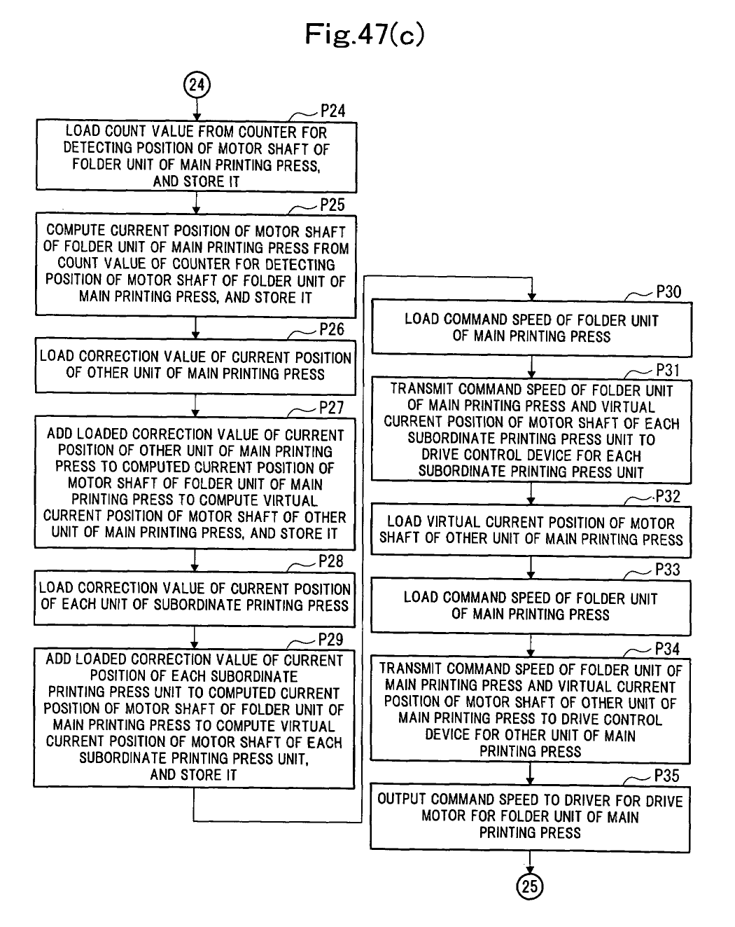

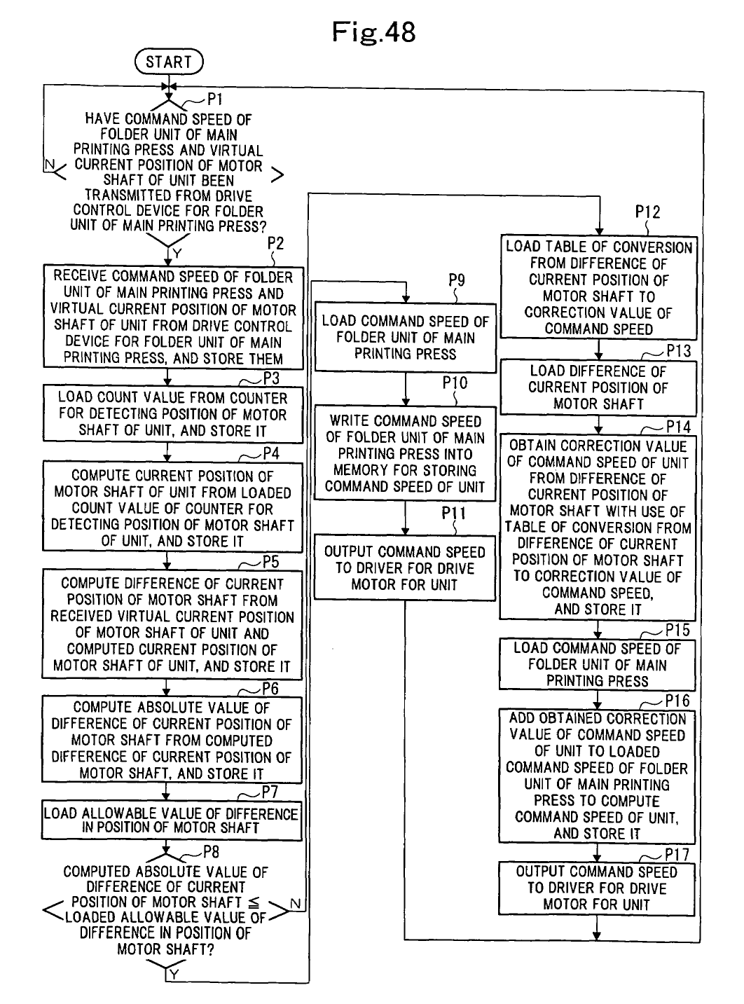

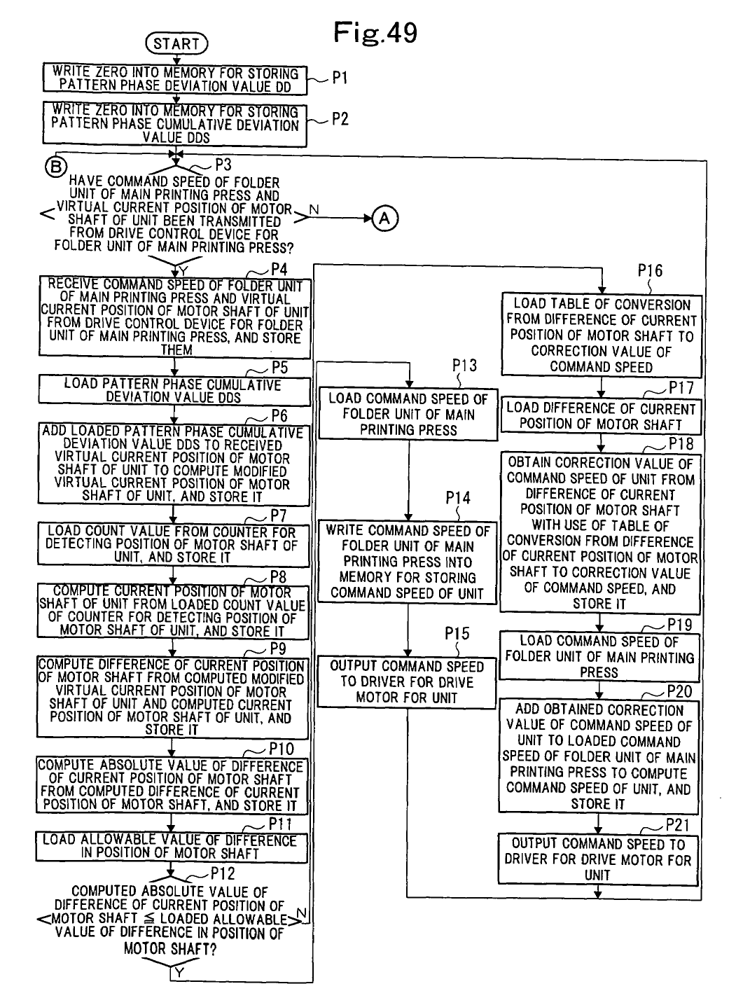

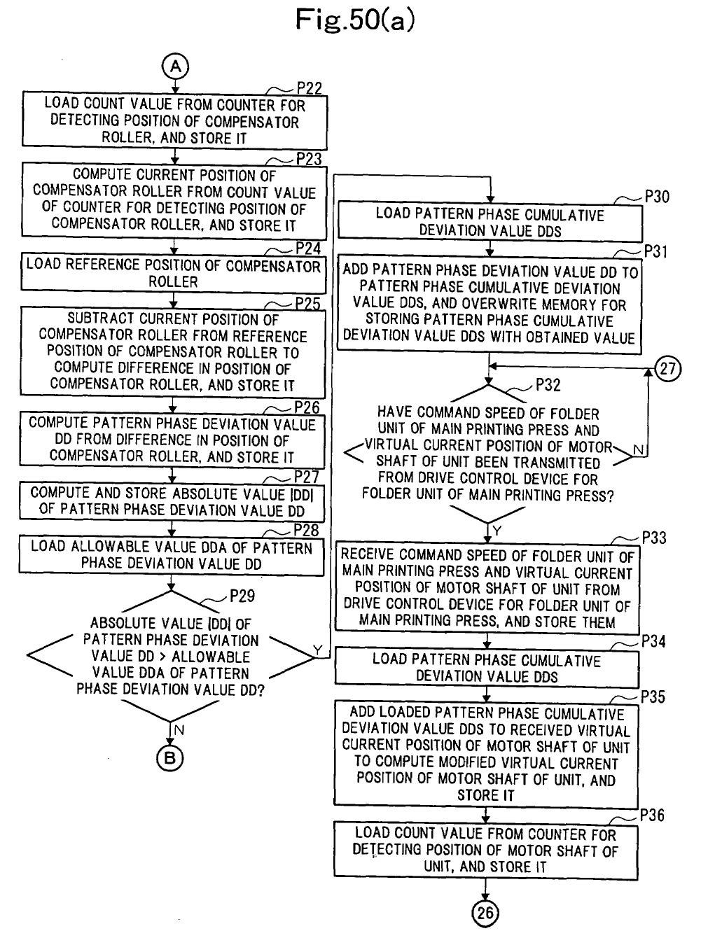

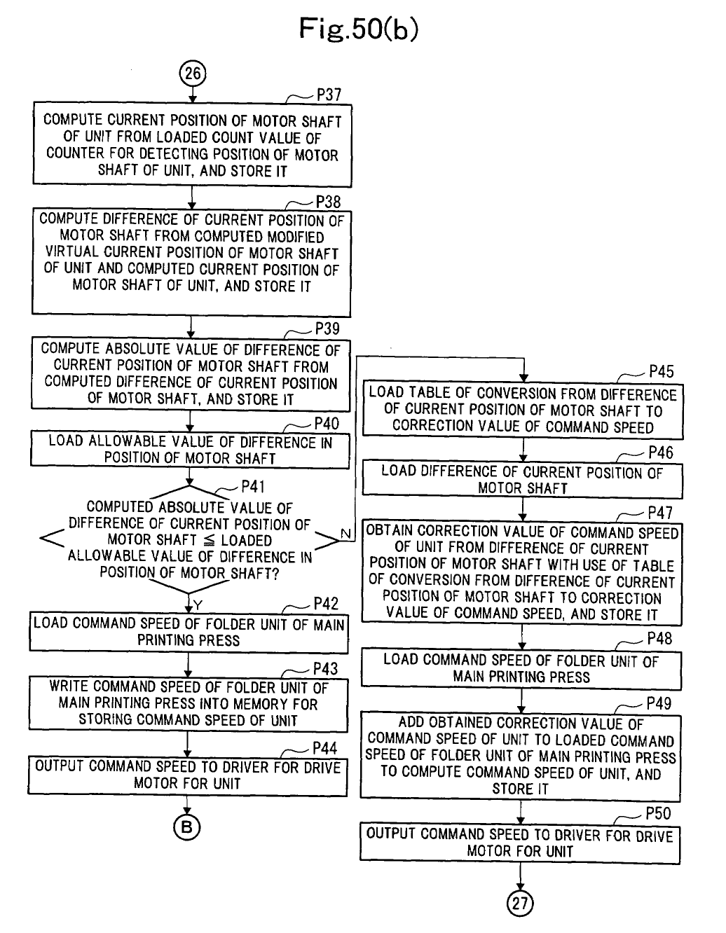

FIG. 41 is a schematic configurational drawing of a synchronous control apparatus for a web rotary printing press showing Embodiment 5 of the present invention. FIG. 42 is a block diagram of a pattern phase deviation modifying compensator roller control device. FIG. 43 is a block diagram of a drive control device for a folder unit of a main printing press. FIG. 44 is a block diagram of a drive control device for other unit of the main printing press. FIG. 45 is a block diagram of a drive control device for each unit of a subordinate printing press. FIG. 46(a) is a motion flow chart of the pattern phase deviation modifying compensator roller control device. FIG. 46(b) is a motion flow chart of the pattern phase deviation modifying compensator roller control device. FIG. 47(a) is a motion flow chart of the drive control device for the folder unit of the main printing press. FIG. 47(b) is a motion flow chart of the drive control device for the folder unit of the main printing press. FIG. 47(c) is a motion flow chart of the drive control device for the folder unit of the main printing press. FIG. 48 is a motion flow chart of the drive control device for other unit of the main printing press. FIG. 49 is a motion flow chart of the drive control device for each unit of the subordinate printing press. FIG. 50(a) is a motion flow chart of the drive control device for each unit of the subordinate printing press. FIG. 50(b) is a motion flow chart of the drive control device for each unit of the subordinate printing press.

In a main printing press Aa comprising a web rotary printing press as a first rolled paper rotary printing press, as shown in FIG. 41, a roll of paper (web) W1 continuously fed from a feeder 1 and an infeed unit 2 undergoes various printings when it passes through first to fourth (printing) units 3 to 6. Then, the web is heated to dryness when it passes through a dryer 7, and is then cooled when it passes through a cooling unit 8. Then, when the web passes over a drag unit 9, its tension is controlled or its direction is changed. Then, the web is cut to a predetermined shape and folded by a folder 10.

The first to fourth printing units 3 to 6 and the folder 10 are driven individually by drive motors 15a to 15d and a drive motor 61B. Rotary encoders 16a to 16d and 62B for detecting the rotational speeds of these drive motors 15a to 15d, 61B are annexed to the drive motors 15a to 15d, 61B. The drive motors 15a to 15d, 61B are drivingly controlled by drive control devices 14a to 14d, 60B, and detection signals from the rotary encoders 16a to 16d, 62B are inputted to the drive control devices 14a to 14d, 60B.

In a subordinate printing press Bb comprising a web rotary printing press as a second rolled paper rotary printing press, on the other hand, a roll of paper (web) W2 continuously fed from a feeder 101 and an infeed unit 102 undergoes various printings when it passes through first to fourth (printing) units 103 to 106. Then, the web is heated to dryness when it passes through a dryer 107, and is then cooled when it passes through a cooling unit 108. Then, when the web passes over a drag unit 109, its tension is controlled or its direction is changed. Then, the web is cut to a predetermined shape and folded by a folder 110.

The first to fourth printing units 103 to 106 are driven individually by drive motors 115a to 115d. Rotary encoders 116a to 116d for detecting the rotational speeds of the drive motors 115a to 115d are connected to the drive motors 115a to 115d. The drive motors 115a to 115d are drivingly controlled by drive control devices 114a to 114d, respectively, and detection signals from the rotary encoders 116a to 116d are inputted to the drive control devices 114a to 114d. The folder 110 may also be driven individually by a drive motor.

The drive control devices 14a to 14d and 114a to 114d for the respective units of the main printing press Aa and the subordinate printing press Bb are synchronously controlled by the drive control device (control means) 60B for the folder unit of the main printing press, whereby the main printing press Aa and the subordinate printing press Bb are synchronously operated. That is, in the present embodiment, the webs W1 and W2 printed by the main printing press Aa and the subordinate printing press Bb are both guided to the folder 10 of the main printing press Aa, where they are folded.

A pattern phase deviation detecting sensor (pattern position measuring means) 17, such as a scanning sensor, for measuring the position of a pattern (strictly, a register mark) printed by the subordinate printing press Bb is provided halfway through a transport path on which the web W2 printed by the subordinate printing press Bb is transferred so that it is superposed on the web W1 printed by the main printing press Aa.

A detection signal from the pattern phase deviation detecting sensor 17 is inputted to a pattern phase deviation modifying compensator roller control device (control means) 18A, together with the detection signal from the rotary encoder 116a in the first unit 103 of the subordinate printing press Bb.

The pattern phase deviation modifying compensator roller control device 18A adjusts the position of a roller 220a of a compensator (means for adjusting the position of the compensator roller) 220, which adjusts the length of the transport path taken by the web W2 printed by the subordinate printing press Bb, in accordance with the amount of an error in the pattern position (pattern phase deviation value DD) computed based on both of the detection signals, and also controls the rotation phase of the drive motor (115a to 115d) of the subordinate printing press Bb based on the position of the roller 220a, thereby bringing the position of the pattern printed by the main printing press Aa and the position of the pattern printed by the subordinate printing press Bb into alignment. The compensator 220 is provided halfway through the transport path, on which the web W2 printed by the subordinate printing press Bb is transferred so that it is superposed on the web W1 printed by the main printing press Aa, and is also located upstream of the pattern phase deviation detecting sensor 17.

As shown in FIG. 42, the pattern phase deviation modifying compensator roller control device 18A comprises CPU 160, ROM 161, RAM 162, and input/output devices 163 to 166 connected together by BUS (bus line). To the BUS, the following memories are connected: a memory M75 for storing the value CV of a pattern phase deviation counter, a memory M76 for storing the reference value CF of the pattern phase deviation counter, a memory M77 for storing the difference (CV−CF) between the value and the reference value of the pattern phase deviation counter, a memory M78 for storing the absolute value |(CV−CF)| of the difference between the value and the reference value of the pattern phase deviation counter, a memory M79 for storing the allowable value CA of the pattern phase deviation counter, a memory M80 for storing the pattern phase deviation value DD, a memory M81 for storing the correction value of the compensator roller, a memory M82 for storing the count value of a counter for detecting the position of the compensator roller, a memory M83 for storing the current position of the compensator roller, and a memory M84 for storing the desired position of the compensator roller.

A pattern phase deviation correction switch 167 is connected to the input/output device 163.

To the input/output device 164, a gate opening counter (down counter) 168 and a gate closing counter (down counter) 169 are connected, a pattern phase deviation counter 172 is connected via a counter latch 171, and the pattern phase deviation detecting sensor 17 is connected via an AND circuit 173. The rotary encoder 116a for the drive motor for the first unit of the subordinate printing press is connected to the gate opening counter (down counter) 168 and the gate closing counter (down counter) 169, and the rotary encoder 116a for the drive motor for the first unit of the subordinate printing press is also connected to the pattern phase deviation counter 172. A flip-flop circuit 170 is connected to the gate opening counter (down counter) 168 and the gate closing counter (down counter) 169, and the flip-flop circuit 170 is also connected to the pattern phase deviation counter 172 and the AND circuit 173. The AND circuit 173 is also connected to the counter latch 171.

In the input/output device 164, therefore, the gate opening counter 168, the gate closing counter 169, and the pattern phase deviation counter 172 are reset by a zero pulse generated by the rotary encoder 116a for the drive motor for the first unit of the subordinate printing press in accordance with the rotation of the drive motor 115a for the first unit of the subordinate printing press. Then, the gate opening counter 168 counts up in accordance with a clock pulse generated by the rotary encoder 116a, whereupon the flip-flop circuit 170 is set by the output of the counter 168. As a result, the pattern phase deviation counter 172 starts counting, and the AND circuit 173 is opened, in accordance with the output from the flip-flop circuit 170. When the signal from the pattern phase deviation detecting sensor 17 is inputted, the count value of the counter 172 at this time is held by the counter latch 171.

Then, the gate closing counter 169 counts up in accordance with the clock pulse generated by the rotary encoder 116a, whereupon the flip-flop circuit 170 is reset by the output of the counter 169. Consequently, the output from the flip-flop circuit 170 is stopped, whereby the pattern phase deviation counter 172 stops counting, and the AND circuit 173 is closed, so that the input signal from the pattern phase deviation detecting sensor 17 is shut off. In this manner, the pattern phase deviation is detected only with a predetermined timing preset by the gate opening counter 168 and the gate closing counter 169.

To the input/output device 165, a motor 176 for the compensator roller is connected via a driver 175 for the motor for the compensator roller.

A counter 177 for detecting the position of the compensator roller is connected to the input/output device 166, and a rotary encoder 178 for the motor for the compensator roller, which is drivingly coupled to the motor 176 for the compensator roller, is connected to the counter 177 for detecting the position of the compensator roller.

As shown in FIG. 43, the drive control device 60B for the folder unit of the main printing press comprises CPU 120, ROM 121, RAM 122, input/output devices 123 to 126, and an interface 127 connected together by BUS (bus line). To the BUS, the following are connected: a memory M54 for storing the set speed of the main printing press, a memory M55 for storing the count value of the counter for detecting the position of the motor shaft of the folder unit of the main printing press, a memory M56 for storing the current position of the motor shaft of the folder unit of the main printing press, a memory M57 for storing the correction value of the current position of other unit of the main printing press, a memory M58 for storing the virtual current position of the motor shaft of other unit of the main printing press, a memory M59 for storing the correction value of the current position of each unit of the subordinate printing press, a memory M60 for storing the virtual current position of the motor shaft of each unit of the subordinate printing press, a memory M61 for storing the command speed of the folder unit of the main printing press, a memory M62 for storing the time interval at which the command speed of the folder unit of the main printing press and the virtual current position of the motor shaft of other unit are transmitted to the drive control device for other unit, and an internal clock counter 128.

To the input/output device 123, the following are connected: an input device 129 such as a keyboard, various switches, and buttons, a display device 130 such as CRT and lamps, and an output device 131 such as a printer and a floppy disk (registered trademark) drive. A speed setting instrument 132 is connected to the input/output device 124. To the input/output device 125, the drive motor 61B for the folder unit of the main printing press is connected via a D/A converter 133 and a driver 134 for the drive motor for the folder unit of the main printing press. The rotary encoder 62B for the drive motor for the folder unit of the main printing press, which is drivingly coupled to the drive motor 61B for the folder unit of the main printing press, is connected to the driver 134 for the drive motor for the folder unit of the main printing press. A counter 135 for detecting the position of the motor shaft of the folder unit of the main printing press is connected to the input/output device 126, and the rotary encoder 62B for the drive motor for the folder unit of the main printing press is connected to the counter 135 for detecting the position of the motor shaft of the folder unit of the main printing press. The drive control device 14a for the first unit of the main printing press to the drive control device 114d for the fourth unit of the subordinate printing press (to be described later) are connected to the interface 127.

As shown in FIG. 44, the drive control device (14a to 14d) for other unit of the main printing press comprises CPU 180, ROM 181, RAM 182, input/output devices 183 to 185, and an interface 186 connected together via BUS (bus line). To the BUS, the following memories are connected: A memory M85 for storing the command speed of the folder unit of the main printing press, a memory M86 for storing the virtual current position of the motor shaft of the unit, a memory M87 for storing the count value of the counter for detecting the position of the motor shaft of the unit, a memory M88 for storing the current position of the motor shaft of the unit, a memory M89 for storing the difference of the current position of the motor shaft, a memory M90 for storing the absolute value of the difference of the current position of the motor shaft, a memory M91 for storing the allowable value of the difference of the position of the motor shaft, a memory M92 for storing the command speed of the unit, a memory M93 for storing a table of conversion from the difference of the current position of the motor shaft to the correction value of the command speed, and a memory M94 for storing the correction value of the command speed of the unit.

To the input/output device 183, the following are connected: an input device 188 such as a keyboard, various switches, and buttons, a display device 189 such as CRT and lamps, and an output device 190 such as a printer and a floppy disk (registered trademark) drive. To the input/output device 184, the drive motor (15a to 15d) for the unit is connected via a D/A converter 191 and a driver 192 for the drive motor for the unit. The rotary encoder (16a to 16d) for the drive motor for the unit, which is drivingly coupled to the drive motor (15a to 15d) for the unit, is connected to the driver 192 for the drive motor for the unit. A counter 193 for detecting the position of the motor shaft of the unit is connected to the input/output device 185, and the rotary encoder (16a to 16d) for the drive motor for the unit is connected to the counter 193 for detecting the position of the motor shaft of the unit. The aforementioned drive control device 60B for the folder unit of the main printing press is connected to the interface 186.

As shown in FIG. 45, the drive control device (114a to 114d) for other unit of the subordinate printing press comprises CPU 200, ROM 201, RAM 202, input/output devices 203 to 206, and an interface 207 connected together via BUS (bus line). To the BUS, the following memories are connected: a memory M95 for storing the pattern phase deviation value DD, a memory M96 for storing the pattern phase cumulative deviation value DDS, a memory M97 for storing the command speed of the folder unit of the main printing press, a memory M98 for storing the virtual current position of the motor shaft of the unit, a memory M99 for storing the modified virtual current position of the motor shaft of the unit, a memory M100 for storing the count value of the counter for detecting the position of the motor shaft of the unit, a memory M101 for storing the current position of the motor shaft of the unit, a memory M102 for storing the difference of the current position of the motor shaft, a memory M103 for storing the absolute value of the difference of the current position of the motor shaft, a memory M104 for storing the allowable value of the difference of the position of the motor shaft, a memory M105 for storing the command speed of the unit, a memory M106 for storing a table of conversion from the difference of the current position of the motor shaft to the correction value of the command speed, a memory M107 for storing the correction value of the command speed of the unit, a memory M108 for storing the count value of the counter for detecting the position of the compensator roller, a memory M109 for storing the current position of the compensator roller, a memory M110 for storing the reference position of the compensator roller, a memory M111 for storing the difference in the position of the compensator roller, a memory M112 for storing the absolute value |DD| of the pattern phase deviation value DD, and a memory M113 for storing the allowable value DDA of the pattern phase deviation value DD.

To the input/output device 203, the following are connected: an input device 209 such as a keyboard, various switches, and buttons, a display device 210 such as CRT and lamps, and an output device 211 such as a printer and a floppy disk (registered trademark) drive. To the input/output device 204, the drive motor (115a to 115d) for the unit is connected via a D/A converter 212 and a driver 213 for the drive motor for the unit. The rotary encoder (116a to 116d) for the drive motor for the unit, which is drivingly coupled to the drive motor (115a to 115d) for the unit, is connected to the driver 213 for the drive motor for the unit. A counter 214 for detecting the position of the motor shaft of the unit is connected to the input/output device 205, and the rotary encoder (116a to 116d) for the drive motor for the unit is connected to the counter 214 for detecting the position of the motor shaft of the unit. A counter 215 for detecting the position of the compensator roller is connected to the input/output device 206. The aforementioned drive control device 60B for the folder unit of the main printing press is connected to the interface 207.

Because of the above configurations, when the main printing press Aa and the subordinate printing press Bb are to be synchronously controlled, the pattern phase deviation modifying compensator roller control device 18A acts in accordance with the motion flow shown in FIGS. 46(a) and 46(b).

If the pattern phase deviation correction switch 167 is ON in Step P1, the output of the pattern phase deviation detecting sensor 17 is loaded in Step P2. Then, in Step P3, it is determined whether the output of the pattern phase deviation detecting sensor 17 is ON.

If the answer is Y (yes) in the above Step P3, the value CV of the pattern phase deviation counter 172 is loaded and stored into the memory M75 in Step P4. If the answer is N (no) in Step P3, it is determined in Step P13 whether the pattern phase deviation correction switch 167 is OFF. If the answer is Y in Step P13, the action is completed. If the answer is N, the program returns to Step P2.

Then, in Step P5, the reference value CF of the pattern phase deviation counter 172 is loaded from the memory M76. Then, in Step P6, the difference (CV−CF) between the value and the reference value of the pattern phase deviation counter is computed, and stored into the memory M77. The reference value CF of the pattern phase deviation counter corresponds to the rotation phase of the first unit of the subordinate printing press Bb, in which the pattern printed by the subordinate printing press Bb is detected by the pattern phase deviation detecting sensor 17, with the position of the pattern printed by the main printing press Aa (first printing press) and the position of the pattern printed by the subordinate printing press Bb (second printing press) being aligned in the folder 10, in consideration of the amount of elongation of the web W1 printed by the main printing press Aa.

Then, in Step P7, the absolute value (|CV−CF|) of the difference between the value and the reference value of the pattern phase deviation counter is computed, and stored into the memory M78. Then, in Step P8, the allowable value CA of the pattern phase deviation counter 172 is loaded from the memory M79.

Then, in Step P9, it is determined whether the absolute value (|CV−CF|) of the difference between the value and the reference value of the pattern phase deviation counter is equal to or greater than the allowable value CA of the pattern phase deviation counter. If the answer is Y, in Step P10, the pattern phase deviation value DD is computed from the difference (CV−CF) between the value and the reference value of the pattern phase deviation counter, and stored into the memory M80. If the answer is N, the program returns to Step P2.

Then, in Step P11, the correction amount of the compensator roller is computed from the pattern phase deviation value DD, and stored into the memory M81. Then, in Step P12, the count value is loaded from the counter 177 for detecting the position of the compensator roller, and stored into the memory M82.

Then, in Step P13, the current position of the compensator roller is computed from the count value of the counter 177 for detecting the position of the compensator roller, and stored into the memory M83. Then, in Step P14, the correction amount of the compensator roller is loaded from the memory M81.

Then, in Step P15, the loaded correction amount of the compensator roller is added to the computed current position of the compensator roller to compute the desired position of the compensator roller, which is stored into the memory M84. Then, in Step P16, it is determined whether the correction amount of the compensator roller is greater than 0.

Then, if the answer is Y in the above Step P16, Step P18 is executed to output a normal rotation command to the driver 175 for the motor for the compensator roller. Then, in Step P19, the count value is loaded from the counter 177 for detecting the position of the compensator roller, and stored in the memory M82.

Then, in Step P20, the current position of the compensator roller is computed from the count value of the counter 177 for detecting the position of the compensator roller, and stored into the memory M83. Then, in Step P21, the desired position of the compensator roller is loaded from the memory M84.

Then, in Step P22, it is determined whether the current position of the compensator roller is equal to or greater than the desired position of the compensator roller. If the answer is Y, in Step P23, a stop command is outputted to the driver 175 for the motor for the compensator roller, and the program returns to Step P2. If the answer is N, the program returns to Step P19.

If the answer is N in the above Step P16, Step P24 is executed to output a reverse rotation command to the driver 175 for the motor for the compensator roller. Then, in Step P25, the count value is loaded from the counter 177 for detecting the position of the compensator roller, and stored in the memory M82.

Then, in Step P26, the current position of the compensator roller is computed from the count value of the counter 177 for detecting the position of the compensator roller, and stored in the memory M83. Then, in Step P27, the desired position of the compensator roller is loaded from the memory M84.

Then, in Step P28, it is determined whether the current position of the compensator roller is equal to or greater than the desired position of the compensator roller. If the answer is Y, the program shifts to Step P23. If the answer is N, the program returns to Step P25. Afterwards, this procedure is repeated.

In accordance with the above motion flow, the pattern phase deviation value DD (the amount of an error in the pattern position) is computed, and the position of the roller 220a of the compensator 220 is adjusted based on the result of the computation.

Then, the drive control device 60B for the folder unit of the main printing press acts in accordance with the motion f low shown in FIGS. 47(a), 47(b) and 47(c).

If the set speed is inputted to the speed setting instrument 132 in Step P1, Step P2 is executed to load the set speed of the main printing press Aa from the speed setting instrument 132, and store it in the memory M54.

Then, in Step P3, the count value is loaded from the counter 135 for detecting the position of the motor shaft of the folder unit of the main printing press, and stored in the memory M55. Then, in Step P4, the current position of the motor shaft of the folder unit of the main printing press is computed from the count value of the counter 135 for detecting the position of the motor shaft of the folder unit of the main printing press, and then stored in the memory M56.

Then, in Step P5, the correction value of the current position of other unit of the main printing press is loaded from the memory M57. Then, in Step P6, the loaded correction value of the current position of other unit of the main printing press is added to the computed current position of the motor shaft of the folder unit of the main printing press to compute the virtual current position of the motor shaft of other unit of the main printing press, and then the computed value is stored in the memory M58.

Then, in Step P7, the correction value of the current position of each unit of the subordinate printing press is loaded from the memory M59. Then, in Step P8, the loaded correction value of the current position of each unit of the subordinate printing press is added to the computed current position of the motor shaft of the folder unit of the main printing press to compute the virtual current position of the motor shaft of each unit of the subordinate printing press, and the computed value is stored in the memory M60.

Then, in Step P9, the set speed of the main printing press is loaded from the memory M54. Then, in Step P10, the loaded set speed of the main printing press is written into the memory M61 for storing the command speed of the folder unit of the main printing press. Then, in Step P11, the virtual current position of the motor shaft of each unit of the subordinate printing press is loaded from the memory M60.

Then, in Step P12, the command speed of the folder unit of the main printing press is loaded from the memory M61. Then, in Step P13, the command speed of the folder unit of the main printing press and the virtual current position of the motor shaft of each unit of the subordinate printing press are transmitted to the drive control device (114a to 114d) for each unit of the subordinate printing press.

Then, in Step P14, the virtual current position of the motor shaft of other unit of the main printing press is loaded from the memory M58. Then, in Step P15, the command speed of the folder unit of the main printing press is loaded from the memory M61.

Then, in Step P16, the command speed of the folder unit of the main printing press and the virtual current position of the motor shaft of other unit of the main printing press are transmitted to the drive control device (14a to 14d) for other unit of the main printing press. Then, in Step P17, the command speed is outputted to the driver 134 for the drive motor for the folder unit of the main printing press.

Then, in Step P18, counting of the internal clock counter (for counting of elapsed time) 128 is started. Then, in Step P19, the set speed of the main printing press is loaded from the memory M54.

Then, in Step P20, the loaded set speed of the main printing press is written into the memory M61 for storing the command speed of the folder unit of the main printing press. Then, in Step P21, the time interval at which the command speed of the folder unit of the main printing press and the virtual current position of the motor shaft of other unit are transmitted to the drive control device (14a to 14d, 114a to 114d) for other unit is loaded from the memory M62.

The, in Step P22, the count value of the internal clock counter 128 is loaded. Then, in Step P23, it is determined whether the count value of the internal clock counter is equal to or greater than the time interval at which the command speed of the folder unit of the main printing press and the virtual current position of the motor shaft of other unit are transmitted to the drive control device for other unit. If the answer is Y, in Step P24, the count value of the counter 135 for detecting the position of the motor shaft of the folder unit of the main printing press is loaded, and then stored in the memory M55. If the answer is N, the program returns to Step P22.

Then, in Step P25, the current position of the motor shaft of the folder unit of the main printing press is computed from the count value of the counter 135 for detecting the position of the motor shaft of the folder unit of the main printing press, and then stored in the memory M56. Then, in Step P26, the correction value of the current position of other unit of the main printing press is loaded from the memory M57.

Then, in Step P27, the loaded correction value of the current position of other unit of the main printing press is added to the computed current position of the motor shaft of the folder unit of the main printing press to compute the virtual current position of the motor shaft of other unit of the main printing press, and the computed value is stored in the memory M58. Then, in Step P28, the correction value of the current position of each unit of the subordinate printing press is loaded from the memory M59.

Then, in Step P29, the loaded correction value of the current position of each unit of the subordinate printing press is added to the computed current position of the motor shaft of the folder unit of the main printing press to compute the virtual current position of the motor shaft of each unit of the subordinate printing press, and the computed value is stored in the memory M60. Then, in Step P30, the command speed of the folder unit of the main printing press is loaded from the memory M61.

Then, in Step P31, the command speed of the folder unit of the main printing press and the virtual current position of the motor shaft of each unit of the subordinate printing press are transmitted to the drive control device (114a to 114d) for each unit of the subordinate printing press. Then, in Step P32, the virtual current position of the motor shaft of other unit of the main printing press is loaded from the memory M58.

Then, in Step P33, the command speed of the folder unit of the main printing press is loaded from the memory M61. Then, in Step P34, the command speed of the folder unit of the main printing press and the virtual current position of the motor shaft of other unit of the main printing press are transmitted to the drive control device (14a to 14d) for other unit of the main printing press. Then, in Step P35, the command speed is outputted to the driver 134 for the drive motor for the folder unit of the main printing press, and the program returns to Step P18. Afterwards, this procedure is repeated.

In accordance with the above-described motion flow, the command speed of the folder unit of the main printing press and the virtual current position of the motor shaft of other unit are transmitted to the drive control device (14a to 14d) for other unit of the main printing press and the drive control device (114a to 114d) for each unit of the subordinate printing press at predetermined time intervals.

Then, the drive control device (14a to 14d) for other unit of the main printing press acts in accordance with the motion flow shown in FIG. 48.

In Step P1, it is determined whether the command speed of the folder unit of the main printing press and the virtual current position of the motor shaft of the unit have been transmitted from the drive control device 60B for the folder unit of the main printing press. If the answer is Y, in Step P2, the command speed of the folder unit of the main printing press and the virtual current position of the motor shaft of the unit are received from the drive control device 60B for the folder unit of the main printing press, and stored in the memory M85 and the memory M86.

Then, in Step P3, the count value of the counter 193 for detecting the position of the motor shaft of the unit is loaded, and stored into the memory M87. Then, in Step P4, the current position of the motor shaft of the unit is computed from the loaded count value of the counter 193 for detecting the position of the motor shaft of the unit, and then stored in the memory M88.

Then, in Step P5, the difference of the current position of the motor shaft is computed from the received virtual current position of the motor shaft of the unit and the computed current position of the motor shaft of the unit, and then is stored in the memory M89. Then, in Step P6, the absolute value of the difference of the current position of the motor shaft is computed from the computed difference of the current position of the motor shaft, and then stored in the memory M90.

Then, in Step P7, the allowable value of the difference in the position of the motor shaft is loaded from the memory M91. Then, in Step P8, it is determined whether the computed absolute value of the difference of the current position of the motor shaft is equal to or less than the loaded allowable value of the difference in the position of the motor shaft. If the answer is Y, in Step P9, the command speed of the folder unit of the main printing press is loaded from the memory M85. If the answer is N, the program shifts to Step P12 to be described later.

Then, in Step P10, the command speed of the folder unit of the main printing press is written into the memory M92 for storing the command speed of the unit. Then, in Step P1, the command speed is outputted to the driver 192 for the drive motor for the unit, and the program returns to Step P1.

Then, in the aforementioned Step P12, the table of conversion from the difference of the current position of the motor shaft to the correction value of the command speed is loaded from the memory M93. Then, in Step P13, the difference of the current position of the motor shaft is loaded from the memory M89.

Then, in Step P14, the correction value of the command speed of the unit is obtained from the difference of the current position of the motor shaft with the use of the table of conversion from the difference of the current position of the motor shaft to the correction value of the command speed, and the obtained value is stored in the memory M94. Then, in Step P15, the command speed of the folder unit of the main printing press is loaded from the memory M85.

Then, in Step P16, the obtained correction value of the command speed of the unit is added to the loaded command speed of the folder unit of the main printing press to compute the command speed of the unit, which is stored in the memory M92. Then, in Step P17, the command speed is outputted to the driver 192 for the drive motor for the unit, and the program returns to Step P1. Afterwards, this procedure is repeated.

In accordance with the above-described motion flow, the obtained correction value of the command speed of the unit is added to the loaded command speed of the folder unit of the main printing press to compute the command speed of the unit, which is outputted to the driver 192 for the drive motor for the unit.

Then, the drive control device (114a to 114d) for each unit of the subordinate printing press acts in accordance with the motion flow shown in FIGS. 49, 50(a) and 50(b).

In Step P1, zero is written into the memory M95 for storing the pattern phase deviation value DD. Then, in Step P2, zero is written into the memory M96 for storing the pattern phase cumulative deviation value DDS.

Then, in Step P3, it is determined whether the command speed of the folder unit of the main printing press and the virtual current position of the motor shaft of the unit have been transmitted from the drive control device for the folder unit of the main printing press. If the answer is Y, in Step P4, the command speed of the folder unit of the main printing press and the virtual current position of the motor shaft of the unit are received from the drive control device for the folder unit of the main printing press, and stored in the memory M97 and the memory M98. If the answer is N, the program shifts to Step P22, as described later.

Then, in Step P5, the pattern phase cumulative deviation value DDS is loaded from the memory M96. Then, in Step P6, the loaded pattern phase cumulative deviation value DDS is added to the received virtual current position of the motor shaft of the unit to compute the modified virtual current position of the motor shaft of the unit, which is stored in the memory M99.

Then, in Step P7, the count value is loaded from the counter 214 for detecting the position of the motor shaft of the unit, and stored into the memory M100. Then, in Step P8, the current position of the motor shaft of the unit is computed from the loaded count value of the counter 214 for detecting the position of the motor shaft of the unit, and then stored in the memory M101.

Then, in Step P9, the difference of the current position of the motor shaft is computed from the computed modified virtual current position of the motor shaft of the unit and the computed current position of the motor shaft of the unit, and is stored into the memory M102. Then, in Step P10, the absolute value of the difference of the current position of the motor shaft is computed from the computed difference of the current position of the motor shaft, and stored into the memory M103.

Then, in Step P11, the allowable value of the difference in the position of the motor shaft is loaded from the memory M104. Then, in Step P12, it is determined whether the computed absolute value of the difference of the current position of the motor shaft is equal to or less than the loaded allowable value of the difference in the position of the motor shaft. If the answer is Y, in Step P13, the command speed of the folder unit of the main printing press is loaded from the memory M97. If the answer is N, the program shifts to Step P16 to be described later.

Then, in Step P14, the command speed of the folder unit of the main printing press is written into the memory M105 for storing the command speed of the unit. Then, in Step P15, the command speed is outputted to the driver 213 for the drive motor for the unit, and the program returns to Step P3.

Then, in the aforementioned Step P16, the table of conversion from the difference of the current position of the motor shaft to the correction value of the command speed is loaded from the memory M106. Then, in Step P17, the difference of the current position of the motor shaft is loaded from the memory M102.

Then, in Step P18, the correction value of the command speed of the unit is obtained from the difference of the current position of the motor shaft with the use of the table of conversion from the difference of the current position of the motor shaft to the correction value of the command speed, and the obtained value is stored in the memory M107. Then, in Step P19, the command speed of the folder unit of the main printing press is loaded from the memory M97.

Then, in Step P20, the obtained correction value of the command speed of the unit is added to the loaded command speed of the folder unit of the main printing press to compute the command speed of the unit, which is stored in the memory M105. Then, in Step P21, the command speed is outputted to the driver 213 for the drive motor for the unit, and the program returns to Step P3.

Then, in the aforementioned Step P22, the count value is loaded from the counter 215 for detecting the position of the compensator roller, and then stored in the memory M108. Then, in Step P23, the current position of the compensator roller is computed from the count value of the counter 215 for detecting the position of the compensator roller, and then stored in the memory M109.

Then, in Step P24, the reference position of the compensator roller is loaded from the memory M110. Then, in Step P25, the current position of the compensator roller is subtracted from the reference position of the compensator roller to compute the difference in the position of the compensator roller, which is stored in the memory M111.

Then, in Step P26, the pattern phase deviation value DD is computed from the difference in the position of the compensator roller, and then stored in the memory M95. Then, in Step P27, the absolute value |DD| of the pattern phase deviation value DD is computed, and stored in the memory M112.

Then, in Step P28, the allowable value DDA of the pattern phase deviation value DD is loaded from the memory M113. Then, in Step P29, it is determined whether the absolute value |DD| of the pattern phase deviation value DD is greater than the allowable value DDA of the pattern phase deviation value DD. If the answer is Y, in Step P30, the pattern phase cumulative deviation value DDS is loaded. If the answer is N, the program returns to Step P3.

Then, in Step P31, the pattern phase deviation value DD is added to the pattern phase cumulative deviation value DDS, and the memory 96 for storing the pattern phase cumulative deviation value DDS is overwritten with the obtained value. Then, in Step P32, it is determined whether the command speed of the folder unit of the main printing press and the virtual current position of the motor shaft of the unit have been transmitted from the drive control device 60B for the folder unit of the main printing press. If the answer is Y, in Step P33, the command speed of the folder unit of the main printing press and the virtual current position of the motor shaft of the unit are received from the drive control device 60B for the folder unit of the main printing press, and stored in the memory M97 and the memory M98.

Then, in Step P34, the pattern phase cumulative deviation value DDS is loaded from the memory M96. Then, in Step P35, the loaded pattern phase cumulative deviation value DDS is added to the received virtual current position of the motor shaft of the unit to compute the modified virtual current position of the motor shaft of the unit, which is stored into the memory M99.

Then, in Step P36, the count value is loaded from the counter 214 for detecting the position of the motor shaft of the unit, and stored into the memory M100. Then, in Step P37, the current position of the motor shaft of the unit is computed from the loaded count value of the counter 214 for detecting the position of the motor shaft of the unit, and then stored in the memory M101.

Then, in Step P38, the difference of the current position of the motor shaft is computed from the computed modified virtual current position of the motor shaft of the unit and the computed current position of the motor shaft of the unit, and is stored into the memory M102. Then, in Step P39, the absolute value of the difference of the current position of the motor shaft is computed from the computed difference of the current position of the motor shaft, and then stored in the memory M103.

Then, in Step P40, the allowable value of the difference in the position of the motor shaft is loaded from the memory M104. Then, in Step P41, it is determined whether the computed absolute value of the difference of the current position of the motor shaft is equal to or less than the loaded allowable value of the difference in the position of the motor shaft. If the answer is Y, in Step P42, the command speed of the folder unit of the main printing press is loaded from the memory M97. If the answer is N, the program shifts to Step P45, as described later.

Then, in Step P43, the command speed of the folder unit of the main printing press is written into the memory M105 for storing the command speed of the unit. Then, in Step P44, the command speed is outputted to the driver 213 for the drive motor for the unit, and the program returns to Step P3.

Then, in the aforementioned Step P45, the table of conversion from the difference of the current position of the motor shaft to the correction value of the command speed is loaded from the memory M106. Then, in Step P46, the difference of the current position of the motor shaft is loaded from the memory M102.

Then, in Step P47, the correction value of the command speed of the unit is obtained from the difference of the current position of the motor shaft with the use of the table of conversion from the difference of the current position of the motor shaft to the correction value of the command speed, and the obtained value is stored in the memory M107. Then, in Step P48, the command speed of the folder unit of the main printing press is loaded from the memory M97.

Then, in Step P49, the obtained correction value of the command speed of the unit is added to the loaded command speed of the folder unit of the main printing press to compute the command speed of the unit, which is stored into the memory M105. Then, in Step P50, the command speed is outputted to the driver 213 for the drive motor for the unit, and the program returns to Step P32.

In accordance with the above-described motion flow, when the pattern phase deviation modifying compensator roller control device 18A detects the phase deviation of the pattern printed by the subordinate printing press Bb and adjusts the position of the roller 220a of the compensator 220, the drive control device (114a to 114d) for each unit of the subordinate printing press Bb detects this. As a result, the obtained correction value of the command speed of the unit is added to the loaded command speed of the folder unit of the main printing press to compute the command speed of the unit, which is outputted to the driver 213 for the drive motor for the unit. In response to the command speed, a correction is made such that the position of the pattern printed by the subordinate printing press Bb and the position of the pattern printed by the main printing press Aa are in the proper position, whereupon the drive motor (15a to 15d, 115a to 115d) for other unit is controlled in synchronization with the drive motor 61B for the folder unit of the main printing press.

In the present embodiment, as described above, the rotation phase of the drive motor (115a to 115d) for the unit of the subordinate printing press Bb is indirectly adjusted via the compensator 220 by the drive control device (114a to 114d) for each unit of the subordinate printing press Bb and the pattern phase deviation modifying compensator roller control device 18A in accordance with the position of the pattern of the subordinate printing press Bb detected by the pattern phase deviation detecting sensor 17. Thus, the position of the pattern printed by the main printing press Aa and the position of the pattern printed by the subordinate printing press Bb can be automatically brought into the correct position.

Accordingly, burden on the operator can be lessened, and the amount of occurrence of defective printing products can be cut down. In the present embodiment, there may be a plurality of the subordinate printing presses B.

It goes without saying that the present invention is not limited to the above embodiments, and various changes and modifications may be made without departing from the gist of the present invention. Such variations are not to be regarded as a departure from the spirit and scope of the invention, and all such modifications as would be obvious to one skilled in the art are intended to be included within the scope of the following claims.

What is claimed is:

1. A synchronous control method for a web rotary printing press comprising
a first web rotary printing press,
a second web rotary printing press,
a drive motor for driving the second web rotary printing press, and
a folder provided in the first web rotary printing press, and enables a printing product printed by the first web rotary printing press and a printing product printed by the second web rotary printing press to be superposed and folded by the folder,
the synchronous control method, which comprises the steps of:
providing a pattern position measuring means halfway through a transport path, on which a web printed by the second web rotary printing press is transferred to so that the web is superposed on a web printed by the first web rotary printing press, the pattern position measuring means being adapted to measure a position of a pattern printed by the second web rotary printing press;
measuring the position of the pattern, which has been printed by the second web rotary printing press, by the pattern position measuring means; and
controlling a rotation phase of the drive motor based on the measured position of the pattern printed by the second web rotary printing press.

2. The synchronous control method for a web rotary printing press according to claim 1, further comprising the steps of:
providing a means for adjusting a position of a compensator roller based on the measured position of the pattern printed by the second web rotary printing press, the means for adjusting the position of the compensator roller being provided halfway through the transport path, on which the web printed by the second web rotary printing press is transferred so that the web is superposed on the web printed by the first web rotary printing press, the compensator roller being adapted to adjust a length of the transport path of the web printed by the second web rotary printing press; and
controlling the rotation phase of the drive motor based on the position of the compensator roller.

3. A synchronous control method for a web rotary printing press comprising
a first web rotary printing press,
a second web rotary printing press having a drive motor provided in a printing unit, and
a folder provided in the first web rotary printing press, and enables a printing product printed by the first web rotary printing press and a printing product printed by the second web rotary printing press to be superposed and folded by the folder,
the synchronous control method, which comprises the steps of:
providing a pattern position measuring means halfway through a transport path, on which a web printed by the second web rotary printing press is transferred so that the web is superposed on a web printed by the first web rotary printing press, the pattern position measuring means being adapted to measure a position of a pattern printed by the second web rotary printing press;
measuring the position of the pattern, which has been printed by the second web rotary printing press, by the pattern position measuring means; and
controlling a rotation phase of the drive motor, which drives the printing unit of the second web rotary printing press, based on the measured position of the pattern printed by the second web rotary printing press.

4. The synchronous control method for a web rotary printing press according to claim 3, further comprising the steps of:
providing a means for adjusting a position of a compensator roller based on the measured position of the pattern printed by the second web rotary printing press, the means for adjusting the position of the compensator roller being provided halfway through the transport path, on which the web printed by the second web rotary printing press is transferred so that the web is superposed on the web printed by the first web rotary printing press, the compensator roller being adapted to adjust a length of the transport path of the web printed by the second web rotary printing press; and
controlling the rotation phase of the drive motor, which drives the printing unit of the second web rotary printing press, based on the position of the compensator roller.

5. A synchronous control apparatus for a web rotary printing press which comprises:
a first web rotary printing press;
a second web rotary printing press;
a drive motor for driving the second web rotary printing press;
a folder provided in the first web rotary printing press, and enables a printing product printed by the first web rotary printing press and a printing product printed by the second web rotary printing press to be superposed and folded by the folder,
a pattern position measuring means provided halfway through a transport path, on which a web printed by the second web rotary printing press is transferred so that the web is superposed on a web printed by the first web rotary printing press, the pattern position measuring means being adapted to measure a position of a pattern printed by the second web rotary printing press; and
a control means for controlling a rotation phase of the drive motor based on the position of the pattern printed by the second web rotary printing press, the position having been measured by the pattern position measuring means.

6. The synchronous control apparatus for a web rotary printing press according to claim 5, further comprising:
a means for adjusting a position of a compensator roller based on the measured position of the pattern printed by the second web rotary printing press, the means for adjusting the position of the compensator roller being provided halfway through the transport path, on which the web printed by the second web rotary printing press is transferred so that the web is superposed on the web printed by the first web rotary printing press, the compensator roller being adapted to adjust a length of the transport path of the web printed by the second web rotary printing press, wherein
the control means controls the rotation phase of the drive motor based on the position of the compensator roller.

7. A synchronous control apparatus for a web rotary printing press which comprises:
a first web rotary printing press;
a second web rotary printing press having a drive motor provided in a printing unit;
a folder provided in the first web rotary printing press, and enables a printing product printed by the first web rotary printing press and a printing product printed by the second web rotary printing press to be superposed and folded by the folder;
a pattern position measuring means provided halfway through a transport path, on which a web printed by the second web rotary printing press is transferred so that the web is superposed on a web printed by the first web rotary printing press, the pattern position measuring means being adapted to measure a position of a pattern printed by the second web rotary printing press; and
a control means for controlling a rotation phase of the drive motor, which drives the printing unit of the second web rotary printing press, based on the position of the pattern printed by the second web rotary printing press, the position having been measured by the pattern position measuring means.

8. The synchronous control apparatus for a web rotary printing press according to claim 7, further comprising:
a means for adjusting a position of a compensator roller based on the measured position of the pattern printed by the second web rotary printing press, the means for adjusting the position of the compensator roller being provided halfway through the transport path, on which the web printed by the second web rotary printing press is transferred so that the web is superposed on the web printed by the first web rotary printing press, the compensator roller being adapted to adjust a length of the transport path of the web printed by the second web rotary printing press, wherein
the control means controls the rotation phase of the drive motor, which drives the printing unit of the second web rotary printing press, based on the position of the compensator roller.
